(19) United States
(12) Patent Application Publication
(10) Pub. No.: US 2016/0364507 A1
(43) Pub. Date: Dec. 15, 2016

(54) RARE-EVENT SAMPLING

(71) Applicant: Brown University, Providence, RI (US)

(72) Inventors: Paul DUPUIS, North Smithfield, RI (US); Jimmie D. DOLL, Barrington, RI (US)

(21) Appl. No.: 14/147,995

(22) Filed: Jan. 6, 2014

Related U.S. Application Data
(63) Continuation of application No. PCT/US12/45779, filed on Jul. 6, 2012.
(60) Provisional application No. 61/504,926, filed on Jul. 6, 2011.

(51) Int. Cl. G06F 17/50

(52) U.S. Cl. CPC G06F 17/5009

(57) ABSTRACT

Systems and methods are disclosed for a new approach to the rare-event Monte Carlo sampling problem. This technique utilizes a symmetrization strategy to create probability distributions that are more highly connected and thus more easily sampled than their original, potentially sparse counterparts. The methods can be applied to Lennard-Jones clusters of varying complexity and rare-event character. In one embodiment, a system is disclosed comprising a grouping module for dividing a control variable range into a first set of groups and a second set of groups, an analysis module for computing data representative of the physical system over the set of control values in each group in the first and second set of groups and for accelerating the flow of information by simultaneously exchanging information between all of the control values within a group; and a swapping module for communicating data.

### CROSS-REFERENCE TO RELATED PATENT APPLICATIONS

This application claims the benefit of priority to U.S. Pat. App. No. 61/504,926, filed Jul. 6, 2011, which is hereby incorporated by reference in its entirety.

### GOVERNMENT SUPPORT

This research was partially supported by the DOE Multiscale and Optimization for Complex Systems Program (DESC00024l3 and DE-00015561), the Army Research Office (W9llNF-09-l-0l55), the Air Force Office of Scientific Research (FA9550-07-1-0544, FA9550-09-1-0378), and by the National Science Foundation (DMS-I008331). The U.S. Government may have certain rights in this invention as provided for by the terms of the above grants.

### BACKGROUND

This invention relates to simulating physical properties of matter in a computer system. More particularly, the invention relates to increasing the speed at which useful simulations of physical systems can be performed. In conventional simulations, large amounts of computational resources are expended simulating a physical system in which nothing of interest is occurring. The invention increases the likelihood that events of interest in the physical system occur during a simulation and increases the efficiency with which computational resources are used.

Monte Carlo methods are among the more versatile and widely utilized tools in modem simulation. In particular, they provide a refinable means for treating problems of a physically realistic complexity. They are of importance in classical and quantum statistical-mechanical applications, for example, where the problem of computing thermodynamic properties can be reduced to that of performing well-defined, large-dimensional averages over known probability distributions. Such applications are the primary focus of the present disclosure.

### SUMMARY

Systems and methods are disclosed for a new approach to the rare-event Monte Carlo sampling problem. This technique utilizes a symmetrization strategy to create probability distributions that are more highly connected and thus more easily sampled than their original, potentially sparse counterparts. The methods can be applied to many physical and statistical problems, such as Lennard-Jones clusters of varying complexity and rare-event character.

In one embodiment, a system is disclosed comprising a grouping module for dividing a control variable range into a first set of groups and a second set of groups, an analysis module for computing data representative of the physical system over the set of control values in each group in the first and second set of groups and for accelerating the flow of information by simultaneously exchanging information between all of the control values within a group; and a swapping module for communicating data.

The control variable range extends from a lowest value, V_{lowest}, to a highest value, V_{highest}, such that each group in the first set including a discrete set of control values that extend over only a portion of the range from V_{lowest} to V_{highest}, each group in the second set including a discrete set of control values that extend over only a portion of the range from V_{lowest} to V_{highest}, each group in the first set being distinct from each group in the second set, and the control values in the first set extend from V_{lowest} to V_{highest}, and the control values in the second set extend from V_{lowest} to V_{highest}.

The swapping module is such that analysis module can use data computed using a group in the first set for computing data representative of the physical system for a group of control values in the second set, and the analysis module can use data computed using a group in the second set for computing data representative of the physical system for a group of control values in the first set.

The description and figures which follow describe various embodiments in further detail. Although the present disclosure is described and illustrated in the following embodiments, it is understood that the present disclosure has been made only by way of example, and that numerous changes in the details of implementation of the disclosure may be made without departing from the spirit and scope of the disclosure.

### BRIEF DESCRIPTION OF THE DRAWINGS

FIG. 1 is a schematic functional plot showing temperature-swapped and particle-swapped processes, in accordance with some embodiments.

FIG. 1A is a schematic functional plot showing an exemplary potential energy function, in accordance with some embodiments.

FIG. 2 is a schematic functional plot showing partial infinite swapping handoffs, in accordance with some embodiments.

FIG. 2A is a multidimensional plot showing isosurfaces, in accordance with some embodiments.

FIG. 3 is a potential energy plot for a 13-atom Lennard-Jones cluster, in accordance with some embodiments.

FIG. 3A is a multidimensional plot showing symmetrized isosurfaces, in accordance with some embodiments.

FIG. 4 is a potential energy plot for a 13-atom Lennard-Jones cluster, in accordance with some embodiments.

FIG. 4A is a multidimensional plot showing partially-symmetrized isosurfaces, in accordance with some embodiments.

FIG. 4B is a second multidimensional plot showing partially-symmetrized isosurfaces, in accordance with some embodiments.

FIG. 5 is a potential energy plot for a 38-atom Lennard-Jones cluster showing parallel tempering and partial infinite swapping, in accordance with some embodiments.

FIG. 5A is a temperature profile plot for four relaxation simulations, in accordance with some embodiments.

FIG. 5B is a relaxation curve plot using infinite swapping, in accordance with some embodiments.

FIG. 6 is a cooling portion of the lowest-temperature curve in FIG. 5b, in accordance with some embodiments.

FIG. 7 is a plot of a representative value on the parallel tempering relaxation curves of FIG. 6, in accordance with some embodiments.

FIG. 8 is a plot of a representative value on the parallel tempering relaxation curves of FIG. 6 using partial infinite swapping, in accordance with some embodiments.

FIG. 9 is a loop average potential energy plot for a 38-atom Lennard-Jones cluster, in accordance with some embodiments.

FIG. 10 is a heat capacity plot for a 38-atom Lennard-Jones cluster, in accordance with some embodiments.

FIG. 11 is a loop average potential energy plot for a 38-atom Lennard-Jones cluster with an alternate simulation start point, in accordance with some embodiments.

FIG. 12 is a heat capacity plot for a 38-atom Lennard-Jones cluster with an alternate simulation start point, in accordance with some embodiments.

FIG. 13 is a relaxation plot for a 38-atom Lennard-Jones cluster, in accordance with some embodiments.

FIG. 14 is an equilibration plot for an LJ-31 system, in accordance with some embodiments.

FIG. 15 is a heat capacity plot for an LJ-31 system, in accordance with some embodiments.

FIG. 16 is a schematic diagram of the partial infinite swapping approach, in accordance with some embodiments.

FIG. 17 is a schematic diagram of a grouping method, in accordance with some embodiments.

FIG. 18 is a schematic diagram of a computer system, in accordance with some embodiments.

### DETAILED DESCRIPTION

Introduction

Monte Carlo methods are among the more versatile and widely utilized tools in modem simulation. In particular, they provide a refinable means for treating problems of a physically realistic complexity. They are of importance in classical and quantum statistical-mechanical applications, for example, where the problem of computing thermodynamic properties can be reduced to that of performing well-defined, large-dimensional averages over known probability distributions. Such applications are the primary focus of the present discussion.

A key step in the use of Monte Carlo methods in either a classical or quantum equilibrium statistical-mechanical context is generating a suitable sampling of the relevant probability distribution. While straightforward in principle, difficulties can arise in practice if the probability distribution involved is “sparse”. In the case of sparse distributions the diffusive random walk methods generally used to perform the sampling can become problematic as transitions from one isolated region of importance to another grow rare on a practical scale. Unfortunately, such rare-event sampling difficulties are themselves not rare events. They arise frequently, for example, in the treatment of activated processes at low temperatures.

The techniques disclosed herein for increasing the efficiency of simulations include two fundamental techniques: (1) “infinite swapping” of information within a limited set and (2) a “dual-chain” technique in which information is exchanged between different groupings. Each of these techniques is explained further below.

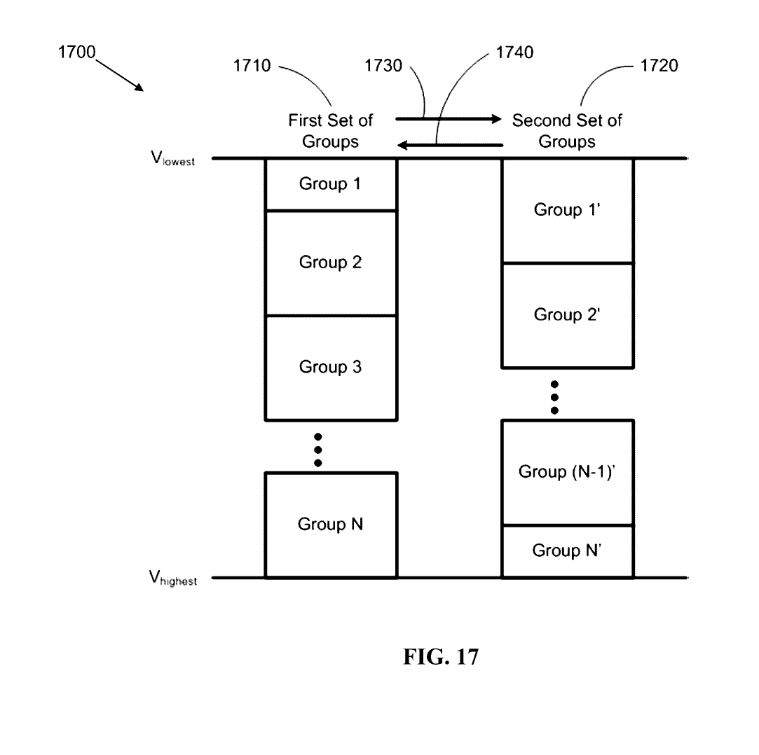

FIG. 17 is a schematic diagram that illustrates both the “infinite swapping” and “dual-chain” techniques. FIG. 17 shows a first set of groups 1710 and a second set of groups 1720. Each of the groups extends from a lowest value, V_{lowest}, to a highest value, V_{highest}. The first set of groups 1710 includes N groups designated Group 1, Group 2, . . . Group N. The second set of groups 1720 also includes N groups designated Group 1′ (i.e., “Group 1 prime”), Group 2′, . . . Group N′. As shown, all the groups in the first set 1710 are distinct from all groups in the second set.

As an example, the groups can extend over a temperature range such that V_{lowest} represents 0.050 degrees and V_{highest} represents 0.330 degrees, and such that 45 temperatures are selected to cover the intervening range from (0.050-0.210) in temperature steps of 0.005, and from (0.210-0.330) in steps of 0.010. The temperature values included in the groups for this example is summarized below in Table A.

TABLE A

| | |
|---|---|
| Group identifier | Temperatures included in the group |

First set of groups 1710

| | |
|---|---|
| Group 1 | 0.050, 0.055, 0.060 |
| Group 2 | 0.065, 0.070, 0.075, 0.080, 0.085, 0.090, 0.095 |
| Group 3 | 0.100, 0.105, 0.110, 0.115, 0.120, 0.125, 0.130 |
| Group 4 | 0.135, 0.140, 0.145, 0.150, 0.155, 0.160, 0.165 |
| Group 5 | 0.170, 0.175, 0.180, 0.185, 0.190, 0.195, 0.200 |
| Group 6 | 0.205, 0.210, 0.220, 0.230, 0.240, 0.250, 0.260 |
| Group 7 | 0.270, 0.280, 0.290, 0.300, 0.310, 0.320, 0.330 |

Second set of groups 1720

| | |
|---|---|
| Group 1′ | 0.050, 0.055, 0.060, 0.065, 0.070, 0.075, 0.080 |
| Group 2′ | 0.085, 0.090, 0.095, 0.100, 0.105, 0.110, 0.115 |
| Group 3′ | 0.120, 0.125, 0.130, 0.135, 0.140, 0.145, 0.150 |
| Group 4′ | 0.155, 0.160, 0.165, 0.170, 0.175, 0.180, 0.185 |
| Group 5′ | 0.190, 0.195, 0.200, 0.205, 0.210, 0.220, 0.230 |
| Group 6′ | 0.240, 0.250, 0.260, 0.270, 0.280, 0.290, 0.300 |
| Group 7′ | 0.310, 0.320, 0.330 |

In this example, the groups are characterized by the following properties:
each set of groups includes each member of the discrete set of temperatures consisting of: {0.050, 0.055, 0.060, 0.065, 0.070, 0.075, 0.080, 0.085, 0.090, 0.095, 0.100, 0.105, 0.110, 0.115, 0.120, 0.125, 0.130, 0.135, 0.140, 0.145, 0.150, 0.155, 0.160, 0.165, 0.170, 0.175, 0.180, 0.185, 0.190, 0.195, 0.200, 0.205, 0.210, 0.220, 0.230, 0.240, 0.250, 0.260, 0.270, 0.280, 0.290, 0.300, 0.310, 0.320, 0.330}
no group contains more than seven temperature values
groups in the first set 1710 are distinct from groups in the second set 1720 (i.e., no group in the first set 1710 includes the identical set of temperatures included in any group of the second set 1710)

As explained below, the “infinite swapping” technique, which uses a symmetrized distribution and allows simultaneous exchange of information within a group of values, is impractical if carried out over too large a set of values. However, the “infinite swapping” technique is practical if carried out over a reasonable set of values. For example, seven or eight values is a reasonably sized set. Thus, in the example above, no group contains more than seven temperature values. As explained further below, when the technique illustrated in FIG. 17 is performed, “infinite swapping” is allowed to occur within each individual group.

Although “infinite swapping” is practical when carried out over a reasonably-sized set of values, it is often desirable to simulate a physical system over a much larger set of values. In the example described above in connection with FIG. 17, it is desired to simulate a physical system at forty-five different temperature values, i.e., 0.050, 0.055, . . . 0.330 degrees. Forty-five different values is too large for “infinite swapping” to be practical.

As again explained further below, the “dual chain” technique provides a good approximation to “infinite swapping” extended over the full range of values of interest. As an example, the “dual chain” technique can be performed as follows:
Infinite swapping analysis is performed within every group in the first set 1710 (i.e., infinite swapping analysis is performed for the values in Group 1, a separate infinite swapping analysis is performed for the values in Group 2, . . . and a separate infinite swapping analysis is performed for the values in Group N).
Data generated in the infinite swapping analysis of the first set 1710 is then provided to the second set 1720 as illustrated by arrow 1730 (e.g., data generated for Groups 1 and 2 of the first set 1710 is used to seed a simulation of Group 1′ in the second set 1720; data generated for Groups 2 and 3 of the first set 1710 is used to seed a simulation of Group 2′ in the second set 1720; . . . and data generated for Group N of the first set 1710 is used to seed a simulation of Group N′ of the second set 1720.
Infinite swapping analysis is then performed within every group in the second set 1720 (i.e., infinite swapping analysis is performed for the values in Group 1′, a separate infinite swapping analysis is performed for the values in Group 2′, . . . and a separate infinite swapping analysis is performed for the values in Group N′).
Data generated in the infinite swapping analysis of the second set 1720 is then provided to the first set 1710 as illustrated by arrow 1740 (e.g., data generated for Group 1′ of the second set 1720 is used to seed a simulation of Group 1 in the first set 1710; data generated for Groups 1′ and 2′ of the second set 1720 is used to seed a simulation of Group 2 in the first set 1710; . . . and data generated for Groups (N−1)′ and N′ of the second set 1720 is used to seed a simulation of Group N of the first set 1710.

In this manner, infinite swapping analysis within one set of groups followed by exchange of information from a previous infinite swapping analysis to a new set of groups and infinite swapping analysis of that group, followed by another exchange of information is performed until the desired results of the simulation have been obtained.

The techniques of “infinite swapping” and “dual chain” have been described above in connection with simulating a physical system over a range of temperatures. However, the values V_{lowest} and V_{highest} need not represent temperatures. As further examples, the simulations can be performed over any parameter, or control variable, of interest such as pressure, density, volume, temperature, or others.

Also, in the example given above, each set 1710 and 1720 contains N groups and each group contains either three or seven values. In practice, each set need not contain the same number of groups and the groups need not contain the same numbers of values. Ideally though, no group will contain more values than would be practical for “infinite swapping” analysis within the group. Also, ideally, the groups in one set are distinct from the groups in another set such that the “dual chain” technique allows a group to receive information from a prior “infinite swapping” analysis that was performed over a range of values different from those contained within the group (e.g., as in the example above, Group 2′ which contains values from 0.085-0.115 receives information from an infinite swapping analysis performed on groups 1 and 2, which covered the overlapping but distinct range of values 0.050 . . . 0.095).

The general technique described above includes: (a) infinite swapping analysis in every group of a first set of groups, followed by (b) using information from the first infinite swapping analysis to seed a simulation for groups in a second set of groups, followed by, (c) infinite swapping analysis in every group of the second set of groups, followed by (d) using information from the second infinite swapping analysis to seed a simulation for groups in the first set, followed by (e) a new infinite swapping analysis in every group of the first set. The process of infinite swapping analysis followed by exchange of information to a new set of groups can continue indefinitely or until desired results are obtained. It should be appreciated that the analysis need not alternate between two sets of groups as has been described above. As an alternative, data from the second infinite swapping analysis can be used to seed a simulation for a third set of groups, and so on.

As explained further below, the “infinite swapping” and “dual chain” techniques can be used broadly for the study of, e.g., nanoscale structures, catalysts, and geometry of proteins. For nanoscale structures, such as Lennard-Jones clusters, the use of grouping allows improved simulation of control values to be used when simulating each of the pairwise interactions of, e.g., a cluster of 10 gold atoms and 15 silver atoms. For catalysts, a similar simulation of the physical properties of each of the atoms in a reaction may be enabled, even for determining the frequency of extremely rare events, thereby facilitating the analysis of a proposed catalyst. For protein geometry, the electrical, nuclear and van der Waals interactions between a large number of atoms may be simulated using the improved performance of this technique, such that large-scale simulation of protein folding at different temperatures may be modeled.

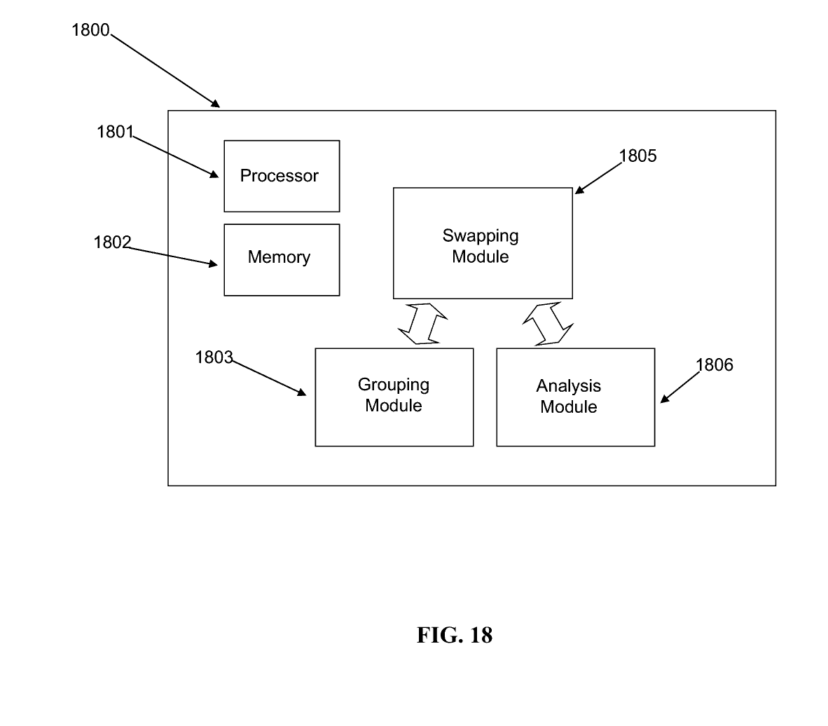

FIG. 18 is a schematic diagram of a computer system, in accordance with some embodiments. Computing device 1800 contains processor 1801, memory 1802, grouping module 1803, swapping module 1805, and analysis module 1806. In one embodiment, data is received by device 1800 and grouped into a first grouping by grouping module 1803, and then handed off to swapping module 1805. Swapping module 1805 performs the logical control functions and transfers data between grouping module 1803 and analysis module 1806 to enable the “dual chain” technique. Analysis module 1806 performs one or more operations that may include symmetrization operations and that may include operations described below as infinite swapping or partial infinite swapping. Once analysis module 1806 is done processing the first grouping, it returns its information to swapping module 1805, which then may determine whether to perform additional groupings, perform additional analysis, or to terminate processing. In some embodiments, at least two groupings are made, thereby enabling dual-chain operation as described below.

FIG. 18 illustrates a single analysis module 1806. It will be appreciated that analysis module 1806 can be subdivided into separate analysis modules, such as a first analysis module (for performing infinite swapping analysis within a first set of groups) and a second analysis module (for performing infinite swapping analysis within a second set of groups). Alternatively, a common module may be used to perform infinite swapping analysis within multiple sets of groups.

To focus the present discussion, the problem is considered of estimating an average of the form

$$〈 V 〉 = \frac{\int μ ( x ) V ( x ) d x}{\int μ ( x ) d x} , \qquad ( 1.1 )$$

where x represents the coordinates of the system and V(x) is a property of interest such as the potential energy. As long as the probability distribution involved, μ(x), has a single “inherent structure’, the sampling is straightforward and the associated numerical results are reliable. If, on the other hand, the probability distribution has multiple, isolated inherent structures, this ceases to be the case. In such cases <V> can be thought of as a sum of contributions over the various inherent structures,

$$〈 V 〉 = {\sum }_{α} {〈 V 〉}_{α} {W}_{α} . \qquad ( 1.2 )$$

In Eq. (1.2) <V>_{α} represents the average of V over the region corresponding to inherent structure α, [symbol] _{α}

$${〈 V 〉}_{α} = \frac{ μ ( x ) V ( x ) d x}{ μ ( x ) d x} , \qquad ( 1.3 )$$

and W_{α} is the fraction of the statistical weight associated with that region:

$${W}_{α} = \frac{ μ ( x ) d x}{\int μ ( x ) d x} . \qquad ( 1.4 )$$

Even though one does not typically decompose the required averages into explicit component form, as emphasized by Eq. (1.2) both intra and inter-inherent structure sampling are at issue in their calculation. The relevant point is that while conventional sampling methods do well for the former task, their performance for the latter can be unreliable.

Methods designed to deal with rare-event sampling issues have been developed and are briefly summarized in Section II. While many represent a significant improvement over basic methods, the need for more effective techniques remains an important area of current research. In the present work a new approach is described that is based on the use of symmetrization. At first glance, the conscious introduction of this element into the discussion is counter-intuitive in that its presence is generally regarded as increasing rather than decreasing the complexity of the problem. As shown in the following sections, however, because it alters the inherent connectedness of the probability distributions involved, symmetrization represents a potentially useful tool in the treatment of rare-event problems.

The outline of the remainder of the paper is as follows: Section II presents both a brief overview of current approaches to the rare-event sampling problem and a heuristic discussion of the present technique. For reasons that will be discussed in greater detail in Section II, this method is denoted the “infinite swapping” or INS technique. The details of the INS approach and practical methods for its implementation are then outlined in Section III. Numerical applications that compare the performance of INS and parallel tempering methods for the calculation of thermodynamic properties of selected Lennard-Jones (LJ) clusters are discussed in Section IV. Finally, Section V summarizes the findings the instant application and indicates possible directions for future development.

Background

A number of methods for dealing with rare-event sampling problems have been developed and are discussed elsewhere. Common strategies include changes in trial moves, changes of measure and parallel tempering or replica exchange methods. Perhaps the simplest device for dealing with rare-event problems is to increase the length scale(s) associated with trial displacements. Although such increases generally result in diminished acceptance probabilities, they can nonetheless sometimes improve the ability of the associated random walks to overcome barriers. If one has sufficient physical insight concerning the nature of the relevant potential energy surfaces involved, “displacement vector Monte Carlo” techniques become an option and can be effective.

A general technique for dealing with rare-event issues is through a change of measure. For example, one can rewrite the average in Eq. (1.1) as

$$〈 V 〉 = \frac{{〈 ( \frac{μ ( x )}{\tilde{μ} ( x )} ) V ( x ) 〉}_{ \tilde{μ}}}{{〈 ( \frac{μ ( x )}{\tilde{μ} ( x )} ) 〉}_{\tilde{μ}}} , \qquad ( 2.1 )$$

where the averages on the right hand side of Eq. (2.1) are over an auxiliary probability distribution, μ^{˜}(x), that can be chosen for sampling convenience. When adopting this approach one must guard against μ^{˜}(x) choices that cause unacceptable increases in the associated variance. A number of strategies for μ^{˜}(x) selection have been proposed.

A widely utilized method for dealing with rare-event sampling issues is the parallel tempering or replica exchange technique. This approach utilizes an expanded computational ensemble composed of systems corresponding to different values of one or more of the control variables. In the study of activated processes, for example, temperature is a natural parameter. Parallel tempering tries to overcome rare-event sampling issues by exchanging information between different portions of the simulation. Information from higher temperatures, where high-energy barriers are more easily crossed, is used to improve the sampling at lower temperatures, where such crossings are more difficult. Strategies for the selection of the tempering ensemble have been discussed.

Information transfer within the computational ensemble is essential to the parallel tempering approach. It is important to note that the nature of the exchange moves that are typically used to generate this transfer places practical limits on the rate of information flow achievable within the approach. For example, conventional, single-temperature coordinate displacements are typically augmented with trial moves that involve attempted swaps of system coordinates between temperatures. The percentage of swap attempts used is generally set using the Goldilocks—“not-too-small not-too-big” approach. If the percentage is too small, the information flow between temperatures is minimal and the resulting sampling benefits are negligible. If, on the other hand, the percentage is too large, the sampling again suffers. In the extreme limit, where all trial moves become attempted swaps, fixed system configurations are ineffectively toggled back and forth between the various temperature streams.

Using the theory of large deviations, it is possible to show that the performance of parallel tempering is, in principle, a monotonically increasing function of the swap rate. Empirical indications of such behavior have been noted. Were it possible to design such a procedure, this result suggests that the infinite swapping limit of parallel tempering would have desirable performance characteristics. This analysis shows that it is, in fact, possible to construct an alternative scheme, which coincides with the infinite swapping limit of parallel tempering in a distributional sense and which can be readily implemented. More generally, the method that emerges is a special case of a new class of rare-event sampling techniques.

The basic ideas that emerge from the large deviations analysis are shown by considering a simple example, a double well system whose potential energy is given by

V(x)=(x²−1)². (2.2)

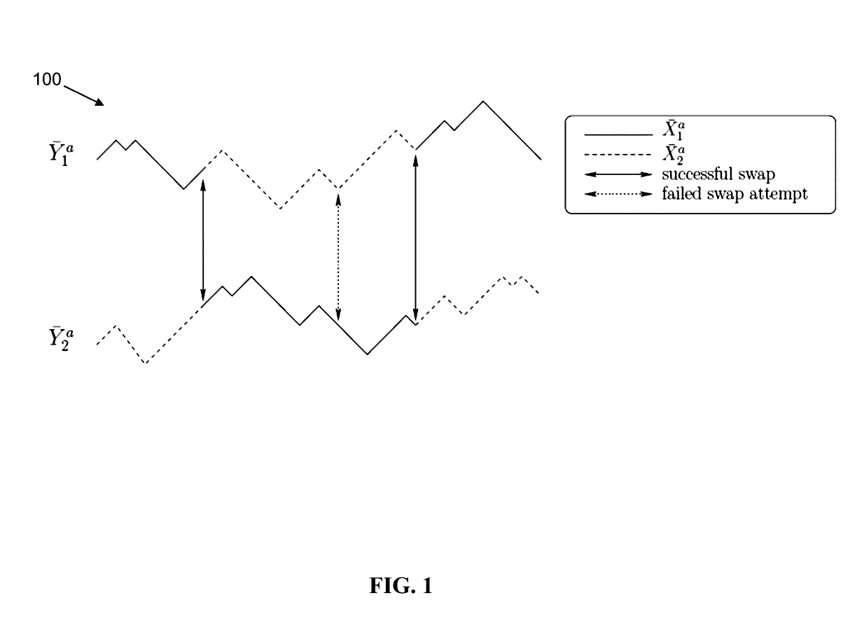

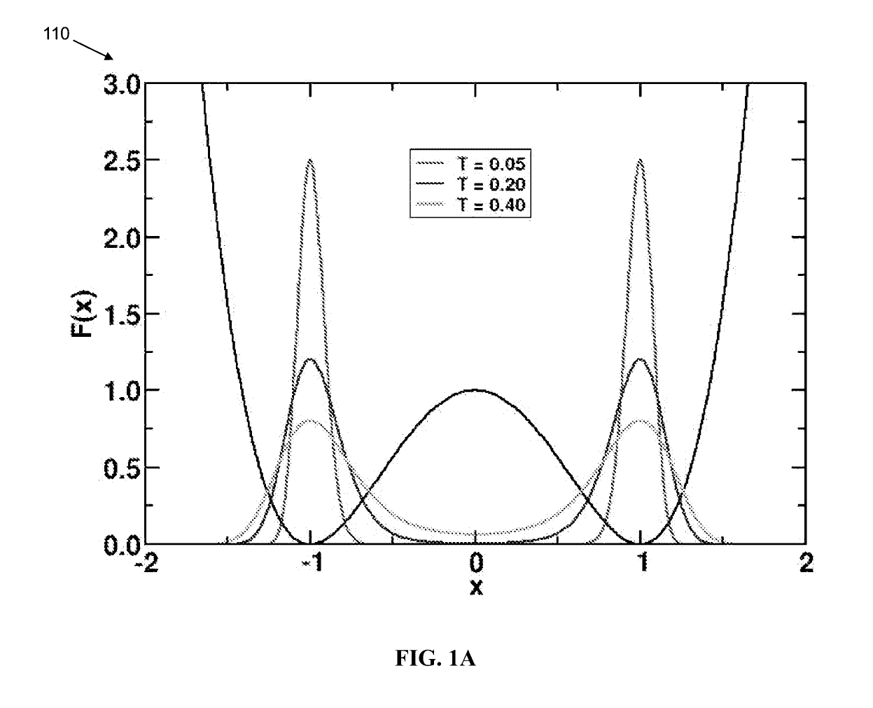

FIG. 1 is a schematic functional plot showing an exemplary potential energy function, in accordance with some embodiments. In FIG. (1) plots of the potential energy are shown, of the classical thermal distributions of the form

π(x,T)=e^{-V(x)/τ}, (2.3)

for three temperatures, here chosen to be T=0.05, 0.20, and 0.40. As expected, the normalized probability densities shown in FIG. (1) are increasingly “sparse” at lower temperatures where the scale of thermal fluctuations becomes small relative to the energy barrier that separates the wells.

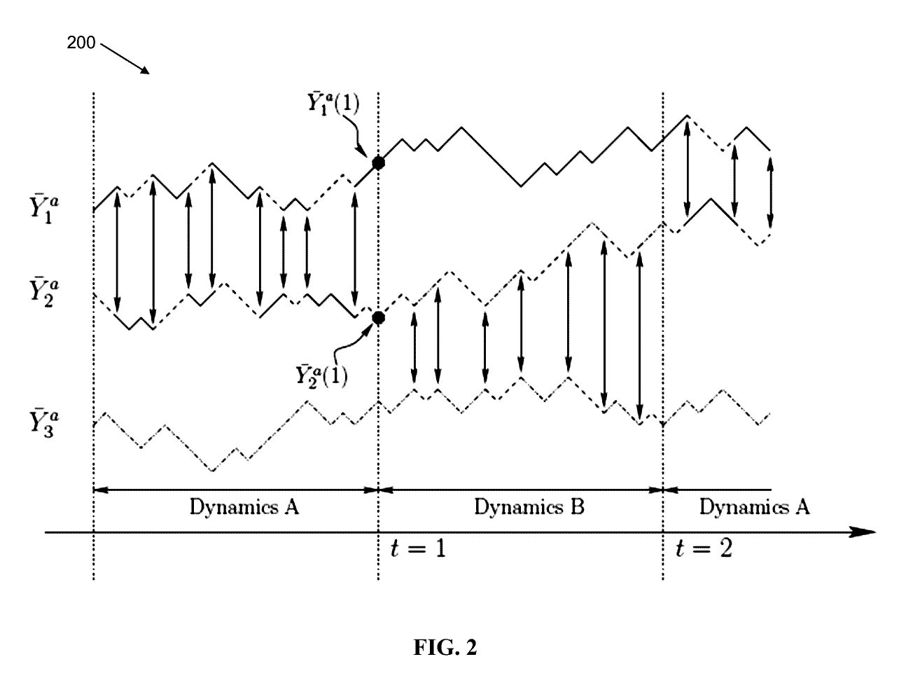

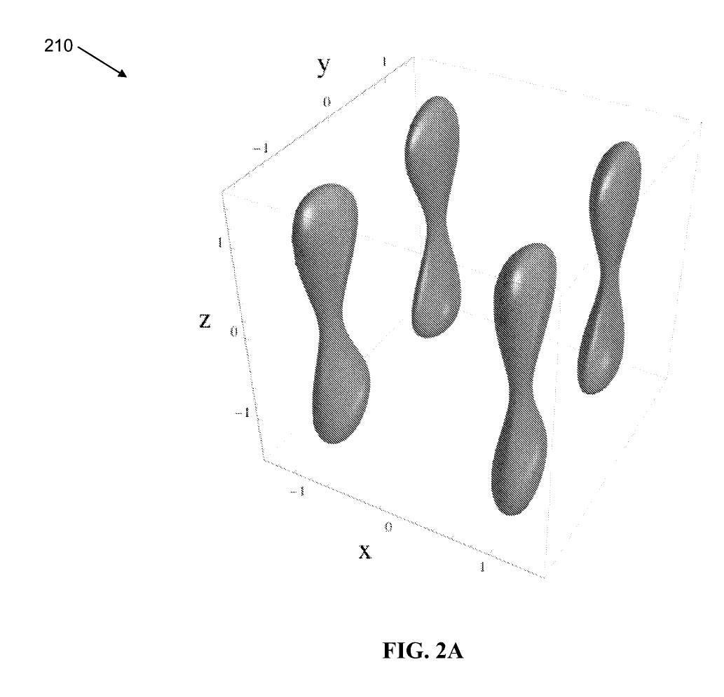

FIG. 2 is a multidimensional plot showing isosurfaces, in accordance with some embodiments. In FIG. (2), the information of FIG. (1) is presented in a somewhat different manner. Specifically, a multi-variable distribution, μ₀, is defined as

μ₀(x,y,z,Tₓ,T_{y},T_{z})=π(x,Tₓ)π(y,T_{y})π(z,T_{z}) (2.4)

and assign the three temperatures used in FIG. (1) to particular coordinates, (Tx=0.05, Ty=0.20, Tz=0.40). The extent to which the various potential minima are linked is reflected in the structure of the isosurfaces of μ₀ shown in FIG. (2). The greatest bridging density is associated with the z-direction (highest temperature) and the least with the x-direction (lowest temperature).

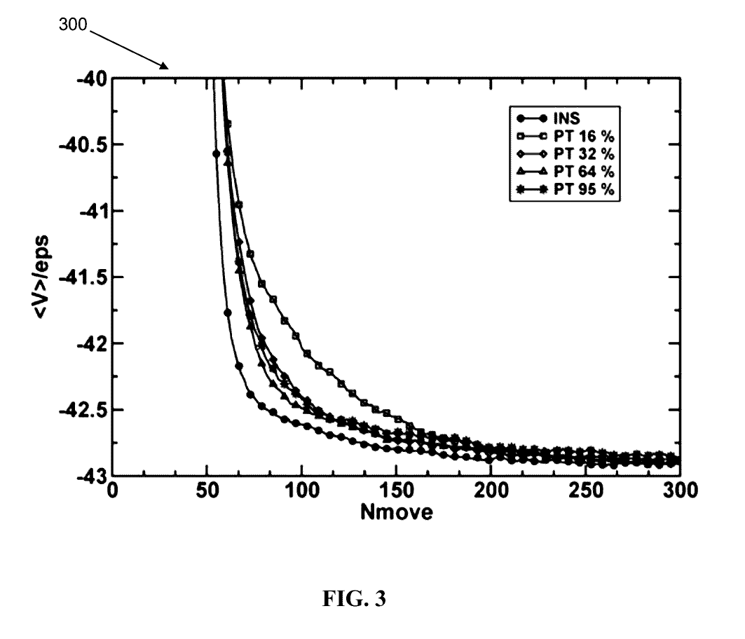

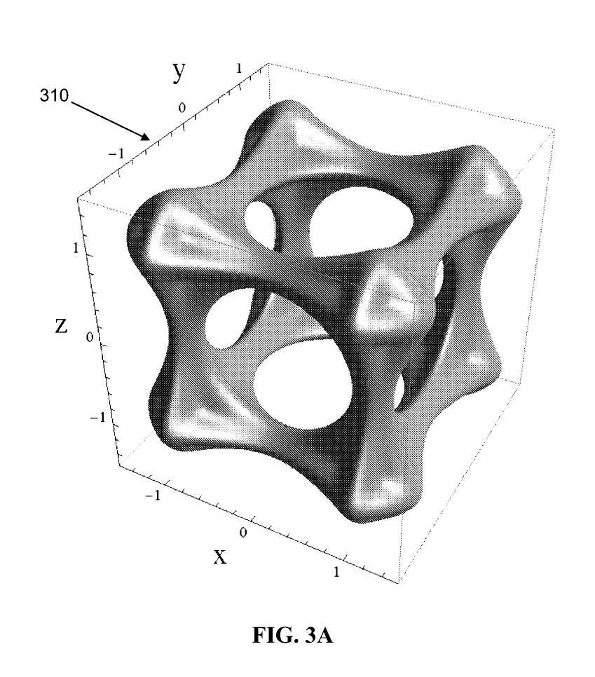

FIG. 3 is a multidimensional plot showing symmetrized isosurfaces, in accordance with some embodiments. In FIG. (3) an isosurface plot is presented of a related distribution, μ_{xyz}, the fully symmetrized analog of the original. This (unnormalized) distribution is defined as

$${μ}_{xyz} ( x , y , z , {T}_{x } , {T}_{y} , {T}_{z} ) = {μ}_{0} ( x , y , z , {T}_{x} , {T}_{y} , {T}_{z} ) + {μ}_{0} ( x , y , z , {T}_{x} , {T}_{z} , {T}_{y} ) + {μ}_{0} ( x , y , z , {T}_{y} , {T}_{x} , {T}_{z} ) + {μ}_{0} ( x , y , z , {T}_{y} , {T}_{z} , {T}_{x} ) + {μ}_{0} ( x , y , z , {T}_{z} , {T}_{x} , {T}_{y} ) + {μ}_{0} ( x , y , z , {T}_{z} , {T}_{y} , {T}_{x} ) . \qquad ( 2.5 )$$

Because symmetrization removes the explicit linkage between temperature and coordinate labels, μ_{xyz} is more highly connected than μₒ. Thus, while both distributions contain related thermodynamic information, FIGS. (2) and (3) suggest that the symmetrized version offers fewer rare-event sampling issues than the original. Whether or not this idea can be exploited and the factorial-scale growth of the computational complexity associated with total symmetrization can be avoided remains to be demonstrated.

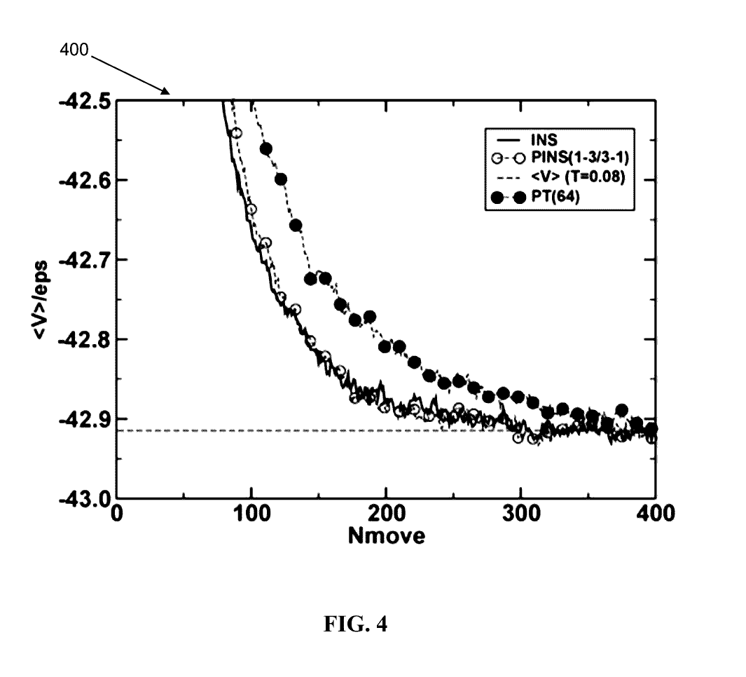

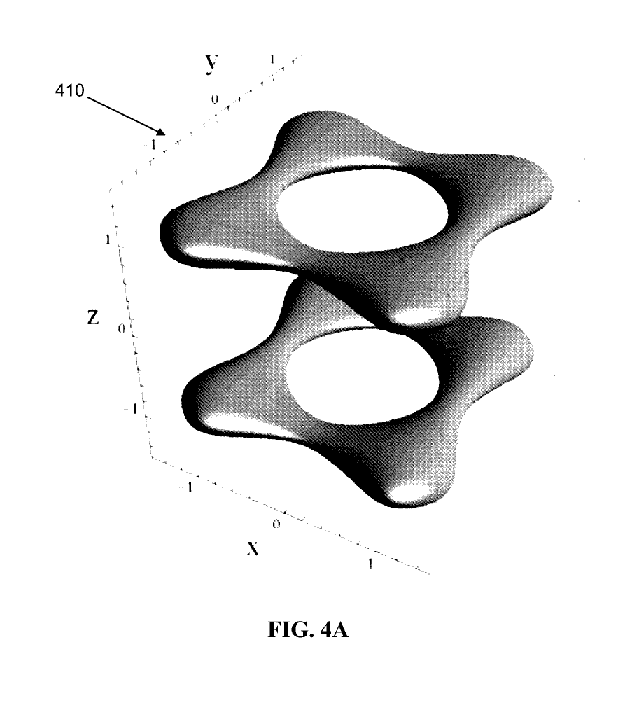

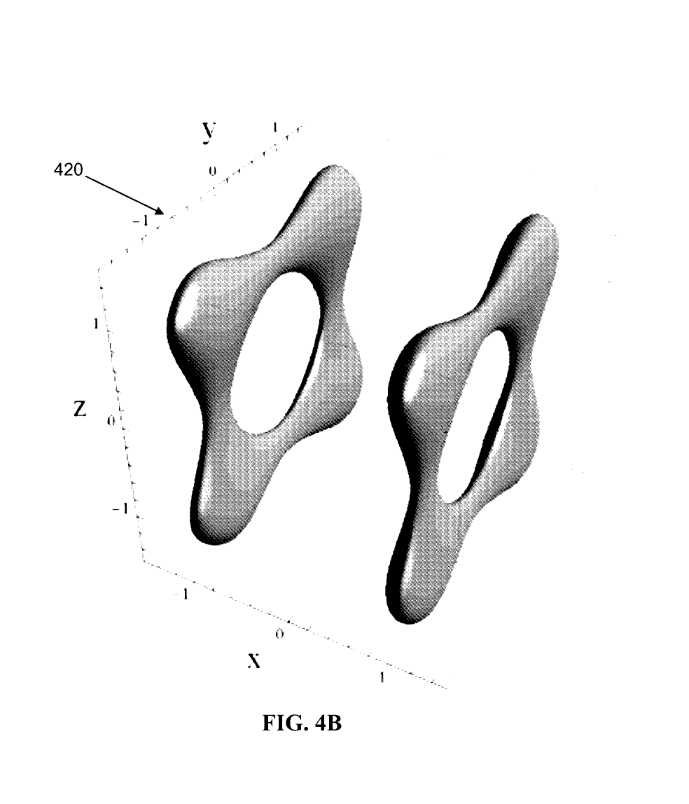

FIG. 4a is a multidimensional plot showing partially-symmetrized isosurfaces, in accordance with some embodiments. FIG. 4b is a second multidimensional plot showing partially-symmetrized isosurfaces, in accordance with some embodiments. One possible strategy is suggested in FIG. (4). These plots display isosurfaces of two, partially symmetrized distributions, μ_{xy} and μ_{yz} defined for the present double-well example as

μ_{xy}(x,y,z)=μ₀(x,y,z,0.20,0.40,0.05)+μ₀(x,y,z,0.40,0.20,0.05) (2.6)

and

μ_{yz}(x,y,z_{z})=μ₀(x,y,z,0.05,0.20,0.40)+μ₀(x,y,z,0.05,0.40,0.20), (2.7)

Although not as great as that seen for full symmetrization, FIG. (4) shows that partial symmetrization produces an increase in the connectedness of the associated distribution, a suggestion that the approach may offer a practical means of achieving the sampling benefits that are the goal of this disclosure.

Before discussing the details of the approach, it is useful to consider symmetrization from a somewhat different perspective. Equation (2.4) represents a typical parallel tempering ensemble; a simple product of Boltzmann terms each corresponding to a specified temperature. The mixing of coordinate and temperature information that underlies the method's improved sampling is generated indirectly, through the choice of trial moves. The structure of the symmetrized distribution defined in Eq. (2.5), on the other hand, intrinsically entangles temperature and coordinate information. All coordinate displacements, even those that would take place in a single temperature setting for the distribution in Eq. (2.4), thus occur in a Born-Oppenheimer like environment generated by the (infinitely rapid) multi-temperature swaps of information inherent in the symmetrization process.

Methods

In this section the INS approach is described and methods are developed for its practical implementation. The formal basis of the method is discussed elsewhere.” An approach is presented in the context of a representative equilibrium problem, that of estimating the average potential energy of a system characterized by a set of coordinates, x, a known potential energy, V(x), and a specified probability distribution, π(x, T). The objective is to compute the average potential energy at a specified temperature (or temperatures), Tₖ,

$${〈 V 〉}_{k} = \frac{\int π ( x , {T}_{k} ) V ( x ) d x}{\int π ( x , {T}_{k} ) d x} . \qquad ( 3.1 )$$

The joint probability distribution for N independent systems with coordinates, {xₙ} and a set of temperatures, {Tₙ}, n=1, N (assumed to include Tₖ) is given by the product π(x₁, T₁) π(x₂, T₂) . . . π(x_{N}, T_{N}) and its associated partition function is given by

$$Z = {\prod }_{n = 1}^{N} \int d {x}_{n} π ( {x}_{n} , {T}_{n} ) . \qquad ( 3.2 )$$

The set of permutations of the temperatures between the coordinate sets is denoted by {Pₙ[π(x1, T1)π(x2, T2) . . . π(xN, TN)]}, where n=1,N! and the coordinate set label corresponding to the temperature Tₖ in the nth permutation by the function indx(n,k). In terms of these quantities, <V>ₖ can be written as the average of N! formally identical terms

$${〈 V 〉}_{k} = \frac{1}{N !} {\sum }_{n} \frac{\int {P}_{n} [ π ( {x}_{1} , {T}_{1} ) π ( {x}_{2} , {T}_{2} ) … π ( {x}_{N} , {T}_{N} ) ] v ( {x}_{\text{?} ( n , \text{?} )} ) d X}{\int {P}_{n} [ π ( {x}_{1} , {T}_{1} ) π ( {x}_{2} , {T}_{2} ) … π ( {x}_{N} , {T}_{N} ) ] d X} , \\ \text{?} \text{indicates text missing or illegible when filed} \qquad ( 3.3 )$$

where X represents the N sets of system coordinates, (Xj, X2, . . . , XN). Because all of the normalization integrals for the terms in Eq. (3.3) are identical, the average involved can also be written as

$$\begin{matrix} {〈 V 〉}_{k} = \frac{\int μ ( X ) [ {\sum }_{a} {ρ}_{n} ( X ) V ( {x}_{\text{?} ( n , \text{?} )} ) ] d X}{\int μ ( X ) d X} , \\ where & ( 3.4 ) \\ {ρ}_{n} ( X ) = \frac{{P}_{n} [ π ( {x}_{1} , {T}_{1} ) π ( {x}_{2} , {T}_{2} ) … π ( {x}_{N} , {T}_{N} ) ]}{μ ( X )} , \\ \text{?} \text{indicates text missing or illegible when filed} & ( 3.5 )\end{matrix}$$

and where the (fully) thermally symmetrized distribution, μ(X), is given by

$$μ ( X ) = {\sum }_{n} {P}_{n} [ π ( {x}_{1} , {T}_{1} ) π ( {x}_{2} , {T}_{2} ) … π ( {x}_{N} , {T}_{N} ) ] . \qquad ( 3.6 )$$

The sum of the statistical weights defined in Eq. (3.5) is, by construction, equal to unity. For a specified temperature, the averages defined in Eqs. (3.1) and (3.4) are formally identical. However, as discussed in Section II, the increased connectedness of μ(x) suggests that μ(x) is a useful importance function and that Eq. (3.4) offers a potential computational advantage over Eq. (3.1) with respect to rare-event issues.

Equations (3.4)-(3.6) represent the full, N-temperature infinite swapping method. The invariant distribution involved is the sum of N! terms arising from all possible temperature permutations. If the number of temperatures is small, it is possible to sample this distribution directly. Even though complete INS sampling will become impractical beyond a modest number of temperatures, its consideration is useful since it provides both insights and benchmark examples that will prove useful for the development and validation of more generally applicable “partial” INS (PINS) approaches.

The fully symmetrized distribution is well defined and can be sampled using a variety of Monte Carlo techniques. One approach is shown in Appendix A and its application illustrated with a simple example. This approach may be valuable since, with suitable extension, it is well suited for both full and partial INS applications.

Simple card games played an important role in the discovery of modern Monte Carlo methods. They also provide a useful framework for understanding the partial swapping approach described in Appendix B. Generating all possible permutations of the symmetrized distribution μ(x) is analogous to the problem of achieving all possible orderings in a deck of cards. Card shuffling techniques can be designed in a variety of ways. The most straightforward is to shuffle the entire deck at once. Alternatively, one can perform a multi-player shuffle in which players individually partition the deck into subsets, shuffle the cards within each of the subsets generated by their partitioning and then pass the deck to another player. As long as the partitionings involved do not share a common boundary, the resulting process will produce a complete shuffling. A simple, two-player, three-card example serves to illustrate the basic idea. Assume that when they have control of the deck, the players' actions are as follows:

Player-1: leave top card in place, shuffle cards two and three

Player-2: shuffle top two cards, leave card three in place.

Although neither player's individual actions would do so, the actions of the two players combined will shuffle the entire deck. Randomization is produced locally by the individual players and globally by their interaction. It is important to note that, even when the number of cards (temperatures) involved is large, the explicit randomization steps involve subsets whose sizes can be made controllably small. A general “dual” (two-player) sampling procedure is outlined based on this idea in Appendix B.

It is useful to note that the methods described in Appendix A and B contain internal diagnostics that can be helpful in numerical applications. Specifically, the statistical weights associated with the various permutations, Pn(x), contain information that provides insight into the nature of the sampling. If only a small number of the permutations in the relevant tempering ensemble have significant statistical weight, the sampling benefits associated with symmetrization will be minimal. This situation might arise, for example, if the spacings between the temperatures in the ensemble are too large. If, on the other hand, the ensemble temperatures are well chosen, then the statistical weight will be spread more broadly across the computational ensemble. The Shannon entropy associated with the ρ-values involved,

$${S}_{p} = - {\sum }_{n} {ρ}_{n} log ( {ρ}_{n} ) , \qquad ( 3.7 )$$

is a measure of the dispersion of such ?-values and thus provides a useful device for monitoring the sampling.

Numerical Applications

A series of studies is presented below that are designed to explore the utility of the infinite and partial infinite-swapping approaches. Because they provide a common environment for few and many-body systems, exhibit a range of computational challenges, and have an extensive published literature, Lennard-Jones clusters have been chosen as the subject for these investigations. A series of relatively simple applications is used that illustrates the basic elements of the present approach and that provides a convenient means for comparing the performance of infinite swapping methods to that of current techniques. After these initial tests, a series of applications to systems of increasingly demanding rare-event character is presented in order to provide a basis for gauging the performance of the new techniques.

Unless otherwise stated, the following computational details apply to all studies discussed in the present section. Interaction potentials are assumed to be a sum of pairwise Lennard-Jones interactions of the form,

$$v ( r ) = 4 ɛ ( {( \frac{σ}{r} )}^{12} - {( \frac{σ}{r} )}^{6} ) , \qquad ( 4.1 )$$

where and are energy and length scale parameters, respectively and r is the interparticle separation. Dimensionless energy and length scales, set by and, are used throughout. Temperatures quoted are in dimensionless form (k_{B}T/ε) and all times are expressed in natural Lennard-Jones units, (/mσ²)^{1/2}, where m is the atomic mass. Cluster evaporation is controlled by means of the customary addition of a confining potential to the pairwise Lennard-Jones interactions. The form of the confining potential used in the present study is

$$\begin{matrix}{V}_{c} ( {r}_{1} , {r}_{2} , … , {r}_{N} ) = {\sum }_{i = 1}^{N} {v}_{c} ( {r}_{i} ) , \\ where & ( 4.2 ) \\ {v}_{c} ( r ) = {ɛ ( \frac{\vert r - {r}_{c m} \vert}{{R}_{c}} )}^{20} , & ( 4.3 )\end{matrix}$$

and where r_{cm} and R_{c} are the cluster center of mass and constraining radius, respectively. In order to provide a uniform basis for comparison of the various sampling methods being discussed, a common technique, the smart Monte Carlo (SMC) method, is used to perform the necessary sampling moves. The choice of the SMC approach is based on a variety of considerations. At the practical level, SMC methods make use of familiar and readily available molecular dynamics techniques, thus making them relatively easy to implement. In addition, dynamically based SMC methods are well-suited for treating the correlated, many-particle barrier dynamics involved in these activated processes. In the SMC approach “moves” are generated by assigning Gaussian random moments, a characteristic of the temperature in question to all Cartesian degrees of freedom for the cluster and then propagating the classical equations of motion forward for a specified length of time via molecular dynamics methods. As defined, SMC “moves” thus involve the displacement of all cluster coordinates. Subsequent moves are generated by repeating this process with the last configuration serving as the starting point for the next move. Provided that the total system energy is conserved for the molecular dynamics segments, the configurations so produced provide a proper sampling of the Boltzmann distribution of positions at the specified temperature. Because the time scale for the molecular-dynamics segments involved is relatively short (on the order of the cluster vibrations), it is relatively easy to achieve an acceptable level of energy conservation. Fourth-order Runge-Kutta methods with step sizes of between 0.005 and 0.010 Lennard-Jones time units are utilized for all molecular dynamics integration tasks in the present work.

TABLE 1

| k_{B}T/ε | INS | 1-4/4-1 | 2-3/3-2 | 1-2-2/2-2-1 | Metropolis |
|---|---|---|---|---|---|
| 0.0500 | −5.8370 (3) | −5.8374 (3) | −5.8375 (3) | −5.8378 (4) | −5.8366 (7) |
| 0.0600 | −5.8007 (3) | −5.8012 (4) | −5.8010 (4) | −5.8013 (4) | −5.8017 (9) |
| 0.0800 | −5.7219 (5) | −5.7223 (5) | −5.7227 (6) | −5.7225 (6) | −5.7225 (12) |
| 0.1000 | −5.6300 (8) | −5.6305 (10) | −5.6310 (9) | −5.6297 (10) | −5.6319 (17) |
| 0.1200 | −5.5191 (18) | −5.5184 (20) | −5.5184 (18) | −5.5190 (20) | −5.5178 (24) |

Table 1 shows a series of average potential energies computed for the simple, four-atom LJ cluster at five temperatures. These results are computed for the various temperatures using a number of different approaches, including the ordinary Metropolis technique, INS, and three different PINS approaches. The numbers quoted in parentheses are the standard deviation estimates for the last digit quoted in the associated results. To facilitate comparison, all results are generated using 2×105 SMC moves of 0.50 time duration and a confining potential parameter of R_{c}=2.5. Of these moves, S×10⁴ are used as warm-up. Because there is only one stable potential minimum, rare-event sampling issues are not a concern for this system. What is relevant is that in Table I that all methods yield consistent estimates of the average potential energy at the various temperatures involved. In particular, the average potential energies produced by the full INS method, various types of PINS sampling, and single-temperature Metropolis sampling all agree.

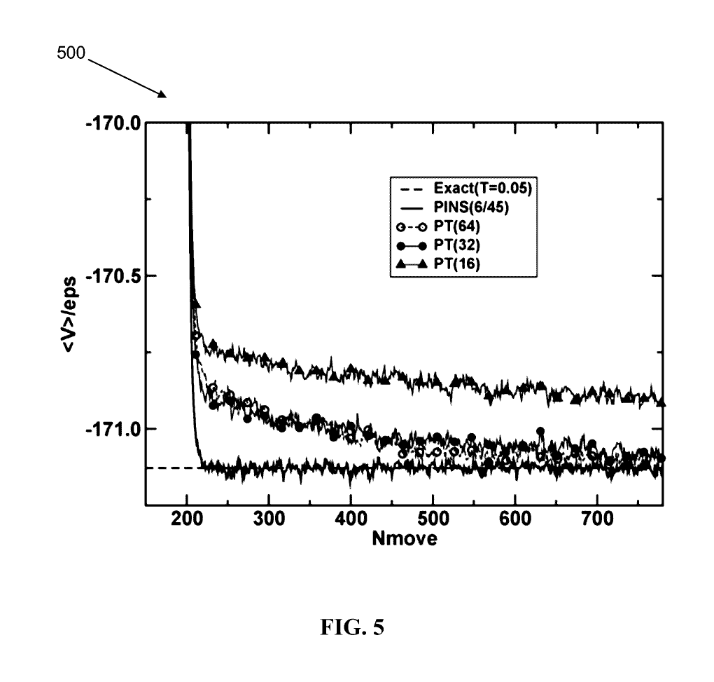

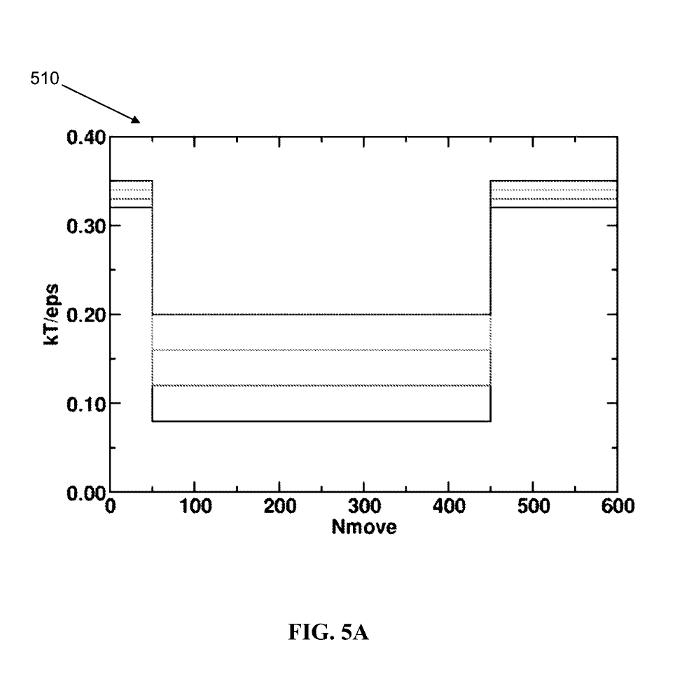

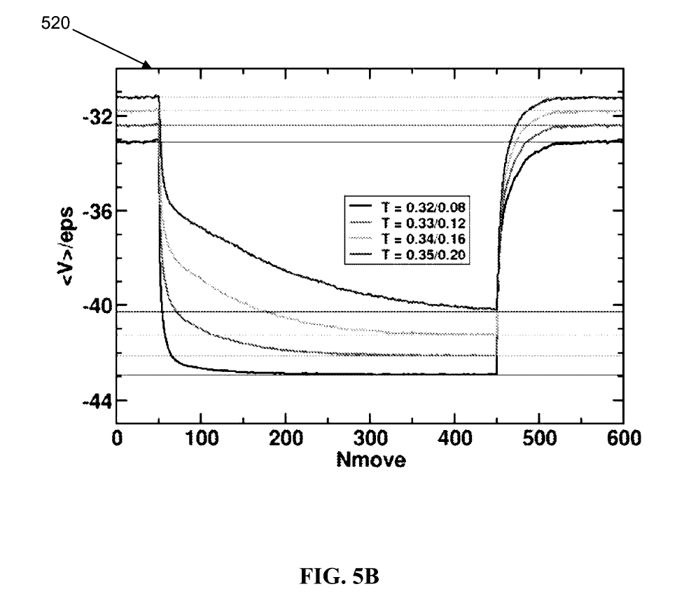

A comparison is now made of the performance of a number of different sampling methods for a series of increasingly demanding applications. FIG. 5a is a temperature profile plot for four relaxation simulations, in accordance with some embodiments. FIG. 5b is a relaxation curve plot using infinite swapping, in accordance with some embodiments. “Relaxation experiments,” of the type illustrated in FIG. (5) for a simple 4-temperature 13-atom LJ cluster, are a convenient device for making such comparisons. The idea behind such numerical experiments is to impose a periodic temperature variation in the computational ensemble and to monitor the response of a calculated average property, in this case the average potential energy. One period of the temperature variations used in the present study is shown in FIG. (5a). As this cycle is repeated, potential energies corresponding to various numbers of SMC moves are accumulated and “relaxation” curves of the type shown in FIG. (5b) are generated. The results in FIG. (5b) are generated using 2000 heating/cooling cycles of the type displayed in FIG. (5a) using complete INS sampling. SMC moves of 0.50 duration and a confining potential parameter of R_{c}=2.5 are used. For comparison purposes, the values of the average potential energies for the high and low-temperatures shown in FIG. (5b) are computed in separate INS simulations using 6×10⁵ SMC moves. The rates at which the heating/cooling curves approach their limiting equilibrium values can be seen in FIG. (5b).

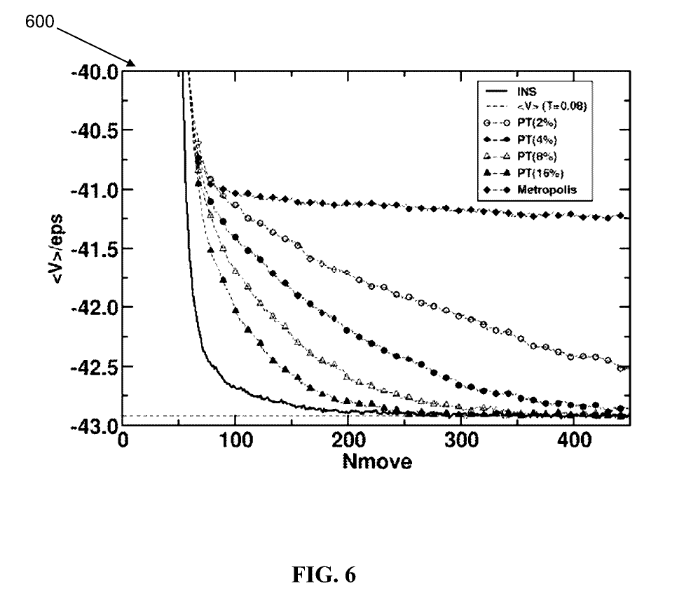

FIG. 6 is a cooling portion of the lowest-temperature curve in FIG. 5b, in accordance with some embodiments. Relaxation studies allow us to compare the rates of equilibration for different sampling methods. In FIG. (6), for example, the cooling portions of the lowest of the four temperatures shown in FIG. (5) are obtained for comparison using various sampling methods, including INS sampling, parallel tempering, and conventional single-temperature Metropolis methods. The parallel tempering results shown in FIG. (6) are labeled with the percentages of trial swap moves involved. Specifically, the percentage stated corresponds to the probability that during each update of the coordinates there is an attempted parallel tempering exchange between one, randomly chosen, nearest-neighbor pair of temperatures. In this notation, conventional, single-temperature Metropolis results correspond to the zero swapping limit of parallel tempering. The other computational parameters used for the studies of FIG. (6) are the same as those in FIG. (5). To provide a common basis for comparison, all studies in FIG. (6), including the conventional Metropolis approach, utilize SMC sampling moves of duration 0.50. The observed rates of equilibration for the sampling methods vary significantly, with conventional, single-temperature Metropolis sampling being the slowest and the INS approach the fastest. In FIG. (6) that over the range typically utilized in parallel tempering simulations the rate of equilibration is an increasing function of the percentage of pair swap attempts.

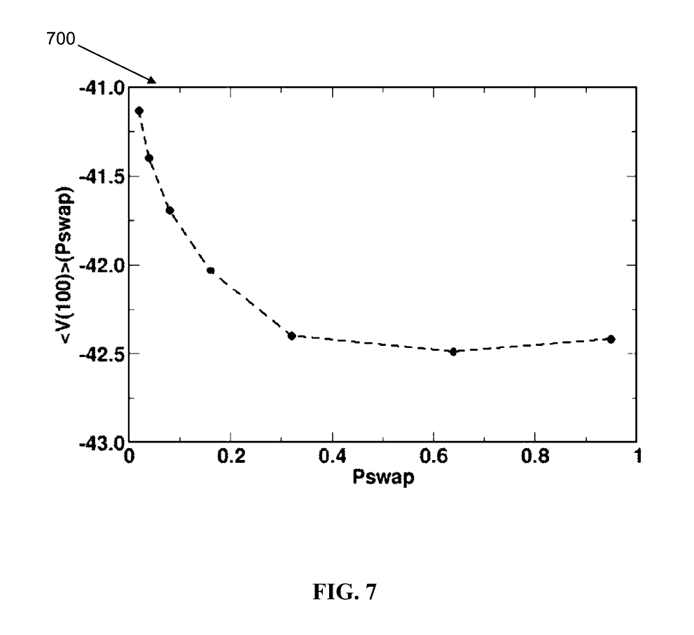

FIG. 7 is a plot of a representative value on the parallel tempering relaxation curves of FIG. 6, in accordance with some embodiments. As discussed in Section II and as illustrated in FIG. (7), the improvement in the convergence rate (as measured by the value of <V> at a particular point on the relaxation curve) ultimately saturates and reverses as the percentage of attempted pair swaps is increased. The “optimal” swap percentage for this example is larger than that commonly utilized in tempering applications. It should be noted that “optimal” as described herein may refer to a relative degree of optimality with regards to the prior art, or to a degree of optimality within the framework of the disclosed invention, or to another meaning of the term.

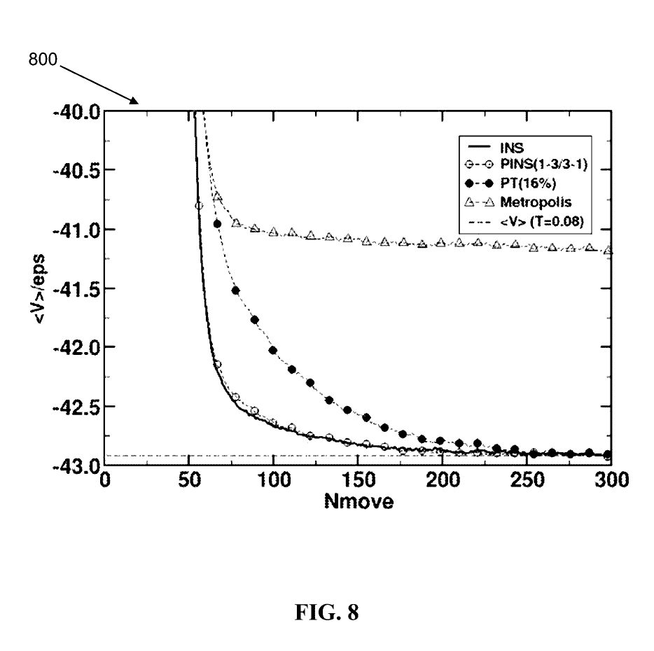

Finally, an examination of the quality of the partial infinite swapping approach is shown below. FIG. 8 is a plot of a representative value on the parallel tempering relaxation curves of FIG. 6 using partial infinite swapping, in accordance with some embodiments. In FIG. (8) the cooling curves for the INS and parallel tempering results of FIG. (6) are compared with that obtained using a dual-chain PINS approach. Using the notation of Appendix B, both PINS chains are composed of two temperature blocks, a lowest temperature and a group of three higher temperatures for one chain and group of three lower temperatures and a single highest temperature for the other. The performance of this PINS(1-3/3-1) approach is quite similar to that of the full infinite swapping method. For example, the value of <V> for the PINS(I-3/3-1) cooling curve at Nₘₒᵥₑ=100, the point used in FIG. (7) to gauge the rate of parallel tempering equilibration, is −42.64, quite close to that produced by the full INS simulation (−42.66) and better than the “optimal” parallel tempering result of FIG. (7) (−42.49). Although encouraging, conclusions concerning the performance and general utility of the PINS method await more serious tests.

The 38-atom Lennard-Jones cluster is an appreciably more complex system than those considered thus far. The potential energy surface for this system exhibits a multi-funnel structure in which the global and lowest-lying local minimum differ in energy by an amount that is small relative to the barrier that separates them. This and the presence of roughly 4×10⁴ local minima are indications that the LJ-38 system presents non-trivial computational challenges.

Although other, more effective methods are shown later, the LJ-38 investigations are first shown with a series of applications that utilize a rather basic version of the PINS approach, the “floating” partial swapping method. As discussed in Appendix B, this simple approach utilizes a symmetrized band of temperatures that moves randomly within the larger computational ensemble. Using these methods, the issue of equilibration in the LJ-38 system is examined.

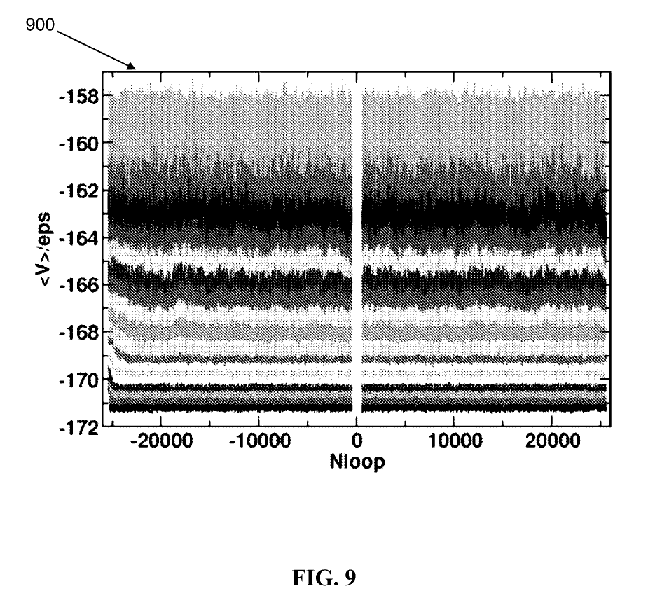

FIG. 9 is a loop average potential energy plot for a 38-atom Lennard-Jones cluster, in accordance with some embodiments. In FIG. (9) loop averages (100 SMC moves per loop) are compared for two different six-temperature floating PINS simulations. Both simulations use ensembles that contain 45-temperatures that span the range from (0.050-0.210) in steps of 0.005 and the range from (0.210-0.330) in steps of 0.010. SMC moves of 1.00 duration and a confining potential parameter of R_{c}=2.65 are used. Loop averages shown in FIG. (9) correspond to the potential energies for 18 of the 45 temperatures and cover the range from 0.050-0.180. Results shown on the left in FIG. (9) are from a simulation that is initiated using a randomly chosen, high-temperature “melt” configuration (a down-anneal) while those on the right are from a second simulation that is initiated using the known global minimum configuration (an up-anneal). For ease of visual comparison of the final results, the output for the up-anneal simulation is displayed in reverse in FIG. (9). That is, the results of the two simulations begin at the edges and end in the center of the figure. The loop averages generated in the up and down anneals for the various temperatures are consistent (i.e. merge as they approach the center of the figure).

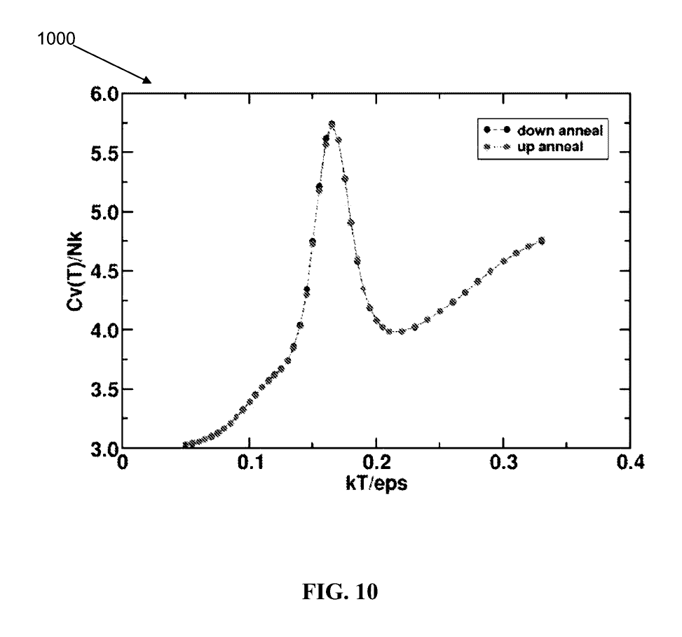

FIG. 10 is a heat capacity plot for a 38-atom Lennard-Jones cluster, in accordance with some embodiments. As further evidence of this consistency, the heat capacities computed using the last 20,000 loops or 2×10⁶ SMC moves of both simulations are compared in FIG. (10). The heat capacities for these two simulations, including the “shoulder” region between temperatures of 0.10 and 0.15, are in good agreement.

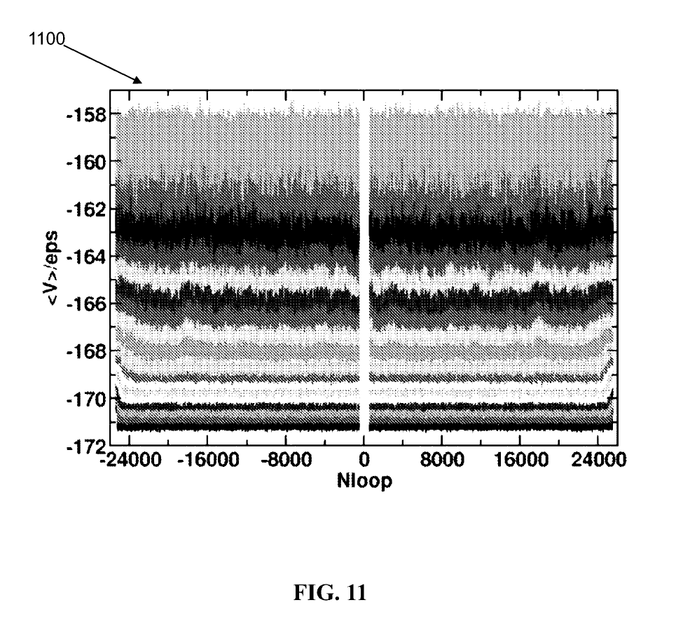

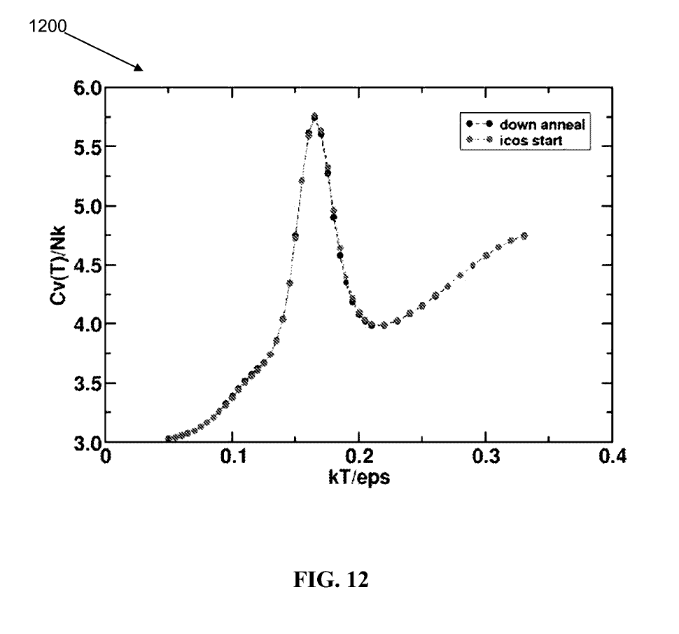

FIG. 11 is a loop average potential energy plot for a 38-atom Lennard-Jones cluster with an alternate simulation start point, in accordance with some embodiments. FIG. 12 is a heat capacity plot for a 38-atom Lennard-Jones cluster with an alternate simulation start point, in accordance with some embodiments. In FIGS. (11) and (12) additional LJ-38 equilibration and heat capacity studies are presented. In these figures the up-anneal results of FIGS. (9) and (10) are replaced with analogous six-temperature floating PINS results in which the initial configuration is taken to be that of the lowest-lying LJ-38 icosahedral isomer instead of the global minimum. Significant equilibration difficulties have been reported for parallel tempering simulations involving this particular isomer. The quality of the PINS results in FIGS. (11) and (12) are similar to those shown in FIGS. (9) and (10), a further indication that PINS methods are effective in coping with the rare-event sampling issues presented by the LJ-38 system.

The LJ-38 results shown in FIGS. (9-12) indicate that the floating PINS approach is a useful technique. It is important to note, however, that other, more effective methods are available. As an illustration, FIG. (13) shows the results of a series of numerical relaxation experiments for the LJ-38 system. These are obtained using parallel tempering (16% swap rate), floating PINS and dual-chain PINS approaches for the 45 temperature ensemble described previously. For simplicity, only results for the lowest temperature in the computational ensemble are shown. Because the floating PINS simulation is based on a six-temperature symmetrized block, a dual-chain PINS study is shown in which sampling chains are composed of the same size blocks. Specifically, each of the chains is composed of seven, six-temperature blocks plus one smaller block of three temperatures for a total of 45 temperatures. In one chain, the three-temperature block is made up of the lowest three temperatures, in the other chain the highest three. Heating and cooling profiles used are of the generic type illustrated in FIG. (5a). In the present study, however, the cycles consist of 1200 SMC moves, each of one unit Lennard-Jones time duration. The cooling segment is taken as the portion of the cycle from moves 200 to 800 with the remainder being the heating portion. During the cooling portion of the cycle the 45 temperatures in the ensemble cover the range from (0.050-0.210) in temperature steps of 0.005, and from (0.210-0.330) in steps of 0.010 while during the heating portion of the cycle temperatures less than or equal to 0.150 are set equal to 0.150. It should be noted that for a fixed block size, the computational effort in the dual-chain PINS approach grows linearly in the total number of temperatures. All simulations utilize a constraining radius of R, =2.65 and are obtained using 600 thermal cycles.

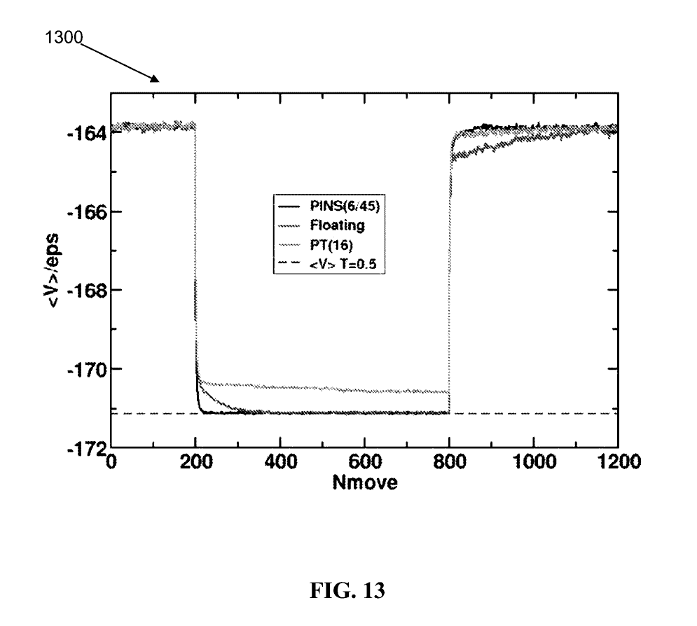

FIG. 13 is a relaxation plot for a 38-atom Lennard-Jones cluster, in accordance with some embodiments. In FIG. (13), equilibration is achieved by both the floating and dual-chain PINS approaches and that the rates for both are significantly better than those of parallel tempering. In fact, evidence of incomplete equilibration is seen in the parallel tempering results of FIG. (13). The rates of equilibration for the dual-chain PINS approach are also significantly better than those for the simple floating PINS approach. It is important to note that this improvement in equilibration rates is achieved with a relatively modest increase in computational effort. For example, the computing times required for the floating and dual-chain PINS results in FIG. (13) are only 9% and 12% more than those required for the corresponding parallel tempering results, respectively.

Finally, a 31-atom Lennard-Jones cluster is considered, a system that offers a number of interesting features. As discussed by Doye, et al., the potential energy surface for this system is relatively complex with many, nearly degenerate local minima separated by large barriers. This complex energy landscape makes locating the global minimum structure difficult and produces a low-temperature heat capacity feature that represents a challenging computational objective.

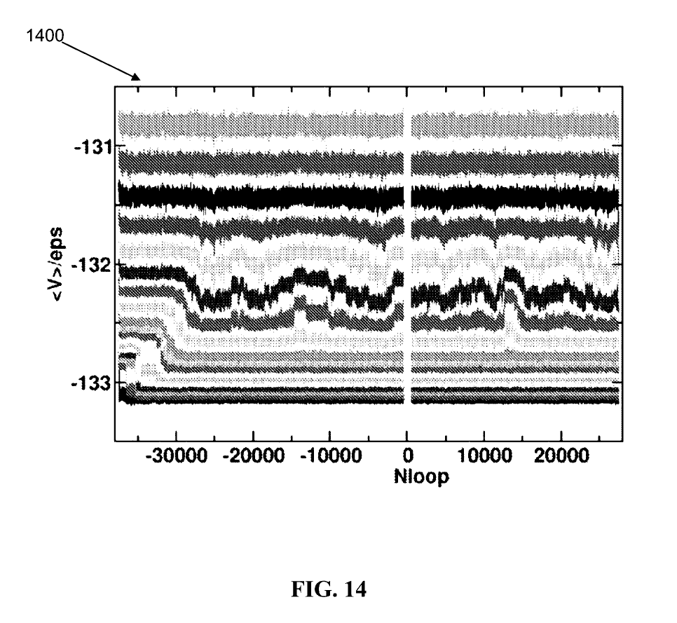

FIG. 14 is an equilibration plot for an LJ-31 system, in accordance with some embodiments. In FIG. (14) down and up-anneal studies are presented for the LJ-31 system. The results shown are obtained using two PINS(4/54) simulations. As with the previous LJ-38 studies, the down-anneal starts from a randomly chosen, high-temperature “melt” configuration while the up-anneal is initiated using the known global minimum. The 54 temperatures in the ensemble are distributed geometrically in the range (0.01, 0.35). Loop averages for 18 temperatures over the range (0.01,0.0535) are shown in FIG. (14). These simulations contain various numbers of loops that consist of 100 SMC moves per loop, with each SMC move being of unit time duration. The confining radius used in these LJ-31 studies is R_{c}=3.00, the same as that in Ref (33). The down-anneal simulation uses 37,000 total loops with the final 25,000 being used for data collection. Because the warm-up period involved is appreciably smaller, the up-anneal uses 27,000 total loops, again with the final 25,000 being for data collection.

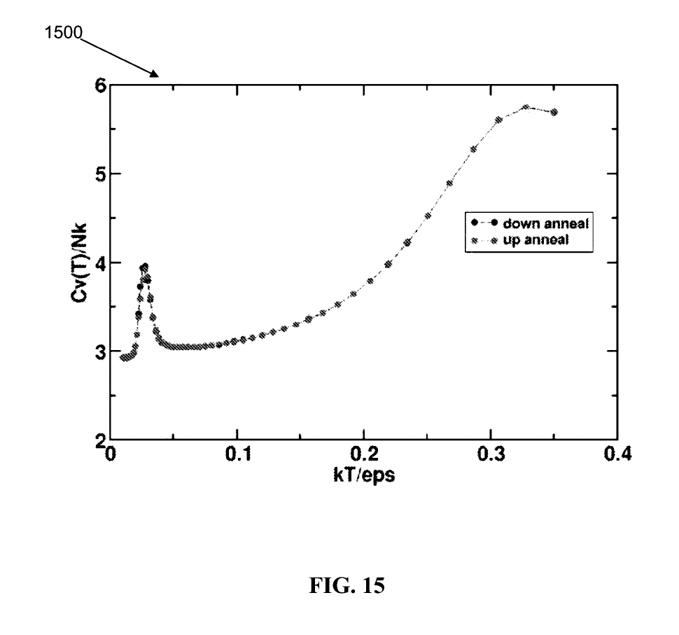

FIG. 15 is a heat capacity plot for an LJ-31 system, in accordance with some embodiments. The heat capacities for the LJ-31 system computed from these two simulations are shown in FIG. (15). As was the case with the analogous LJ-38 studies, the agreement of the heat capacities produced by the up and down-anneal simulations is quite good, including the region of the low-temperature heat capacity peak near T=0.027. The potential energy fluctuations associated with rare-event hops between the various local minima that produce this low-temperature heat capacity feature are evident in FIG. (14) in the potential energy range of roughly −132.5±0.5.

Discussion and Summary

The rare-event sampling problem is a troublesome and ubiquitous one. The present work develops an approach for dealing with such problems that is based on the use of symmetrization. In addition, the results have been shown for an initial series of applications to a representative class of problems, the calculation of the thermodynamic properties of Lennard-Jones clusters. Preliminary findings suggest that the infinite swapping approach is an effective tool for dealing with rare-event problems and represents an improvement over parallel tempering.

It is important to note that, while both the infinite swapping and parallel tempering approaches utilize an expanded computational ensemble to improve their rare-event sampling performance, there is an important distinction between the two approaches. In parallel tempering the invariant distribution is a simple product of individual Boltzmann components. The transfer of temperature-related information used to improve the rare event sampling is achieved by expanding the space of possible trial moves to include swaps of data between the various temperature streams. In contrast, the invariant distribution for the infinite swapping approach is a thermally symmetrized sum of Boltzmann-like terms. This distribution is more highly connected than the original, unsymmetrized form. Moreover, its basic structure intrinsically entangles temperature and coordinate information thereby increasing the flow of temperature-related information within the computational ensemble. This increased flow of information is at the core of the infinite swapping approach. Practical methods for sampling the associated distributions have been presented and discussed.

Beyond the classical statistical-mechanical applications considered in the present work, infinite swapping methods would appear to have other areas of potential utility. One obvious area is that of minimization. Preliminary applications suggest that the increased flow of temperature-related information makes INS-inspired approaches useful for such applications and that further investigations are warranted. Quantum simulations, where the problems of sampling symmetrized and sparse distributions arise naturally in path-integral simulations, are other areas of possible payoff.

### APPENDIX A

An approach called the infinite swapping sampling approach is described by illustrating its application to the calculation of a representative thermodynamic property, the average potential energy at a specified temperature, Tₖ. For simplicity, this temperature is one of the set of ensemble temperatures {Tⱼ}, j=1,N. The N sets of system coordinates, (x₁, x₂, . . . , x_{N}), are collectively denoted as X. The fully symmetrized distribution is defined in Eq. (3.6) and the statistical weight, ρₙ(x₁, x₂, . . . , x_{N}) for each of the N! possible permutations is given by Eq. (3.5). Assuming that the configuration at the mth step is denoted by (x_{1,m}, x_{2,m}, . . . , x_{N,m}), or as simply Xₘ, the sampling process includes the following steps:
calculate the ρ-weights for the current configuration, {ρₙ(Xₘ)}, for all permutations in the N-temperature ensemble, n=1,N!;
select one of the ρ-weights randomly according to its size;
generate a new configuration, Xₘ₊₁, by making single-temperature moves for each of the coordinate sets using the temperature-coordinate associations inherent in the randomly chosen permutation;
calculate the ρ-weights for all permutations in the N-temperature ensemble for the new configuration, {ρₙ(Xₘ₊₁)},n=1,N!;
update the accumulating sum being used to assemble the <V>k average by adding Δₘ₊₁(k)=Σⱼ₌₁^{N}V(x_{j,m+1})Γ(j,k) to the kth sum, where Γ(j,k) is equal to the sum of the ρ-weights for all permutations in which coordinate set j is associated with temperature Tk; and
repeat the process using the new configuration, Xₘ₊₁, as input.

As an illustration, the above process is followed through a hypothetical cycle for a one-dimensional system and a three-temperature ensemble. If the permutation in which x_{K} is associated with temperature 1, x_{L} with temperature 2, etc. is denoted by [K, L, . . . ], then the six possible permutations arising from the three-temperature ensemble are given by

n Pn

1 [1,2,3]

2 [1,3,2]

3 [2,1,3]

4 [2,3,1]

5 [3,1,2]

6 [3,2,1]

Given a particular configuration, (x_{1,m}, x_{2,m}, x_{3,m}) the ρ-values associated with each of the possible permutations are first evaluated, and then one of these permutations is selected randomly in proportion to its size. For purposes of illustration, permutation 3 in the above table is the permutation selected. Single-temperature Monte Carlo moves would then be made in which coordinate 2 would be advanced using temperature T1, coordinate set 1 using temperature T2, and coordinate 3 using temperature T3. The potential energies, {V(xⱼ)}, and ρ-weights, {ρₙ(xⱼ)}, j=1,3, n=1,6 corresponding to the new coordinates would be computed and the three accumulating sums being used in the calculation of the potential energy averages would be updated as

Sum(T₁)→Sum(T₁)+V(x₁)(ρ₁+ρ₂)+V(x₂)(ρ₃+ρ₄)+V(x₃)(ρ₅+ρ₆)

Sum(T₂)→Sum(T₂)+V(x₁)(ρ₃+ρ₅)+V(x₂)(ρ₁+ρ₆)+V(x₃)(ρ₂+ρ₄)

Sum(T₃)→Sum(T₃)+V(x₁)(ρ₄+ρ₆)+V(x₂)(ρ₂+ρ₅)+V(x₃)(ρ₁+ρ₃).

### APPENDIX B

In this appendix the partial INS sampling approach is described. As in Appendix A, an N-temperature ensemble is assumed and the objective is the calculation of thermodynamic properties such as the average potential energy. The methods outlined herein are designed for the calculation of such single-temperature properties. With suitable extension more general properties, for example those that depend on the joint distribution of multiple temperatures, can also be treated.

The procedure described herein is a “dual-chain” process in which the full, N-temperature set is partitioned into blocks in two distinct ways. Unlike the full INS approach, symmetrization is partial and is confined to the various temperature blocks that make up the two chains. The two chains are labeled α and β and denote the temperatures for block-1 of chain-α as {Tⱼ^{α}^{₁}}, those for block-2 of the chain-β as {Tⱼ^{β}^{₂}}, etc. The system configuration at the mth step in the sampling is denoted as (x_{1,m}, x_{2,m}, . . . , x_{N,m}) or as simply Xₘ. When necessary, partition and temperature block labels can also be included. For example, the coordinates at the mth sampling step of block-1 of chain-α are labeled as Xₘ^{α}^{₁}, for block-2 of chain-β as Xₘ^{β}^{₂}, and so on. Unless stated otherwise the partitionings of chains α and β are assumed to remain fixed during the simulation.

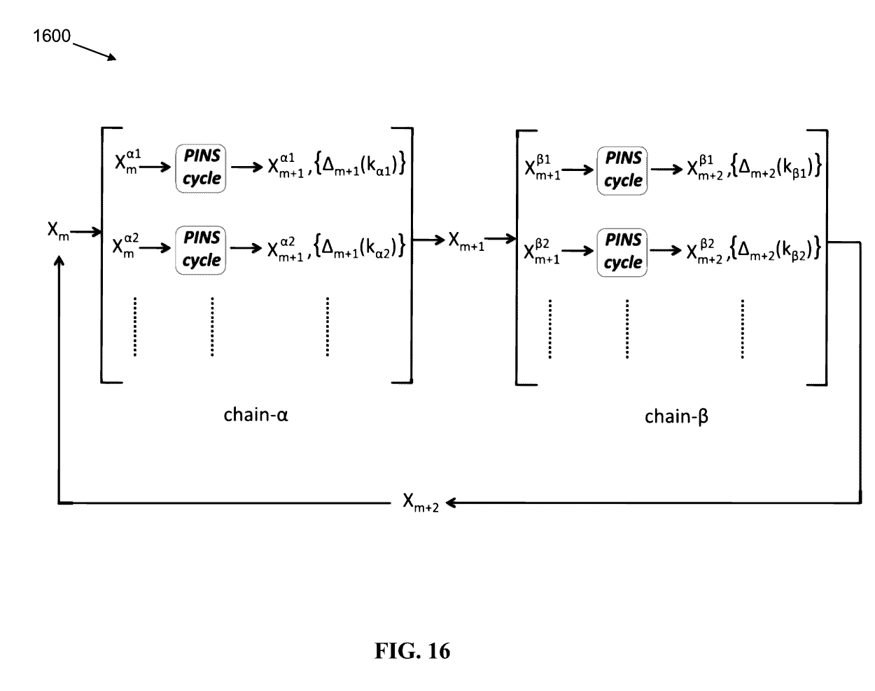

FIG. 16 is a schematic diagram of the partial infinite swapping approach, in accordance with some embodiments. The overall structure of the dual-chain PINS sampling method is depicted schematically in FIG. (16). Local mixing within blocks is produced by symmetrization while larger-scale mixing is generated by the exchange of information between chains. The individual chains are consistent with multiple invariant distributions, namely those that have the proper relative weights of the permutations within the various blocks. The unique distribution that the chains share is the fully symmetrized distribution. Consequently, while neither chain will do so individually, the two chains working in tandem will, if suitably designed, generate a proper sampling of the fully symmetrized distribution, Eq. (3.6). It is important to note that the PINS approach avoids dealing with all possible permutations simultaneously. Because the two chains utilize different partitionings, a proper sampling requires that rules be specified both to govern the construction of the required thermodynamic averages from the information produced by the individual chains and to control the “hand-off” of data between them. In these applications thermodynamic information emerges in the form of update increments that are accumulated to produce the average potential energies at the various temperatures. In FIG. (16) the potential energy increments for the temperatures in the first block of chain-α at step m+1 are denoted as Δₘ₊₁(k_{α1}), those at step m+2 for the temperatures in the second block of chain-β as Δₘ₊₁(k_{β1}), and so on. The PINS sampling process is first described in general terms and then illustrate its use by considering a particular example. Assuming that the m+1st step starts with temperature block-1 of chain-a, the detailed steps in the “PINS cycle” depicted in FIG. (16) are as follows:
define Yₘ=Xₘ^{α}^{₁};
calculate the ρ-weights, {ρₙ(Yₘ)}, n=1, N(α₁), for all N(α₁) permutations in block
select one of the ρ-weights randomly in proportion to its size;
generate a new configuration, Yₘ+1, using the temperature-coordinate associations inherent in the randomly chosen permutation;
calculate the new ρ-weights, {ρₙ(Yₘ₊₁)}, n=1, N(α₁), for all N(α₁) permutations in block α₁;
calculate the potential energy update increments for the temperatures in the block

$${Δ}_{m + 1} ( k ) = \sum \text{?} ( λ {\text{?}}^{w + 1} ) L ( \text{?} ) , \\ \text{?} \text{indicates text missing or illegible when filed}$$

where r(j,k) is equal to the sum of the ρ-weights for all permutations of block α₁ in which coordinate set j is associated with temperature Tₖ;
select one of the newly generated ρ-weights randomly in proportion to its size; and
use the temperature-coordinate associations in the randomly selected permutation to generate the coordinates for block α₁ at the m+1st step, Xₘ₊₁^{α}^{₁} to be handed off to the complementary chain.

These steps are then repeated for the remaining blocks in chain-α. After all chain-α steps are complete, the Xₘ₊₁^{α}^{₁} coordinates for the various blocks are merged to form the new configuration, Xₘ₊₁, and this configuration is passed on to chain-β as indicated in FIG. (16). Chain-β then produces a new configuration, Xₘ₊₂, which is then passed back to chain-α, etc. and the process is repeated as necessary.

The PINS procedure is illustrated by considering its application to the three-temperature example of Appendix A using a dual-chain PINS(I-2/2-I) approach. This designation indicates that chain-α consists of a single-temperature block at temperature TI and a two-temperature, symmetrized block involving the temperatures T2 and T3. In chain-β, on the other hand, the two-temperature block is made up of temperatures TI and T2 while the single temperature block involves only T3. This system is the analog of the three-card example discussed near the end of Section III. For simplicity, the configuration at the mth sampling step is given by Xm=(x_{1,m}, x_{2,m}, x_{3,m}) and that the next sampling move involves chain-α. Defining Ym=Xm, the blocks and the p-values for the permutations in the two blocks in chain-α are evaluated numerically as:

| Block | n | ρₙ(Yₘ) |
|---|---|---|
| 1 | 1 | 1 |
| 2 | 1 | π(y_{2,m}, T₂)π(y_{3,m}, T₃)/(π(y_{2,m}, T₂)π(y_{3,m}, T₃) + |
| | | π(y_{3,m}, T₂)π(y_{2,m}, T₃)) |
| | 2 | π(y_{3,m}, T₂)π(y_{2,m}, T₃)/(π(y_{2,m}, T₂)π(y_{3,m}, T₃) + |
| | | π(y_{3,m}, T₂)π(y_{2,m}, T₃)), |

where n(y,T) is the single-temperature Boltzmann distribution defined by Eq. (2.3). In block-1 of chain-a, the coordinate-temperature association involves y₁ and T₁. Consequently, Y_{1,m+1} is generated from y₁, m using the temperature T₁ and any suitable, single-temperature Monte Carlo procedure. Smart Monte Carlo methods are used for the applications in Section IV. Since there is only one coordinate and temperature for block-1, x_{1,m+1}=y_{1,m+1} and the potential energy increment is Δₘ₊₁(T₁)=V(y_{1, m+1}). To generate the sampling moves for block-2 of chain-α, evaluation of the block's ρ-values, ρ₁ and ρ₂, occurs for the variables (y_{2,m}, y_{3,m}) and one of the ρ-values is selected randomly in proportion to its size. For illustration purposes ρ₂ is assumed to be selected. Continuing, a Monte Carlo move is made from y_{2,m} to y_{2,m+1} and y_{3,m} to y_{3,m+1} using the temperature-coordinate associations in the selected term. From the last line of the table above, the temperature-coordinate associations in ρ₂ is seen to involve the pairings y₂-T₃ and y₃-T₂. Consequently, y₂ is advanced at a temperature T₃ and y₃ at a temperature T₂. Had PI been chosen instead, the y₂ advance would have been made using the temperature T₂ and the corresponding y₃ advance using the temperature T₃. Using the new configuration yₘ₊₁=(y_{2,m+1}, y_{3,m+1}), re-evaluation occurs of the block-2 ρ-values, ρ₁(yₘ₊₁) and ρ₂(yₘ₊₁). These newly generated ρ-values are then used to produce the potential energy increments for T₂ and T₃ as well as the values of (x_{2,m+1}, x_{3,m+1}) that will be “handed-off” to chain-β. The potential energy increments are given by

Δₘ₊₁(T₂)=V(y_{2,m+1})ρ₁(Yₘ₊₁)+V(y_{3,m+1})ρ₂(Yₘ₊₁)

Δₘ₊₁(T₃)=V(y_{2,m+1})ρ₂(Yₘ₊₁)+V(y_{3,m+1})ρ₁(Yₘ₊₁)

To generate the values of (x_{2,m+1}, x_{3,m+1}) that, along with x_{1,m+1}, will be passed on to chain-β, selection of one of the new ρ-values randomly in proportion to its size and assignment of the (x_{2,m+1}, x_{3,m+1}) values based on the coordinate-temperature associations in the selected term is performed. The results for the two possible selections are

| term selected | y-T associations | x-assignments |
|---|---|---|
| ρ₁(Yₘ₊₁) | y₂-T₂, y₃-T₃ | x_{2,m+1} = y_{2,m+1} |
| | | x_{3,m+1} = y_{3,m+1} |
| ρ₂(Yₘ₊₁) | y₂-T₃, y₃-T₂ | x_{2,m+1} = y_{3,m+1} |
| | | x_{3,m+1} = y_{2,m+1} |

The final x-values so generated, xₘ₊₁=(x_{1,m+1}, x_{2,m+1}, x_{3,m+1}), are then handed off as input to chain-β and an analogous series of steps are made using that chain's partitioning. The xₘ₊₂ values produced by the β-chain are then handed back into the α-chain and the entire dual process is repeated.

Partitionings that are composed of multiple blocks that contain the same, even number of temperatures in combination with a single block that contains half that number of temperatures have been used for convenience. To assure that they share no common temperature boundaries, the smaller block in one chain is made up of the lowest temperatures of the ensemble while in the other it involves the highest. The major block size and total number of temperatures thus serve as identifiers of the sampling chains used in the simulation. In this more compressed notation, for example, the previous PINS(I-2/2-1) illustration is designated as a PINS(2/3) simulation.

One has significant flexibility in designing many of the details of the PINS sampling approach. Decisions concerning the potential merits of many of these various options await further study. One option is the choice of the single-temperature sampling method. Although all numerical examples presented here use smart Monte Carlo methods.r” any technique that provides a proper sampling of the Boltzmann distributions involved can be utilized for the single-temperature sampling tasks. While the infinite sampling approach is guaranteed to perform better than parallel tempering, the degree of improvement can depend on the particular sampling used for the single-temperature moves. Another example is the possible use of multi-chain methods. It is straightforward to formulate multi-chain sampling methods that are generalizations of the dual-chain techniques utilized in the present studies. Whether or not these, either by themselves or in combination with particular partitioning strategies, offer a computational advantage is an interesting and open question. Another example is the use of multi-step methods. In the present work only a single sampling step is made within each of the chains before handing-off the calculation to the complementary chain. It is important to note that multiple steps are permitted, a fact that may prove of practical significance in the context of parallel implementations of the PINS approach. Finally, the partitionings of the various chains need not remain fixed during the simulation. In the present work, for example, the “floating” PINS applications are implemented using a dynamical version of dual-chain sampling in which the chain partitions vary as a single, symmetrized block of temperatures moves randomly throughout the larger computational ensemble.

Figure Captions

FIG. 1:

Plots of V(x) for the double-well example (Eq. (2.2)) and three normalized Boltzmann distributions (Eq. (2.3)) corresponding to T=0.05, 0.20, 0.40.

FIG. 2:

Plot of the isosurface μ₀(x,y,z)=0.05, where μ₀ is defined in Eq. (2.4).

FIG. 3:

Plot of the isosurface μ_{xyz}(x,y,z)=0.05, where μ_{xyz} is defined in Eq. (2.5).

FIG. 4:

(a) Plot of the isosurface μ_{xy}(x,y,z)=0.05, where μ_{xy} is defined in Eq. (2.6), (b) Plot of the isosurface μ_{yz}(x,y,z)=0.05, where μ_{yz} is defined in Eq. (2.7).

FIG. 5:

(a) Temperature profiles for the four-temperature, LJ-13 relaxation simulations, (b) <V> values for the LJ-13 infinite swapping relaxation simulations performed using the temperature profiles in FIG. (5a).

FIG. 6:

The cooling portion of the of the lowest of the four-temperature studies of FIG. (5b). Results correspond to infinite swapping (INS), parallel tempering (PT), and ordinary Metropolis sampling. The dashed line corresponds to the numerically exact value of <V> for T=0.08.

FIG. 7:

A plot of a representative value on the parallel tempering relaxation curves of FIG. (6) (Nmove=100) as a function of the attempted pair swap probability (Pswap).

FIG. 8:

As in FIG. (6) with the addition of the partial swapping results (PINS).

FIG. 9:

Loop averages (100 moves/loop) of the potential energy of a 38-atom LJ cluster. Results are obtained using a 6-temperature floating PINS simulation starting from a “melt” configuration (left edge to center) and from a second simulation starting from the known global minimum geometry (right edge to center). The bands correspond to the potential energies of 18 temperatures from the range (0.05, 0.18).

FIG. 10:

Heat capacities for the LJ-38 system. The “down” (“up”) labels refer to the corresponding simulations of FIG. (9).

FIG. 11:

As in FIG. (9), except that the right hand portion of the plot corresponds to results obtained starting with the icosahedral isomer instead of the global minimum energy structure.

FIG. 12:

Heat capacities for the LJ-38 system extracted from the last 20,000 loops of the simulations of FIG. (11).

FIG. 13:

Relaxation simulations for LJ-38. The <V> values shown are for the lowest temperature of the 45-temperature ensemble (see text for details) and are obtained using parallel tempering (PT), a “floating” six temperature partial swapping approach, and dual-chain PINS(6/45) methods. The numerically exact results for <V>=0.05 are shown for comparison.

FIG. 14:

PINS(4/54) equilibration studies for the LJ-31 system. Temperatures in the ensemble are distributed geometrically in the range (0.01,0.35). Loop averages for 18 temperatures in the range (0.01,0.0535) are shown. Results on the left (right) side of the plot are initialized using a high-temperature melt configuration (the known global minimum geometry).

FIG. 15:

The heat capacities of the LJ-31 system as a function of temperature extracted from the final 25,000 loops of the PINS(4/54) simulations of FIG. (14).

FIG. 16:

A schematic depiction of the PINS sampling approach utilized in the present studies.

### APPENDIX C

The disclosure below provides further mathematical details regarding the disclosure.

### 1. Introduction

The problem of computing integrals with respect to Gibbs measures occurs in chemistry, physics, statistics, engineering, and elsewhere. In many situations, there are no viable alternatives to methods based on Monte Carlo. Given an energy potential, there are standard methods for constructing a Markov process whose unique invariant distribution is the associated Gibbs measure, and an approximation is given by the occupation or empirical measure of the process over some finite time interval [10]. However, a weakness of these methods is that they may be slow to converge. This happens when the dynamics of the process do not allow all important parts of the state space to communicate easily with each other. In large scale applications this occurs frequently since the potential function often has complex structures involving multiple deep local minima.
An interesting method called “parallel tempering” has been designed to overcome some of the difficulties associated with rare transitions [4, 6, 21, 22]. In this technique, simulations are conducted in parallel at a series of temperatures. This method does not require detailed knowledge of or intricate constructions related to the energy surface and is a standard method for simulating complex systems. To illustrate the main idea, we first discuss the diffusion case with two temperatures. Discrete time models will be considered later in the paper, and there are obvious analogues for discrete state systems.
Suppose that the probability measure of interest is μ(dx)∝e^{-V(x)/τ}^{₁}dx: where τ1 is the temperature and V: [symbol] → [symbol] is the potential function. The normalization constant of this distribution is typically unknown. Under suitable conditions on V, μ is the unique invariant distribution of the solution to the stochastic differential equation

$$dX = - ∇ V ( X ) dt + \sqrt{2 {τ}_{1} dW} ,$$

where W is a d-dimensional standard Wiener process. A straightforward Monte Carlo approximation to μ is the empirical measure over a large time interval of length T, namely,

$$\frac{1}{T} {\int }_{B}^{T + B} {δ}_{X ( t )} ( d x ) d t ,$$

where δₓ is the Dirac measure at x and B>0 denotes a “burn-in” period. When V has multiple deep local minima and the temperature Σ₁ is small, the diffusion X can be trapped within these deep local minima for a long time before moving out to other parts of the state space. This is the main cause for the inefficiency.
Now consider a second, larger temperature τ₂. If W₁ and W₂ are independent Wiener processes, then of course the empirical measure of the pair

dX₁=−∇V(X₁)dt+\sqrt{2τ₁dW₁,}

dX₂=−∇V(X₂)dt+\sqrt{2τ₂dW₂,} (1.1)

gives an approximation to the Gibbs measure with density

$$π ( {x}_{1} , {x}_{2} ) ∝ {e}^{- \frac{V ( {x}_{1} )}{{τ}_{1}}} {e}^{- \frac{V ( {x}_{2} )}{{τ}_{2}}} . \qquad ( 1.2 )$$

The idea of parallel tempering is to allow “swaps” between the components X₁ and X₂. In other words, at random times the X₁ component is moved to the current location of the X₂ component, and
vice versa. Swapping is done according to a state dependent intensity, and so the resulting process is actually a Markov jump diffusion. The form of the jump intensity can be selected so that the invariant distribution remains the same, and thus the empirical measure of X₁ can still be used to approximate μ. Specifically, the jump intensity or swapping intensity is of the Metropolis form ag(X₁, X₂), where

$$g ( {x}_{1} , {x}_{2} ) = 1 ⋀ \frac{π ( {x}_{2} , {x}_{1} )}{π ( {x}_{1} , {x}_{2} )} \qquad ( 1.3 )$$

and aε(0, ∞) is a constant. Note that the calculation of g does not require the knowledge of the normalization constant. A straightforward calculation shows that π is the stationary density for the resulting process for all values of a (see (2.2)). We refer to a as the “swap rate” and note that as a increases, the swaps become more frequent.
The intuition behind parallel tempering is that the higher temperature component, being driven by a Wiener process with greater volatility, will move more easily between the different parts of the state space. This “ease of movement” is transferred to the lower temperature component via the swapping mechanism so that it is less likely to be trapped in the deep local minima of the energy potential. This, in turn, is expected to lead to more rapid convergence of the empirical measure to the invariant distribution of the low temperature component. There is an obvious extension to more than two temperatures.
Although this procedure is remarkably simple and needs little detailed information for implementation, relatively little is known regarding theoretical properties. A number of papers discuss the efficiency and optimal design of parallel tempering [8, 16, 15]. However, most of these discussions are based on heuristics and empirical evidence. In general, some care is required to construct schemes that are effective. For example, it can happen that for a given energy potential function and swapping rate, the probability for swapping may be so low that it does not significantly improve performance.
There are two aims to the current paper. The first is to introduce a performance criterion for Monte Carlo schemes of this general kind that differs in some interesting ways from traditional criteria, such as the magnitude of the subdominant eigenvalue of a related operator [11, 25]. More precisely, we use the theory of large deviations to define a “rate of convergence” for the empirical measure. The key observation here is that this rate, and hence the performance of parallel tempering, is monotonically increasing with respect to the swap rate a. Traditional wisdom in the application of parallel tempering has been that one should not attempt to swap too frequently. While an obvious reason is that the computational cost for swapping attempts might become a burden, it was also argued that frequent swapping would result in poor sampling. For a discussion on prior approaches to the question of how to set the swapping rate and an argument in favor of frequent swapping, see [20, 19].
The use of this large deviation criterion and the resulting monotonicity with respect to a directly suggest the second aim, which is to study parallel tempering in the limit as a→∞. Note that the computational cost due just to the swapping will increase without bound, even on bounded time intervals, when a→∞. However, we will construct an alternative scheme, which uses different process dynamics and a weighted empirical measure. Because this process no longer swaps particle positions, it and the weighted empirical measure have a well-defined limit as a→∞ which we call infinite swapping. In effect, the swapping is achieved through the proper choice of weights and state dependent diffusion coefficients. This is done for the case of both continuous and discrete time processes with multiple temperatures.
An outline of the paper is as follows. In the next section the swapping model in continuous time is introduced and the rate of convergence, as measured by a large deviations rate function, is defined. The alternative scheme which is equivalent to swapping but which has a well-defined limit is introduced, and its limit as a→∞ is identified. The following section considers the analogous limit model for more than two temperatures and discusses certain practical difficulties associated with direct implementation when the number of temperatures is not small. The continuous time model is used for illustration because both the large deviation rate and the weak limit of the appropriately redefined swapping model take a simpler form than those of discrete time models. However, the discrete time model is what is actually implemented in practice. To bridge the gap between continuous time diffusion models and discrete time models, in section 4 we discuss the idea of infinite swapping for continuous time Markov jump processes and prove that the key properties demonstrated for diffusion models hold here as well. We also state a uniform (in the swapping parameter) large deviation principle. The discrete time form actually used in numerical implementation is presented in section 5. Section 6 returns to the issue of implementation when the number of temperatures is not small. In particular, we resolve the difficulty of direct implementation of the infinite swapping models via approximation by what we call partial infinite swapping models. Section 7 gives numerical examples, and an appendix gives the proof of the uniform large deviation principle.

### 2. Diffusion Models with Two Temperatures

Although the implementation of parallel tempering uses a discrete time model, the motivation for the infinite swapping limit is best illustrated in the setting where the state process is a continuous time diffusion process. It is in this case that the large deviation rate function, as well as the construction of a process that is distributionally equivalent to the infinite swapping limit, is simplest. In order to minimize the notational overhead, we discuss in detail the two-temperature case. The extension to models with multiple temperatures is obvious and will be stated in the next section.

### 2.1. Model Setup.

Let (X̅₁^{a},X̅₂^{a}) denote the Markov jump diffusion process of parallel tempering with swap rate a. That is, between swaps (or jumps), the process follows the diffusion dynamics (1.1). Jumps occur according to the state dependent intensity function ag(X̅₁^{a},X̅₂^{a}). At a jump time t, the particles swap locations, that is, (X̅₁^{a}(t),X̅₂^{a}(t))=(X̅₂^{a}(t−),X̅₁^{a}(t−)). Hence for a smooth function ƒ: [symbol] ^{d}× [symbol] ^{d}→ [symbol] the infinitesimal generator of the process is given by

$${ℒ}^{a} f ( {x}_{1} , {x}_{2} ) = - 〈 {∇}_{{x}_{1}} f ( {x}_{1} , {x}_{2} ) , ∇ V ( {x}_{1} ) 〉 - 〈 {∇}_{{x}_{2}} f ( {x}_{1} , {x}_{2} ) , ∇ V ( {x}_{2} ) 〉 + {τ}_{1} tr [ {∇}_{{x}_{1} {x}_{1}}^{2} f ( {x}_{1} , {x}_{2} ) ] + {τ}_{2} tr [ {∇}_{{x}_{2} {x}_{2}}^{2} f ( {x}_{1} , {x}_{2} ) ] + ag ( {x}_{1} , {x}_{2} ) [ f ( {x}_{2} , {x}_{1} ) - f ( {x}_{1} , {x}_{2} ) ] ,$$

where ∇ₓ_{ᵢ}ƒ and ∇ₓ_{ᵢ}ₓ_{ᵢ}²ƒ denote the gradient and the Hessian matrix with respect to xᵢ, respectively, and tr denotes trace. Throughout the paper we also assume the growth condition

$${lim}_{r -> ∞} {inf}_{x : \vert x \vert \geq r} 〈 ∇ V ( x ) , x / \vert x \vert 〉 = ∞ . \qquad ( 2.1 )$$

This condition not only ensures the existence and uniqueness of the invariant distribution but also enforces the exponential tightness needed for the large deviation principle for the empirical measures.
Recall the definition of π in (1.2), and let μ be the corresponding Gibbs probability distribution, that is,

$$μ ( d {x}_{1} d {x}_{2} ) = π ( {x}_{1} , {x}_{2} ) d {x}_{1} d {x}_{2} ∝ {e}^{- \frac{V ( {x}_{1} )}{{τ}_{1}}} {e}^{- \frac{V ( {x}_{2} )}{{τ}_{2}}} d {x}_{1} d {x}_{2} .$$

Straightforward calculations show that for any smooth function ƒ which vanishes at infinity

$${ℒ}^{α} f ( {x}_{1} , {x}_{2} ) μ ( d {x}_{1} d {x}_{2} ) = 0. \qquad ( 2.2 )$$

Since the condition (2.1) implies that V(x)→∞ as |x|→∞, by Echeverria's theorem [5, Theorem 4.9.17], μ is the unique invariant probability distribution of the process (X̅₁^{a},X̅₂^{a}).

### 2.2. Rate of Convergence by Large Deviations.

It follows from the previous discussion and the ergodic theorem [1] that, for a fixed burn-in time B, with probability one (w.p.1)

$${λ}_{T}^{α} \dot{=} \frac{1}{T} {\int }_{B}^{T + B} {δ}_{( {\overline{X}}_{1}^{a} ( t ) , {\overline{X}}_{2}^{a} ( t ) )} d t ⇒ μ$$

as T→∞. For notational simplicity we assume without loss of generality that B=0 from now on. A basic question of interest is, How rapid is this convergence, and how does it depend on the swap rate a? In particular, what is the rate of convergence of the lower temperature marginal?
We note that standard measures one might use for the rate of convergence, such as the second eigenvalue of the associated operator, are not necessarily appropriate here. They provide only indirect information on the convergence properties of the empirical measure, which is the quantity of interest in the Monte Carlo approximation. Such measures properly characterize the convergence rate of the transition probability

p(x,dy;t)=P{(X̅₁^{a}(t),X̅₂^{a}(t))εdy|(X̅₁^{a}(0),X̅₂^{a}(0))=x},x,yε [symbol] ^{d}× [symbol] ^{d},

as t→∞. However, they neglect the time averaging effect of the empirical measure, an effect that is not present with the transition probability. In fact, it is easy to construct examples such as nearly periodic Markov chains for which the second eigenvalue suggests a slow convergence when in fact the empirical measure converges quickly [17].
Another commonly used criterion for algorithm performance is the notion of asymptotic variance [10, 12, 23]. For a given functional ƒ: [symbol] ²× [symbol] ^{d}→ [symbol] , one can establish a central limit theorem which asserts that as T→∞

$$Var [ \frac{1}{\sqrt{T}} {\int }_{0}^{T} f ( {\overline{X}}_{1}^{a} ( t ) , {\overline{X}}_{2}^{a} ( t ) ) d t ] -> {σ}^{2} .$$

The magnitude of σ is used to measure the statistical efficiency of the algorithm. The asymptotic variance is closely related to the spectral properties of the underlying probability transition kernel [7, 17]. However, as with the second eigenvalue the usefulness of this criterion for evaluating performance of the empirical measure λ_{T}^{a} is not clear.
In this paper, we use the large deviation rate function to characterize the rate of convergence of a sequence of random probability measures. To be more precise, let S be a Polish space, that is, a complete and separable metric space. Denote by [symbol] (S) the space of all probability measures on S. We equip [symbol] (S) with the topology of weak convergence, though one can often use the stronger τ-topology [3]. Under the weak topology, [symbol] (S) is metrizable and itself a Polish space. Note that the empirical measure λ_{T}^{a} is a random probability measure, that is, a random variable taking values in the space [symbol] (S).
Definition 2.1. A sequence of random probability measures {γτ} is said to satisfy a large deviation principle (LDP) with rate function I: P(S)→[0, ∞] if for all open sets I⊂P(S),

$${lim inf}_{T -> ∞} \frac{1}{T} log P \{ {γ}_{T} ∈ O \} \geq - {inf}_{ν ∈ O} I ( ν ) ,$$

for all closed sets F⊂P(S),

$${lim sup}_{T -> ∞} \frac{1}{T} log P \{ {γ}_{T} ∈ F \} \leq - {inf}_{ν ∈ F} I ( ν ) ,$$

and {w: l(w)≦M} is compact in [symbol] (S) for all M<∞.
For our problem all rate functions encountered will vanish only at the unique invariant distribution j and hence give information on the rate of convergence of λ_{T}^{a}. A larger rate function will indicate faster convergence, though this is an asymptotic statement valid only for sufficiently large T.

### 2.3. Explicit Form of Rate Function.

The large deviation theory for the empirical measure of a Markov process was first studied in [2]. Besides the Feller property, which will hold for all processes we consider, the validity of the LDP depends on two types of conditions. One is a so-called transitivity condition, which requires that there be times T₁ and T₂ such that for any x,yε [symbol] ^{d}× [symbol] ^{d},

∫₀^{T}^{₁}e^{-t}p(x,dz;t)dt<<∫₀^{T}^{₂}e^{-t}p(y,dx;t)dt,

where << indicates that the measure in z on the left is absolutely continuous with respect to the measure on the right. For the jump diffusion process we consider here, this condition holds automatically since ΔV is bounded on bounded sets, [symbol] is bounded, and the diffusion coefficients are uniformly nondegenerate. The second type of condition is one that enforces a strong form of tightness, such as (2.1).
Under condition (2.1), the LDP holds for {λ_{T}^{a}: T>C} and the rate function, denoted by I^{a}, takes a fairly explicit form because the process is in continuous time and reversible [2, 13]. We will state the following result and omit the largely straightforward calculation since its role here is motivational. (A uniform LDP for the analogous jump Markov process will be stated in section 4, and its proof is given in the appendix.)
Let ν be a probability measure on [symbol] ^{d}× [symbol] ^{d} with smooth density. Define
θ(x₁, x₂) [symbol] [dν/dμ(x₁, x₂). Then I^{a}(ν) can be expressed as

$${I}^{a} ( ν ) = {J}_{0} ( ν ) + {aJ}_{1} ( ν ) , \\ where \\ {J}_{0} ( ν ) = {\int }_{{ℝ}^{d} \times {ℝ}^{d}}^{ } \frac{1}{8 {θ ( {x}_{1} , {x}_{2} )}^{2}} [ {τ}_{1} {‖ {∇}_{{x}_{1}} θ ( {x}_{1} , {x}_{2} ) ‖}^{2} + {τ}_{2} {‖ {∇}_{{x}_{2}} θ ( {x}_{1} , {x}_{2} ) ‖}^{2} ] ν ( d {x}_{1} d {x}_{2} ) , \\ {J}_{1} ( ν ) = {\int }_{{ℝ}^{d} \times {ℝ}^{d}}^{ } g ( {x}_{1} , {x}_{2} ) 𝓁 ( \sqrt{\frac{θ ( {x}_{2} , {x}_{1} )}{θ ( {x}_{1} , {x}_{2} )}} ) ν ( d {x}_{1} d {x}_{2} ) , \qquad ( 2.3 )$$

and where l(z)=z log z−z+1 for z≧0 is familiar from the large deviation theory for jump processes.
The key observation is that the rate function I^{a} (ν) is affine in the swapping rate a, with J₀(ν) the rate function in the case of no swapping. Furthermore, J₁(ν)≧0 with equality if and only if θx₂, x₂)=θ(x²x₁, x₂) for ν-a.e. (χ₁, χ₂). This form of the rate function, and in particular its monotonicity in a, motivates the study of the infinite swapping limit as a→∞.

Remark 2.2. The limit of the rate function I^{a} satisfies

$${I}^{∞} ( ν ) \dot{=} {lim}_{a -> ∞} {I}^{a} ( ν ) = \{ \begin{matrix}{J}_{0} ( ν ) & if θ ( {x}_{1} , {x}_{2} ) = θ ( {x}_{2} , {x}_{1} ) ν - a . s . , \\ ∞ & otherwise\end{matrix}$$

Hence for I^{∞}(ν) to be finite it is necessary that ν put exactly the same relative weight as μ on the points (x₁, x₂) and (x₂, x₂). Note that if a process could be constructed with I^{∞} as its rate function, then with the large deviation rate as our criterion such a process improves on parallel tempering with finite swapping rate in exactly those situations where parallel tempering improves on the process with no swapping at all.

### 2.4. Infinite Swapping Limit.

From a practical perspective, it may appear that there are limitations on how much benefit one obtains by letting a a→∞. When implemented in discrete time, the overall jump intensity corresponds to the generation of roughly a independent random variables that are uniform on [0,1] for each corresponding unit of continuous time, and based on each uniform variable a comparison is made to decide whether or not to make the swap. Hence even for fixed and finite T, the computations required to simulate a single trajectory scale like a as a→∞. Thus it is of interest if one can gain the benefit of the higher swapping rate without all the computational burden. This turns out to be possible but requires that we view the prelimit processes in a different way.
It is clear that the processes (X̅₁^{a},X̅₂^{a} are not tight as a→∞ since the number of discontinuities of size O(1) will grow without bound in any time interval of positive length. In order to obtain a limit, we consider alternative processes defined by

dY̅₁^{a}=−∇V(Y̅₁^{a})dt+{square root over (2τ₁I_{(Z̅}_{^{a}}₌₀₎+2τ₂I_{(Z̅}_{^{a}}₌₁₎)}dW₁,

dY̅₂^{a}=−∇V(Y̅₂^{a})dt+{square root over (2τ₂I_{(Z̅}_{^{a}}₌₀₎+2τ₁I_{(Z̅}_{^{a}}₌₁₎)}dW₂, (2.4)

where is Z̅a a jump process that switches from state 0 to state 1 with intensity ag(Y̅₁^{a},X̅₂^{a}) and from state 1 to state 0 with intensity ag(Y̅₁^{a},Y̅₂^{a}). Compared to conventional parallel tempering, the processes (Y̅₁^{a},Y̅₂^{a}) swap the diffusion coefficients at the jump times rather than the physical locations of two particles with constant diffusion coefficients. For this reason, we refer to the solution to (2.4) as the temperature swapped process, in order to distinguish it from the particle swapped process (X̅₁^{a},X̅₂^{a}). We illustrate these processes in FIG. 1. Note that the solid line and the dotted line represent X̅₁^{a} and X̅₂^{a}, respectively. These processes have more and more frequent jumps of size O(1) as a→∞. In contrast, the processes (Y̅₁^{a},Y̅₂^{a}) have varying diffusion coefficients. The figure attempts to also suggest features of the discrete time setting, with both successful and failed swap attempts.
Clearly the empirical measure of (Y̅₁^{a},Y̅₂^{a}) does not provide an approximation to μ. Instead, we should shift our attention between (Y̅₁^{a},Y̅₂^{a}) and (Y̅₂^{a},Y̅₁^{a}) depending on the value of Z̅a. Indeed, the random probability measures

$${η}_{T}^{a} = \frac{1}{T} {\int }_{0}^{T} [ {1}_{\{ {\overline{Z}}^{a} ( t ) = 0 \}} {δ}_{( {\overline{Y}}_{1}^{a} ( t ) , {\overline{Y}}_{2}^{a} ( t ) )} + {1}_{\{ {\overline{Z}}^{a} ( t ) = 1 \}} {δ}_{( {\overline{Y}}_{2}^{a} ( t ) , {\overline{Y}}_{1}^{a} ( t ) )} ] d t \qquad ( 2.5 )$$

have the same distribution as

$$\frac{1}{T} {\int }_{0}^{T} {δ}_{( {\overline{X}}_{1}^{a} ( s ) , {\overline{X}}_{2}^{a} ( s ) )} d s$$

and hence converge to μ at the same rate. However, these processes and measures have well-defined limits in distribution as a→∞. More precisely, we have the following result. For the proof see [9]. Related (but more complex) calculations are needed to prove the uniform large deviation result given in Theorem 4.1.
THEOREM 2.3. Assume that ∇V is locally Lipschitz continuous. Then for each T the sequence (Y̅₁^{a},Y̅₂^{a}, η_{τ}^{a}) converges in distribution to, (Y̅₁^{∞},Y̅₂^{∞}, η_{τ}) as a→∞, where (Y̅₁^{∞},Y̅₂^{∞}) is the unique strong solution to

$$\begin{matrix}d {\overline{Y}}_{1}^{∞} = - ∇ V ( {\overline{Y}}_{1}^{∞} ) d t + \sqrt{2 {τ}_{1} ρ ( {\overline{Y}}_{1}^{∞} , {\overline{Y}}_{2}^{∞} ) + 2 {τ}_{2} ρ ( {\overline{Y}}_{2}^{∞} , {\overline{Y}}_{1}^{∞} )} d {W}_{1} , \\ d {\overline{Y}}_{2}^{∞} = - ∇ V ( {\overline{Y}}_{2}^{∞} ) d t + \sqrt{2 {τ}_{2} ρ ( {\overline{Y}}_{1}^{∞} , {\overline{Y}}_{2}^{∞} ) + 2 {τ}_{1} ρ ( {\overline{Y}}_{2}^{∞} , {\overline{Y}}_{1}^{∞} )} d {W}_{2} , & ( 2.6 ) \\ {η}_{T}^{∞} = \frac{1}{T} {\int }_{0}^{T} [ ρ ( {\overline{Y}}_{1}^{∞} ( t ) , {\overline{Y}}_{2}^{∞} ( t ) ) {δ}_{( {\overline{Y}}_{1}^{∞} ( t ) , {\overline{Y}}_{2}^{∞} ( t ) )} + ρ ( {\overline{Y}}_{2}^{∞} ( t ) , {\overline{Y}}_{1}^{∞} ( t ) ) {δ}_{( {\overline{Y}}_{2}^{∞} ( t ) , {\overline{Y}}_{1}^{∞} ( t ) )} ] d t , \\ and \\ ρ ( {x}_{1} , {x}_{2} ) \dot{=} \frac{π ( {x}_{1} , {x}_{2} )}{π ( {x}_{2} , {x}_{1} ) + π ( {x}_{1} , {x}_{2} )} . & ( 2.7 )\end{matrix}$$

The existence and form of the limit are due to the time scale separation between the fast Z̅a process and the slow (Y̅₁^{a},Y̅₂^{a}) process. To give an intuitive explanation of the limit dynamics, consider the prelimit processes (2.4). Suppose that on a small time interval, the value of the slow process (Y̅₁^{a},Y̅₂^{a}) does not vary much, say (Y̅₁^{a},Y̅₂^{a})≈(x₁, x₂). Given the dynamics of the binary process Z̅a, it is easy to verify that as a tends to infinity the fractions of time that Z̅a=0 and Z̅a=1 are p(x₁, x₂) and p(x₂, x₁), respectively. This leads to the limit dynamics (2.6). When mapped back to the particle swapped process, p(x₁, x₂) and p(x₂, x₁) account for the fraction of time that (X̅₁^{a},X̅₂^{a})=(x₁, x₂) and (X̅₁^{a},X̅₂^{a})=(x₂, x₁), respectively, which naturally leads to the limit weighted empirical measure (2.7).
The weights p₁ and p₂ do not depend on the unknown normalization constant, and in fact

$$ρ ( {x}_{1} , {x}_{2} ) = \frac{{e}^{- \frac{V ( {x}_{1} )}{{τ}_{1}} - \frac{V ( {x}_{2} )}{{τ}_{2}}}}{{e}^{- \frac{V ( {x}_{1} )}{{τ}_{1}} - \frac{V ( {x}_{2} )}{{τ}_{2}}} + {e}^{- \frac{V ( {x}_{2} )}{{τ}_{1}} - \frac{V ( {x}_{1} )}{{τ}_{2}}}} \\ and \\ ρ ( {x}_{2} , {x}_{1} ) = 1 - ρ ( {x}_{1} , {x}_{2} ) = \frac{{e}^{- \frac{V ( {x}_{2} )}{{τ}_{1}} - \frac{V ( {x}_{1} )}{{τ}_{2}}}}{{e}^{- \frac{V ( {x}_{1} )}{{τ}_{1}} - \frac{V ( {x}_{2} )}{{τ}_{2}}} + {e}^{- \frac{V ( {x}_{2} )}{{τ}_{1}} - \frac{V ( {x}_{1} )}{{τ}_{2}}}} . \qquad ( 2.8 )$$

The following properties of the limit system are worth noting:
1. Instantaneous equilibration of multiple locations. Observe that the lower temperature component of this modified “empirical measure,” i.e., the first marginal, uses contributions from both components at all times, corrected according to the weights. The form of the weights in (2.7) guarantees that the contributions to μ_{T}^{∞} from locations (Y̅₁^{∞},Y̅₂^{∞}) and (Y̅₂^{∞},Y̅₁^{∞})) are at any time perfectly balanced according to the invariant distribution on product space.
2. Symmetry and invariant distribution. While the marginals of η_{T}^{∞} play very different roles, the dynamics of Y̅₁^{∞} and Y̅₂^{∞} are actually symmetric. Using Echeverria's theorem [5, Theorem 4.9.17], it can be shown that the unique invariant distribution of the process (Y̅₁^{∞},Y̅₂^{∞}) has the density

½[π(x₁,x₂)+π(x₂,x₁)].
It then follows from the ergodic theorem that η_{T}^{∞} [symbol] μ w.p.1 as T→∞. This is hardly surprising since μ is the invariant distribution for the prelimit processes (X₁^{∞},X₂^{a}).
   3. Escape from local minima. Finally it is worth commenting on the behavior of the diffusion coefficients as a function of the relative positions of Y̅₁^{∞} and Y̅₂^{∞} on an energy landscape. Recall that T₁<T₂. Suppose that Y̅₁^{∞}(t) is near the bottom of a local minimum (which for simplicity we set to be zero), while Y̅₂^{∞}(t) is at a higher energy level, perhaps within the same local minimum. Then

$$ρ ( {y}_{1} , {y}_{2} ) \approx \frac{{e}^{- \frac{V ( {y}_{2} )}{τ - 2}}}{{e}^{- \frac{V ( {y}_{2} )}{{τ}_{2}}} + {e}^{- \frac{V ( {y}_{2} )}{{τ}_{1}}}} \approx 1 , \\ ρ ( {y}_{2} , {y}_{1} ) = 1 - ρ ( {y}_{1} , {y}_{2} ) \approx 0.$$

Thus to some degree the dynamics look like

dY̅₁^{∞}=−∇V(Y̅₁^{∞})dt+\sqrt{2τ₁}dW₁,

dY̅₂^{∞}=−∇V(Y̅₂^{∞})dt+\sqrt{2τ₂}dW₂,
i.e., the particle higher up on the energy landscape is given the greater diffusion coefficient, while the one near the bottom of the well is automatically given the lower coefficient. Hence the particle which is already closer to escaping from the well is automatically given the greater noise (within the confines of (τ₁, τ₂)). Recalling the role of the higher temperature particle is to more assiduously explore the landscape in parallel tempering; this is an interesting property.
   One can apply results from [2] to show that the empirical measure of the infinite swapping limit {η_{T}^{∞}: T>0} satisfies an LDP with rate function I^{∞} as defined in Remark 2.2. However, to justify the claim that the infinite swapping model is truly superior to the finite swapping variant (note that I^{∞}≧I^{a} for any finite a), one should establish a uniform LDP, which would show that I^{∞} is the correct rate function for any sequence {a_{T}: T>0}⊂[0, ∞] such that a T→∞. We omit the proof here, since in Theorem 4.1 the analogous result will be proved in the setting of continuous time jump Markov processes.

### 3. Diffusion Models with Multiple Temperatures

In practice, parallel tempering uses swaps between more than two temperatures. A key reason is that if the gap between the temperatures is too large, then the probability of a successful swap under the (discrete time version of the) Metropolis rule (1.3) is far too low for the exchange of information to be effective. A natural generalization is to introduce, to the degree that computational feasibility is maintained, a ladder of higher temperatures and then attempt pairwise swaps between particles. There are a variety of schemes used to select which pair should attempt the swap, including deterministic and randomized rules for selecting only adjacent temperatures or an arbitrary pair of temperatures. However, if one were to replace any of these particle swapped processes with its equivalent temperature swapped analogue and consider the infinite swapping limit, one would get the same system of process dynamics and weighted empirical measures which we now describe.
Suppose that besides the lowest temperature τ₁ (in many cases the temperature of principal interest), we introduce the collection of higher temperatures

τ₁<τ₂< . . . <τ_{K}.

Let y=(y₁, y₂, . . . , y_{K})ε( [symbol] ^{d})^{K} be a generic point in the state space of the process, and define a product Gibbs distribution with the density

π(y)=π(y₁,y₂, . . . ,y_{K})∝e^{-V(y}^{₁}^{)/τ}^{₁}e^{-V(y}^{₂}^{)/τ}^{₂} . . . e^{-V(y}^{_{K}}^{)/τ}^{_{K}}.

The limit of the temperature swapped processes with K temperatures takes the form

$$d {\overline{Y}}_{1}^{∞} = - ∇ V ( {\overline{Y}}_{1}^{∞} ) dt + \sqrt{2 {ρ}_{11} {τ}_{1} + 2 {ρ}_{12} {τ}_{2} + … + 2 {ρ}_{1 K} {τ}_{K}} {dW}_{1} , \\ d {\overline{Y}}_{2}^{∞} = - ∇ V ( {\overline{Y}}_{2}^{∞} ) dt + \sqrt{2 {ρ}_{21} {τ}_{1} + 2 {ρ}_{22} {τ}_{2} + … + 2 {ρ}_{2 K} {τ}_{K}} {dW}_{2} , \\ ⋮$$

$$d {\overline{Y}}_{K}^{∞} = - ∇ V ( {\overline{Y}}_{K}^{∞} ) dt + \sqrt{2 {ρ}_{K 1} {τ}_{1} + 2 {ρ}_{K 2} {τ}_{2} + … + 2 {ρ}_{KK} {τ}_{K}} {dW}_{K} .$$

To define these weights pᵢⱼ it is convenient to introduce some new notation.
Let S_{K} be the collection of all bijective mappings from {1, 2, . . . , K} to itself. S_{K} has K! elements, each of which corresponds to a unique permutation of the set {1, 2, . . . , K}, and S_{K} forms a group with the group action defined by composition. Let σ⁻¹ denote the inverse of σ. Furthermore, for each aεS_{E} and every y=(y₁, y₂, . . . , y_{K})ε( [symbol] ^{d})^{K}, define Y_{σ} [symbol] Y_{σ(1)}, Y_{σ(2)}, . . . , Y_{σ(K)}).
At the level of the prelimit particle swapped process, we interpret the permutation a to correspond to the event that the particles at location y=(y₁, y₂, . . . , y_{K}) are swapped to the new location Y_{σ} [symbol] (Y_{σ(1)}, Y_{σ(2)}, . . . , Y_{σ(K)}). Under the temperature swapped process, this corresponds to the event that particles initially assigned temperatures in the order T₁, T₂, . . . , T_{K} have now been assigned the temperatures T_{σ-1(1)}, T_{σ-1(2)}, . . . , T_{σ-1(K)}.
The identification of the infinite swapping limit of the temperature swapped processes is very similar to that of the two-temperature model in the previous section. By exploiting the time-scale separation, one can assume that in a small time interval the only motion is due to temperature swapping and the motion due to diffusion is negligible. Hence the fraction of time that the permutation σ is in effect should again be proportional to the relative weight assigned by the invariant distribution to Y_{σ}, that is,

π(y_{σ})=π(y_{σ(1)},y_{σ(2)}, . . . ,y_{σ(K)}).

### Thus if

$$w ( y ) = \frac{π ( y )}{{\sum }_{θ ∈ {S}_{K}} π ( {y}_{θ } )} ,$$

then the fraction of time that the permutation a is in effect is w(Y_{σ}) w(ya). Note that for any y,

$${\sum }_{σ ∈ {S}_{K}} w ( {y}_{σ} ) = 1.$$

Going back to the definition of the weights pᵢⱼ(y), I, j=1, . . . , K, it is clear that they represent the limit proportion of time that the ith particle is assigned the temperature j and hence will satisfy

$${ρ}_{ij} ( y ) = {\sum }_{σ : σ ( j ) = i} w ( {y}_{σ} ) .$$

Likewise the replacement for the empirical measure, accounting as it does for mapping the temperature swapped process back to the particle swapped process, is given by

$${η}_{T}^{∞} = \frac{1}{T} {\int }_{0}^{T} {\sum }_{σ ∈ {S}_{K}} w ( {\overline{Y}}_{σ}^{∞} ( t ) ) {δ}_{{\overline{Y}}_{σ}^{∞} ( t )} d t , \qquad ( 3.1 )$$

where Y̅_{σ}^{∞}(t)≐[Y̅^{∞}(t)]_{σ}=(Y̅_{σ(1)}^{∞}(t), Y̅_{σ(2)}^{∞}(t), . . . , Y̅_{σ(K)}^{∞}(t)).
The instantaneous equilibration property still holds for the infinite swapping system with multiple temperatures. That is, at any time tε[0, T] and given a current position Y̅^{∞}(t)=y, the weighted empirical measure η_{τ}^{∞} has contributions from all locations of the form y_{σ}, σ⊂S_{K}, balanced exactly according to their relative contributions from the invariant density π(y_{∞}). The dynamics of Y̅^{∞} are again symmetric, and the density of the invariant distribution at point y is

$$\frac{1}{K !} {\sum }_{σ ∈ {S}_{K}} π ( {y}_{σ} ) .$$

Remark 3.1. The infinite swapping process described above allows the most effective communication between all temperatures, and is the “best” in the sense that it leads to the largest large deviation rate function and hence the fastest rate of convergence. However, computation of the coefficients becomes very demanding for even moderate values of K since one needs to evaluate K! terms from all possible permutations. In section 5 we discuss a more tractable and easily implementable family of schemes which are essentially approximations to the infinite swapping model presented in the current section and have very similar performance. We call the current model the full infinite swapping model since it uses the whole permutation group S_{K}, as opposed to the partial infinite swapping model in section 5 where only subgroups of S_{K} are used.

### 4. Infinite Swapping for Jump Markov Processes

The continuous time diffusion model is a convenient vehicle for conveying the main idea of infinite swapping. In practice, however, algorithms are implemented in discrete time. In this section we discuss continuous time pure jump Markov processes and the associated infinite swapping limit. The purpose of this intermediate step is to serve as a bridge between the diffusion and discrete time Markov chain models. These two types of processes have some subtle differences regarding the infinite swapping limit, which is best illustrated through the continuous time jump Markov model.
In this section we discuss the two-temperature model and omit the completely analogous multiple-temperature counterpart. We will not refer to temperatures τ₁ and τ₂ to distinguish dynamics. Instead, let α₁(x, dy) and α₂(x, dy) be two probability transition kernels on [symbol] ^{d} given [symbol] ^{d}. One can think of αᵢ as the dynamics under temperature τ₁ for i=1, 2. We assume that for each i=1, 2 the stationary distribution μᵢ associated with the transition kernel αᵢ admits the density [symbol] ᵢ, in order to be consistent with the diffusion models, and define

μ=μ₁×μ₂, π(x₁,x₂)=π₁(x₁)π₂(x₂).

We assume that the kernels are Feller and have a density that is uniformly bounded with respect to Lebesgue measure. These conditions would always be satisfied in practice. Finally, we assume that the detailed balance or reversibility condition holds, that is,

αᵢ(x,dz)πᵢ(x)dx=αᵢ(z,dx)πᵢ(z)dz. (4.1)

### 4.1. Model Setup.

In the absence of swapping (i.e., swapping rate α=0), the dynamics of the system are as follows. Let X⁰+{X⁰(t)=(X₁⁰(t),X₂⁰(t)), t≧0} denote a continuous time process taking values in [symbol] ^{d}× [symbol] ^{d}. The probability transition kernel associated with the embedded Markov chain, denoted by X̅⁰={(X̅₂⁰(j)): j=0, 1, . . . }, is

P{X̅⁰(j+1)ε(dy₁,dy₂)|X̅⁰(j)=(x₁,x₂)}=α₁(x₁,dy₁)α₂(x₂,dy₂).

Without loss of generality, we assume that the jump times occur according to a Poisson process with rate one. In other words, let {τᵢ} be a sequence of independent and identically distributed (i.i.d.) exponential random variables with rate one that are independent of X⁰. Then

$${X}^{0} ( t ) = {\overline{X}}^{0} ( j )$$

$$for$$

$${\sum }_{i = 1}^{j} {τ}_{i} \leq t < {\sum }_{i = 1}^{j + 1} {τ}_{i} .$$

The infinitesimal generator of X⁰ is such that for a given smooth function ƒ,

[symbol]

⁰ƒ(x₁,x₂)= [symbol] [ƒ(y₁,y₂)−ƒ(x₁,x₂)]α₁(x₁,dy₁)α₂(x₂,dy₂).

Owing to the detailed balance condition (4.1), the operator [symbol] ⁰ is self-adjoint. Using arguments similar to but simpler than those used to prove the uniform LDP in Theorem 4.1, the large deviation rate function I⁰ associated with the occupation measure

$${η}_{T}^{0} = \frac{1}{T} {\int }_{0}^{T} {δ}_{{X}^{0} ( t )} d t$$

can be explicitly identified: for any probability measure v on [symbol] ^{d}× [symbol] ^{d} with ν<<μ and θ+dν/dμ,

$${I}^{0} ( ν ) = 1 - {\int }_{{( {ℝ}^{d} \times {ℝ}^{d} )}^{2}} \sqrt{θ ( {x}_{1} , {x}_{2} ) θ ( {y}_{1} , {y}_{2} )} π ( {x}_{1} , {x}_{2} ) {α}_{1} ( {x}_{1} , d {y}_{1} ) {α}_{2} ( {x}_{2} , d {y}_{2} ) d {x}_{1} d {x}_{2} ,$$

and I⁰ is extended to all of [symbol] ( [symbol] ^{d}× [symbol] ^{d}) by lower semicontinuous regularization.

### 4.2. Finite Swapping Model.

Denote by X^{a}−{(X₁^{a}(t),X₂^{a}(t)): t≧0} the state process of the finite swapping model with swapping rate a, and let X̅^{a}={(X̅₁^{a}(j),X̅₂^{a}(j)): j=0, 1, . . . } be the embedded Markov chain. The probability transition kernel for X̅^{a} is

$$P ( {\overline{X}}^{a} ( j + 1 ) ∈ ( d {y}_{1} , d {y}_{2} ) \vert {\overline{X}}^{a} ( j ) = ( {x}_{1} , {x}_{2} ) \} = \frac{1}{a + 1} {α}_{1} ( {x}_{1} , d {y}_{1} ) {α}_{2} ( {x}_{2} , d {y}_{2} ) + \frac{a}{a + 1} [ g ( {x}_{1} , {x}_{2} ) {δ}_{( {x}_{2} , {x}_{1} )} ( d {y}_{1} , {dy}_{2} ) + ( 1 - g ( {x}_{1} , {x}_{2} ) ) {δ}_{( {x}_{1} , {x}_{2} )} ( {dy}_{1} , {dy}_{2} ) ] ,$$

where g is defined as in (1.3). Furthermore, let {Tᵢ^{a}} be a sequence of i.i.d. exponential random variables with rate (a+1), and define

$${X}^{a} ( t ) = {\overline{X}}^{a} ( j ) for {\sum }_{i = 1}^{j} {τ}_{i}^{a} \leq t < {\sum }_{i = 1}^{j + 1} {τ}_{i}^{a} .$$

In other words, the jumps occur according to a Poisson process with rate a+1. Note that there are two types of jumps. At any jump time, with probability 1/(a+1) it will be a jump according to the underlying probability transition kernels α₁ and α₂. With probability a/(a+1) it will be an attempted swap which will succeed with the probability determined by g. As a grows, the swap attempts become more and more frequent. However, the time between two consecutive jumps of the first type will have the same distribution as

$${S}^{a} = {\sum }_{i = 1}^{{N}^{a}} {τ}_{i}^{a} ,$$

where N^{a} is a geometric random variable with parameter 1/(a+1). It is easy to argue that for any a the distribution of S^{a} is exponential with rate one. This observation will be useful when we derive the infinite swapping limit.

The infinitesimal generator [symbol] ^{a} of X̅² is such that for any smooth function ƒ on [symbol] ^{d}× [symbol] ^{d},

[symbol]

^{a}ƒ(x₁,x₂)= [symbol] [ƒ(y₁,y₂)−ƒ(x₁,x₂)]α₁(x₁,dy₁)α₂(x₂,dy₂)+ag(x₁,x₂)[ƒ(x₂,x₁)−ƒ(x₁,x₂)].

It is not difficult to check that the stationary distribution of X̅^{a} remains μ and that £^{a} is self-adjoint. As before, the large deviation rate function I^{a} for the occupation measure

$${η}_{T}^{a} = \frac{1}{T} {\int }_{0}^{T} {δ}_{{X}^{a} ( t )} d t \qquad ( 4.2 )$$

can be explicitly identified. Indeed, for any probability measure ν on [symbol] ^{d}× [symbol] ^{d} with ν<<μ and δ=dν/dμ,

$${I}^{a} ( v ) = {I}^{0} ( v ) + aJ ( v ) , \\ where$$

$$J ( ν ) = {\int }_{( {ℝ}^{d} \times {ℝ}^{d} )} g ( {x}_{1} , {x}_{2} ) l ( \sqrt{\frac{θ ( {x}_{2} , {x}_{1} )}{θ ( {x}_{1} , {x}_{2} )}} ) ν ( d {x}_{1} , d {x}_{2} ) .$$

Note that as before, I^{a} is monotonically increasing with respect to a. Since I(ν)≧0 with equality if an θ(x₁, x₂)=θ(x₂, x₁)ν-a.e., we have

$${I}^{∞} ( v ) \dot{=} {lim}_{a -> ∞} {I}^{a} ( v ) = \{ \begin{matrix}{I}^{0} ( v ) & if θ ( {x}_{1} , {x}_{2} ) = θ ( {x}_{2} , {x}_{1} ) v - a . s . , \\ ∞ & otherwise .\end{matrix}$$

### 4.3. Infinite Swapping Limit.

The infinite swapping limit for X^{a} as a>∞ can be similarly obtained by considering the corresponding temperature swapped processes. Since the times between jumps determined by a1 and a2 are always exponential with rate one, the infinite swapping limit Y^{∞}=(\tilde{Y}₁^{∞}, Y₂^{∞}) is a pure jump Markov process where jumps occur according to a Poisson process with rate one. In other words,

$${Y}^{∞} ( t ) = {\overline{Y}}^{∞} ( j ) for {\sum }_{i = 1}^{j} {τ}_{i} \leq t < {\sum }_{i = 1}^{j + 1} {τ}_{i} ,$$

where Y̅^{∞} is the embedded Markov chain and {τᵢ} sequence of i.i.d. exponential random variables with rate one. Furthermore, the probability transition kernel for Y̅^{∞} is

$$P \{ {\overline{Y}}^{∞} ( j + 1 ) ∈ ( {dz}_{1} , {dz}_{2} ) \vert {\overline{Y}}^{∞} ( j ) = ( {y}_{1} , {y}_{2} ) \} = ρ ( {y}_{1} , {y}_{2} ) {α}_{1} ( {y}_{1} , {dz}_{1} ) {α}_{2} ( {y}_{2} , {dz}_{2} ) + ρ ( {y}_{2} , {y}_{1} ) {α}_{2} ( {y}_{1} , {dz}_{1} ) {α}_{1} ( {y}_{2} , {dz}_{2} ) , \qquad ( 4.4 )$$

where the weight function p is defined as in Theorem 2.3. It is not difficult to argue that the stationary distribution for Y^{∞} is

μ̅(dy₁,dy₂)=½[π(y₁,y₂)+π(y₂,y₁)]dy₁dy₂,

and the weighted occupation measure (4.5)

$${η}_{T}^{∞} = \frac{1}{T} {\int }_{0}^{T} [ ρ ( {Y}_{1}^{∞} ( t ) , {Y}_{2}^{∞} ( t ) ) {δ}_{( {Y}_{1}^{∞} ( t ) , {Y}_{2}^{∞} ( t ) )} + ρ ( {Y}_{2}^{∞} ( t ) , {Y}_{1}^{∞} ( t ) ) {δ}_{( {Y}_{2}^{∞} ( t ) , {Y}_{1}^{∞} ( t ) )} ] d t \qquad ( 4.5 )$$

converges to μ(dx₁, dx₂)=π(x₁, x₂)dx₁dx₂ as T→∝. It is obvious that the dynamics of the infinite swapping limit are symmetric and instantaneously equilibrate the contribution from (Y₁, Y₂) and (Y₂, Y₁) according to the invariant measure, owing to the weight function ρ.
We have the following uniform LDP result, which justifies the superiority of the infinite swapping model. Its proof is deferred to the appendix. It should be noted that rate identification is not covered by the existing literature, even in the case of a fixed swapping rate, due to the pure jump nature of the process.
THEOREM 4.1. The occupation measure: {η_{T}^{∞}: T>0} satisfies an LDP with rate function I^{∞}. More generally, define the finite swapping model as in subsection 4.2. Consider any {a_{T}: T>0}⊂[0, ∞] such that a_{T}→∞ as T→∞, and interpret a_{T}<∞ to mean that η_{T}^{a}^{ₓ} is defined by (4.2) with a=a_{T}, and a_{T}=∞ to mean that η_{T}^{a}^{ₓ} is defined by (4.5). Then {η_{T}^{a}^{ₓ}: T>0} satisfies an LDP with the rate function I^{∞} defined in (4.3).

### 5. Discrete Time Process Models

### 5.1. Conventional Parallel Tempering Algorithms.

In the discrete time, multitemperature algorithms that are actually implemented, a swap is attempted after a deterministic or random number of time steps, with a success probability of the form (1.3). The two temperatures corresponding to particles for which a swap is attempted can be chosen according to a deterministic or random schedule, and as noted previously they are usually adjacent since otherwise the success probability (1.3) will be too small to allow efficient exchange of information.
As before it suffices to describe the algorithm in the setting of two temperatures. As in section 4, let αᵢ(x, dy) denote the probability transition kernel for temperature τᵢ whose stationary distribution has a density πᵢ for i=1, 2. For now let N=1/a be a fixed positive integer that determines the frequency of swap attempts. Let X̅={(X̅₁(j),X̅₂(j)): j=0, 1 . . . } denote the state process. Then the evolution of the dynamics is as follows. For any integer k≧1 and (k−1)(N+1)≦j≦k(N+1)−2,

P{X̅(j+1)ε(dy₁,dy₂)|X̅(j)=(x₁,x₂)}=α₁(x₁,dy₁)α₂(x₂,dy₂),

and for j=k(N+1)−1,

P{X̅(j+1)=(x₂,x₁)|X̅(j)=(x₁,x₂)}=g(x₁,x₂),

P{X̅(j+1)=(x₁,x₂)|X̅(j)=(x₁,x₂)}=1−g(x₁,x₂).

Thus a swap is attempted after every N ordinary time steps based on the underlying transition kernels a₁ and a₂. The case N=1/a with a an integer greater than one corresponds to the case where multiple swaps are attempted between two ordinary time steps. The unique invariant distribution of X̅ is μ(dx₁dx₂)=π(x₁, x₂)dx₁dx₂, regardless of the value of N, and the occupation measure

$$\frac{1}{J} {\sum }_{j = 0}^{J - 1} {δ}_{X ( j )}$$

converges to μ as J→∞ a.s.
Remark 5.1. Note that N could be random. For example, if N is chosen to be a geometric random variable with mean λ, then X̅ is exactly the embedded Markov chain of the pure jump Markov process X̅^{a} with a=1/λ, in subsection 4.2.

### 5.2. Infinite Swapping Model.

As with the continuous time case, to produce a well-defined limit one must consider the temperature swapped process and then consider the limit as swapping frequency tends to infinity. It turns out that the limit is exactly the embedded Markov chain for the pure jump Markov process in subsection 4.3. That is, the infinite swapping limit in discrete time is a Markov chain Y̅^{∞}={(Y̅₁^{∞}(j),Y̅₂^{∞}(j)): j=0, 1, . . . } with the transition kernel

ρ(y₁,y₂)α₁(y₁,dz₁)α₂(y₂,dz₂)+ρ(y₂,y₁)α₂(y₁,dz₁)α₁(y₂,dz₂). (5.1)

The corresponding weighted empirical measure is

$${η}_{J}^{∞} \dot{=} \frac{1}{J} {\sum }_{j = 0}^{J - 1} [ ρ ( {\overline{Y}}_{1}^{∞} ( j ) , {\overline{Y}}_{2}^{∞} ( j ) ) {δ}_{( {\overline{Y}}_{1}^{∞} ( j ) , {\overline{Y}}_{2}^{∞} ( j ) )} + ρ ( {\overline{Y}}_{2}^{∞} ( j ) , {\overline{Y}}_{1}^{∞} ( j ) ) {δ}_{( {\overline{Y}}_{2}^{∞} ( j ) , {\overline{Y}}_{1}^{∞} ( j ) )} ] . \qquad ( 5.2 )$$

The generalization to multiple temperatures is also straightforward. Suppose that there are K temperatures. Denote the infinite swapping limit process by Y̅={Y̅(j): j=0, 1, . . . }, which is a Markov chain taking values in the space ( [symbol] ^{d})^{K}. Given that the current state of the chain is Y̅^{∞}(j)=y=(y₁, . . . , y_{K}), define as before the weights

$$w ( y ) \dot{=} \frac{π ( y )}{{\sum }_{θ ∈ {S}_{k}} π ( {y}_{θ} )} .$$

Then the transition kernel of Y̅^{∞} is

$$P ( {\overline{Y}}^{∞} ( j + 1 ) ∈ dz \vert {\overline{Y}}^{∞} ( j ) = y ) = {\sum }_{σ ∈ {S}_{K}} w ( {y}_{σ ( 1 )} , {dz}_{σ ( 1 )} ) … {α}_{K} ( {y}_{σ ( K )} , {dz}_{σ ( K )} ) .$$

The discrete time numerical approximation to the invariant distribution is

$${η}_{J}^{∞} \dot{=} {\sum }_{j = 0}^{J - 1} {\sum }_{σ ∈ {S}_{K}} w ( {\overline{Y}}_{σ}^{∞} ( j ) ) {δ}_{{\overline{Y}}_{σ}^{∞} ( j )} .$$

Remark 5.2. It is not difficult to derive LDPs for the discrete time finite swapping or infinite swapping models. However, it remains an open question whether the rate function is monotonic with respect to the swap rate (frequency). However, the discrete time large deviation rate function can be obtained from that of the continuous time pure jump Markov process models through the contraction principle, and the two coincide in the limit as the transition kernels ai correspond to an infinitesimal time step for the diffusion process (1.1). Hence the discrete time rate function will be at least approximately monotone, and in this sense the infinite swapping limit should (at least approximately) dominate all finite swapping algorithms. This is supported by the data presented in section 7 and the much more extensive empirical study presented in [14].

### 6. Partial Infinite Swapping

As noted in section 3, the number of weights and their calculation can become unwieldy for infinite swapping even when the number of temperatures is moderate. In this section we construct algorithms that maintain most of the benefit of the infinite swapping algorithm but at a much lower computational cost. In the first subsection we describe the infinite swapping limit models when only a subgroup of the permutations of the particles (respectively, temperatures) are allowed by the prelimit particle (respectively, temperature) swapped process. The computational complexity of these limit models will be controlled by limiting the number of permutations that communicate with each other through the swapping mechanism. The infinite swapping models in this subsection will be called partial infinite swapping models, as opposed to the full infinite swapping models in the previous section. The second subsection shows how such partial infinite swapping schemes can be interwoven to approximate the full infinite swapping model.

### 6.1. Partial Infinite Swapping Models.

We consider subsets A of S_{K} with the property that A is an algebraic subgroup of S_{K}. That is, the following hold:

1. the identity belongs to A;

2. if σ₁,σ₂εA, then σ₁∘σ₂εA, where ∘ denotes composition;

3. if σεA, then σ⁻¹εA.

Although one can write down a partial infinite swapping model that corresponds to instantaneous equilibration for an arbitrary subset A, it is only when A is a subgroup that the corresponding partial infinite swapping process has an interpretation as the limit of parallel tempering-type processes. When alternating between partial infinite swapping processes, a “handoff” rule will be needed, and it is only for those which correspond to subgroups that such a handoff rule is well defined. This point is discussed in some detail in the next section.
The definition of the partial infinite swapping process based on A is completely analogous to that of the full infinite swapping process. The state process {Y̅(j): j=0, 1, . . . } is a Markov chain with the transition kernel

$${α}^{A} ( y , dz ) \dot{=} {\sum }_{σ ∈ A} {\tilde{w}}^{A} ( {y}_{σ} ) {α}_{1} ( {y}_{σ ( 1 )} , {dz}_{σ ( 1 )} ) … {α}_{K} ( {y}_{σ ( K )} , {dz}_{σ ( K )} ) , \qquad ( 6.1 )$$

and the weighted empirical measure is

$${\tilde{η}}_{J} \dot{=} \frac{1}{J} {\sum }_{j = 0}^{J - 1} {\sum }_{σ ∈ A} {\tilde{w}}^{A} ( {\overline{Y}}_{σ} ( j ) ) {δ}_{{\overline{Y}}_{σ ( j )}} ,$$

where the weight function \tilde{w}^{A} is defined by

$${\tilde{w}}^{A} ( y ) \dot{=} \frac{π ( y )}{{\sum }_{θ ∈ A} π ( {y}_{θ} )} , \qquad ( 6.2 )$$

and satisfies for any y

$${\sum }_{σ ∈ A} {\tilde{w}}^{A} ( {y}_{σ} ) = 1.$$

We omit the dependence on both a=∞ and A from the notation. Note that in contrast with the full swapping system, it is only those permutations of y corresponding to σεA that are balanced according to the invariant distribution in their contributions to \tilde{η}_{J}.
To illustrate the construction we present a few examples. With a standard abuse of notation denote the permutation σ such that σ(i)=aᵢ by the form (a₁, a₂, . . . , a_{K}). In particular, (1, 2, . . . , K) is the identity of the group S_{K}.
Example 6.1. Let K=4 and A={(1, 2, 3, 4), (2, 1, 3, 4)}. This corresponds to only allowing swaps between temperatures τ₁ and τ₂ at the prelimit. Define

$$\tilde{w} ( y ) = \frac{π ( {y}_{1} , {y}_{2} , {y}_{3} , {y}_{4} )}{π ( {y}_{1} , {y}_{2} , {y}_{3} , {y}_{4} ) + π ( {y}_{2} , {y}_{1} , {y}_{3} , {y}_{4} )} .$$

The probability transition kernel of the corresponding partial infinite swapping process is given by

\tilde{w}(y₁,y₂,y₃,y₄)α₁(y₁,dz₁)α₂(y₂,dz₂)α₃(y₃,dz₃)α₄(y₄,dz₄)+\tilde{w}(y₂,y₁,y₃,y₄)α₁(y₂,dz₂)α₂(y₁,dz₁)α₃(y₃,dz₃)α₄(y₄,dz₄),

and the contribution to the weighted empirical measure is

\tilde{w}(Y̅₁,Y̅₂,Y̅₃,Y̅₄)δ_{(\tilde{Y}}_{₁}_{,\tilde{Y}}_{₂}_{,\tilde{Y}}_{₃}_{,\tilde{Y}}_{₄}₎+\tilde{w}(Y̅₂,Y̅₁,Y̅₃,Y̅₄)δ_{(\tilde{Y}}_{₂}_{,\tilde{Y}}_{₁}_{,\tilde{Y}}_{₃}_{,\tilde{Y}}_{₄}₎.

Note that with πᵢⱼ denoting the marginal invariant distribution on the ith and jth components, the weight function can be written as

$$\tilde{w} ( y ) = \frac{{π}_{12} ( {y}_{1} , {y}_{2} )}{{π}_{12} ( {y}_{1} , {y}_{2} ) + {π}_{12} ( {y}_{2} , {y}_{1} )} ,$$

which is consistent with the weights of the two-temperature model in Theorem 2.3.
Example 6.2. Again take K=4, but this time use the subgroup generated by (2, 1, 3, 4) and (1, 2, 4, 3), i.e., A={(1, 2, 3, 4), (2, 1, 3, 4), (1, 2, 4, 3), (2, 1, 4, 3)}. Then the dynamics are given by

\tilde{w}(y₁,y₂,y₃,y₄)α₁(y₁,dz₁)α₂(y₂,dz₂)α₃(y₃,dz₃)α₄(y₄,dz₄)+\tilde{w}(y₂,y₁,y₃,y₄)α₁(y₂,dz₂)α₂(y₁,dz₁)α₃(y₃,dz₃)α₄(y₄,dz₄)+\tilde{w}(y₁,y₂,y₃,y₄)α₁(y₁,dz₁)α₂(y₂,dz₂)α₃(y₄,dz₄)α₄(y₃,dz₃)+\tilde{w}(y₂,y₁,y₄,y₃)α₁(y₂,dz₂)α₂(y₁,dz₁)α₃(y₄,dz₄)α₄(y₃,dz₃),

where the weight function \tilde{w} is defined by

$$\tilde{w} ( y ) = \frac{π ( {y}_{1} , {y}_{2} , {y}_{3} , {y}_{4} )}{\begin{matrix}π ( {y}_{1} , {y}_{2} , {y}_{3} , {y}_{4} ) + π ( {y}_{2} , {y}_{1} , {y}_{3} , {y}_{4} ) + \\ π ( {y}_{1} , {y}_{2} , {y}_{4} , {y}_{3} ) + π ( {y}_{2} , {y}_{1} , {y}_{4} , {y}_{3} )\end{matrix}} .$$

The contribution to the weighted empirical measure is

\tilde{w}(Y̅₁,Y̅₂,Y̅₃,Y̅₄)δ_{(\tilde{Y}}_{₁}_{,\tilde{Y}}_{₂}_{,\tilde{Y}}_{₃}_{,\tilde{Y}}_{₄}₎+\tilde{w}(Y̅₂,Y̅₁,Y̅₃,Y̅₄)δ_{(\tilde{Y}}_{₂}_{,\tilde{Y}}_{₁}_{,\tilde{Y}}_{₃}_{,\tilde{Y}}_{₄}₎+\tilde{w}(Y̅₁,Y̅₂,Y̅₄,Y̅₃)δ_{(\tilde{Y}}_{₁}_{,\tilde{Y}}_{₂}_{,\tilde{Y}}_{₄}_{,\tilde{Y}}_{₃}₎+\tilde{w}(Y̅₂,Y̅₁,Y̅₄,Y̅₃)δ_{(\tilde{Y}}_{₂}_{,\tilde{Y}}_{₁}_{,\tilde{Y}}_{₄}_{,\tilde{Y}}_{₃}₎.

Example 6.3. We let K=3 and take A to be the subgroup of S_{K} generated by the rotation (2, 3, 1), i.e., A={(1, 2, 3), (2, 3, 1), (3, 1, 2)}. Then the dynamics are given by

$$\tilde{w} ( {y}_{1} , {y}_{2} , {y}_{3} ) {α}_{1} ( {y}_{1} , {dz}_{1} ) {α}_{2} ( {y}_{2} , {dz}_{2} ) {α}_{3} ( {y}_{3} , {dz}_{3} ) + \tilde{w} ( {y}_{2} , {y}_{3} , {y}_{1} ) {α}_{1} ( {y}_{2} , {dz}_{2} ) {α}_{2} ( {y}_{3} , {dz}_{3} ) {α}_{3} ( {y}_{1} , {dz}_{1} ) + \tilde{w} ( {y}_{3} , {y}_{1} , {y}_{2} ) {α}_{1} ( {y}_{3} , {dz}_{3} ) {α}_{2} ( {y}_{1} , {dz}_{1} ) {α}_{3} ( {y}_{2} , {dz}_{2} ) , \\ where$$

$$\tilde{w} ( y ) = \frac{π ( {y}_{1} , {y}_{2} , {y}_{3} )}{π ( {y}_{1} , {y}_{2} , {y}_{3} ) + π ( {y}_{2} , {y}_{3} , {y}_{1} ) + π ( {y}_{3} , {y}_{1} , {y}_{2} )}$$

and the contribution to the weighted empirical measure is

\tilde{w}₁(Y̅₁,Y̅₂,Y̅₃)δ_{(\tilde{Y}}_{₁}_{,\tilde{Y}}_{₂}_{,\tilde{Y}}_{₃}₎+\tilde{w}₂(Y̅₂,Y̅₃,Y̅₁)δ_{(\tilde{Y}}_{₂}_{,\tilde{Y}}_{₃}_{,\tilde{Y}}_{₁}₎+\tilde{w}₃(Y̅₃,Y̅₁,Y̅₂)δ_{(\tilde{Y}}_{₃}_{,\tilde{Y}}_{₁}_{,\tilde{Y}}_{₂}₎.

The first two examples would correspond to the infinite swapping limit of a stan-dard parallel tempering process, where swaps between only 1 and 2 are allowed in the first example, and swaps between 1 and 2 and swaps between 3 and 4 are allowed in the second. Note that the computational complexity does not increase significantly between the first and second examples. The third example corresponds to a very different sort of prelimit process, in which “rotations” of the coordinates (y₁,y₂,y₃)→(y₂,y₃,y₁)→(y₃,y₁,y₂)→(y₁,y₂,y₃) are allowed. One can devise a Metropolis-type rule that allows such “swaps” and yields the indicated infinite swapping system.

### 6.2. Approximating Full Infinite Swapping by Partial Swapping.

In this section we consider the issue of alternating between such partial infinite swapping systems to approximate the full infinite swapping limit. Let A and B be subgroups of S_{K}. A and B are said to generate S_{K} if the smallest subgroup that contains A and B itself is S_{K}. Note that the total number of permutations in A∪B can be significantly smaller than K!, the size of S_{K}. In fact, it is possible to construct subgroups A and B that generate S_{K} and that the total number of permutations in A∪B is of order K. There is an obvious extension to more than two subgroups.
Example 6.4. Let K=4, and let A be generated by {(2, 1, 3, 4), (1, 3, 2, 4)} and B be generated by {(1, 3, 2, 4), (1, 2, 4, 3)}, respectively. Thus A is the collection of six permutations that fix the last component and allow all rearrangements of the first three, while B fixes the first component and allows all rearrangements of the last three. Then A and B generate S_{K}.
Example 6.5. Let K=4, and let A and B be subgroups generated by {(2, 1, 3, 4)} and {(2, 3, 4, 1)}, respectively. In other words, A={(1, 2, 3, 4), (2, 1, 3, 4)} corresponds to allowing permutations only between the first two components, while B={(1, 2, 3, 4), (2, 3, 4, 1), (3, 4, 1, 2), (4, 1, 2, 3)} corresponds to cycling of the four temperatures. Then A and B generate S_{K}.
To keep the computational cost controlled, one can approximate the full infinite swapping model by alternating between partial infinite swapping processes whose as-sociated subgroups generate the whole group. However, one must be careful in how the “handoff” is made when switching between different partial swapping models. It turns out that one cannot simply switch between different partial infinite swapping dynamics (i.e., transition kernels). Recall that in order to get a consistent approximation to the desired target invariant distribution we do not use the empirical measure generated by Y̅ but rather a carefully constructed weighted empirical measure that works with several permutations of Y̅. Simply switching the dynamics and weights will in fact produce an algorithm that may not converge to the target distribution.
To see how one should design a handoff rule, note that if one considers a collection of transition kernels each having the same invariant distribution and alternates between them in a way that does not depend on the outcomes prior to a switch, then the resulting empirical measure will in fact converge to the common invariant distribution. This fact is used (at least implicitly) in the parallel tempering algorithm itself, where one alternates the pair of particles being considered for swapping according to deterministic or random rules so long as the random rules do not rely on previously observed outcomes.
Now we use the fact that each partial infinite swapping model is a limit of either a parallel tempering algorithm where only some pairs of particles are considered for swapping or some more general form of parallel tempering which would allow groups of particles to simultaneously swap (according to an appropriate Metropolis-type ac-ceptance rule). An example in the earlier category would be A in Example 6.4, which arises if only the pairs corresponding to temperatures τ₁, τ₂ and τ₂, τ₃ are allowed to swap, whereas an example in the latter category would be B in Example 6.5, which corresponds to allowing the particle at temperature τᵢ to move to the location of the particle at temperature τᵢ₋₁ (with τ₀=τ₄), and vice versa. Furthermore, each of these partial infinite swapping models arises as a limit of transition kernels of the corresponding temperature swapped processes which preserve the same common invariant distribution. In taking the limit as the swap rate tends to infinity, the correspondence between particle locations for a particle swapped process and the instantaneously equilibrated” temperature swapped process Y̅ is lost. However, one can construct a consistent algorithm by reconstructing this correspondence. In fact one should choose the particle location according to the probabilities (under the invariant distribution) associated with the various permutations in the subgroup. See subsection 6.3 for a more detailed discussion on the intuition behind this approximation algorithm.
We next present an algorithm for alternating between two partial infinite swapping dynamics. The restriction to two is for notational convenience only. Suppose that the dynamics are indexed by the corresponding subgroups A and B and that n_{A} steps of subgroup A are to be alternated with n_{B} steps of subgroup B. For simplicity we do not describe a “burn-in” period. As in (6.1) and (6.2) we let α^{A}(y, dz) and \tilde{w}^{A}(y) denote the transition kernel for A and the weights allocated to the permutation σεA, respectively, and similarly for B.

ALGORITHM 6.6 (approximation to full infinite swapping).

| 1. | Initialization: X̅^{A}(0) = Y̅(0; 0) ε ( [symbol] ^{d})^{K}, [symbol] = 1. | |
|---|---|---|
| 2. | Loop [symbol] : | |
| | (a) | Initializatoin for A dynamics: set Y̅( [symbol] ; 0) = X̅^{A}( [symbol] − 1). |
| | (b) | Subgroup A dynamics: update Y̅( [symbol] ; k), k = 1, . . . , n_{A}, |
| | | according to the transition kernel α^{A}, and add |
| | | ${\sum }_{σ ∈ A} {\tilde{w}}^{A} ( {\overline{Y}}_{σ} ( 𝓁 ; k ) ) {δ}_{{Y}_{σ} ( 𝓁 , k )}$ |
| | | to the unnormalized empirical measure. |
| | (c) | Reconstructing particle locations at the end of A dynamics: |
| | | Let X̅^{B}( [symbol] ) be a random sample from the set {Y̅_{σ}( [symbol] ; n_{A}) : σ ε A} |
| | | according to the weights {\tilde{w}^{A}(Y̅_{σ}( [symbol] ; n_{A})) : σ ε A}. |
| | (d) | Initialization for B dynamics: set Y̅( [symbol] ; n_{A}) = X̅^{B}( [symbol] ). |
| | (e) | Subgroup B dynamics: update Y̅( [symbol] ; k), k = n_{A} + 1, . . . , n_{A} + n_{B}, |
| | | according to the transition kernel α^{B}, and add |
| | | ${\sum }_{σ ∈ B} {\tilde{w}}^{B} ( {\overline{Y}}_{σ} ( 𝓁 ; k ) ) {δ}_{{Y}_{σ} ( 𝓁 , k )}$ |
| | | to the unnormalized empirical measure. |
| | (f) | Reconstruction particle locations at the end of B dynamics: |
| | | Let X̅^{A}( [symbol] ) be a random sample from the set {Y̅_{σ}( [symbol] ; n_{A} + n_{B}) : |
| | | σ ε B} according to the weights {\tilde{w}^{B}(Y̅_{σ}( [symbol] ; n_{A} + n_{B})) : σ ε B}. |
| | (g) | Set [symbol] = [symbol] + 1, and loop back to (a). |

| | |
|---|---|
| 3. | Normalize the empirical measure. |

### 6.3. Discussions on the Approximation.

In this section we further discuss the intuition underlying the handoff rule between different partial infinite swapping dynamics and the approximation algorithm of the previous section. We temporarily assume that the model is in continuous time since the intuition is most transparent in this case.
For simplicity let us assume that there are three temperatures and two groups A={(1, 2, 3), (2,1, 3)} and B={(1, 2, 3), (1, 3, 2)}. That is, under group A dynamics, only pairwise swaps between the temperatures τ₁ and τ₂ are allowed, while under the group B dynamics, only the swaps between τ₂ and τ₃ are allowed. See FIG. 2.
Consider the following prelimit swapping model. Let the swap rate be a. The dynamics corresponding to group A and group B will be alternated on time intervals of length h. Hence on the interval [2kh, (2k+1)h) the particle swapped process (X̅₁^{a},\tilde{X̅}₂^{a},X̅₃^{a}) involves swaps only between temperatures τ₁ and τ₂. One can easily construct the corresponding temperature swapped process (Y̅₁^{a},Y̅₂^{a},Y̅₃^{a}) as before. Note that X̅₃^{a}=Y̅₃^{a} on this time interval. Similarly, on the interval [(2k+1)h, (2k+2)h), only swaps between τ₂ and τ₃ are allowed and on this interval X̅₁^{a}=Y̅₁^{a}. Note that there is no ambiguity for the prelimit processes at the switch times t=h, 2h, . . . since the locations of the particles (X̅₁^{a},X̅₂^{a},X̅₃^{a}) are known.
Now consider the limit as a→∞ with h being fixed. Without loss of generality, we will discuss only how to deal with the switch of the dynamics at time t=h. On the time interval [0,h) we have the partial infinite swapping limit process Y̅^{A}=(Y̅₁,Y̅₂,Y̅₃) that corresponds to the group A. Similarly it is clear that on the time interval [h, 2h) we should have the partial infinite swapping process Y̅^{B} corresponding to the group B. The problem is, however, by taking the limit, we lose the information on the locations of the particles (X̅₁^{a},X̅₂^{a},X̅₃^{a}). Unless we can somehow recover this information at the switch time t=h to assign Y̅^{B} (h), we cannot determine the dynamics of Y̅^{B} on [h, 2h). The key is to recall that the infinite swapping limit instantaneously equilibrates multiple locations according to the invariant distribution. In other words, given Y̅^{A}(h−)=y=(y₁, y₂, y₃), the locations of the particles are distributed according to

$${\sum }_{σ ∈ A} {\tilde{w}}^{A} ( {y}_{σ} ) {δ}_{{y}_{σ}} = \frac{π ( {y}_{1} , {y}_{2} , {y}_{3} ) {δ}_{( {y}_{1} , {y}_{2} , {y}_{3} )} + π ( {y}_{2} , {y}_{1} , {y}_{3} ) {δ}_{( {y}_{2} , {y}_{1} , {y}_{3} )}}{π ( {y}_{1} , {y}_{2} , {y}_{3} ) + π ( {y}_{2} , {y}_{1} , {y}_{3} )} .$$

Therefore, in order to identify the locations of the particles at time h, we will take a random sample from this distribution once Y̅^{A}(h−) is known. This explains the handoff rule used at the switch times of partial infinite swapping processes.
Now we let h→0. Since A and B generate the whole permutation group S_{K}, it is easy to check that at each time instant, the locations of {y_{σ}: σεS_{K}} are equilibrated according to their invariant distribution, and therefore in the limit we will attain the full infinite swapping model. This can be made rigorous by exploiting the time scale separation between the slow diffusion processes (Y̅^{A},Y̅^{B}) and the fast switching process. We omit the proof because the discussion is largely motivational.
Coming back to the discrete time partial infinite swapping model, it is clear that Algorithm 6.6 is nothing but a straightforward adaption of the preceding discussion to discrete time. The only difference is that one cannot establish an analogous result regarding approximation to the full infinite swapping model as in continuous time. The subtlety here is that in continuous time, as h→0, one can basically ignore any effect from the diffusion on any small time interval and assume that the process is making jumps only between different permutations of a fixed triple (y₁,y₂,y₃). This time scale separation is no longer valid in discrete time. In this setting, the performance of a scheme based on interweaving partial infinite swapping schemes lies between parallel tempering and full infinite swapping, and computational results suggest that it is closer to the latter than the former.
The issue of which interwoven partial schemes will perform best is an open question. In practice we have used schemes of the following form. Suppose that a set of say 45 temperatures is given. We then partition 45 into blocks of sizes 3, 6, . . . , 6, with the first block containing the lowest three temperatures, the second block the next six, and so on. Dynamic A then is given by allowing all permutations within each block. Note that the complexity of the coefficients is then no worse than 6!. In dynamic B we use the partition 6, 6, . . . , 6, 3. The form of the partial scheme is heuristically motivated by allowing the largest possible overlap between the different blocks when switching between dynamics, subject to the constraint that blocks be of size no greater than 6.

### 7. Numerical Examples

In this section we present data comparing parallel tempering at various swap rates and both full and partial infinite swapping. We present what we call “relaxation studies.” The quantity of interest is the average potential energy of the lowest temperature component under the invariant distribution. In these studies, the system is run a long time to reach equilibrium, after which it is repeatedly pushed out of equilibrium and we measure the time needed to “relax” back to equilibrium. Each cycle consists of temporarily raising the temperatures of some of the lowest temperature components for a number of steps sufficient to push the average potential energy away from the “true” value (as measured by either sample or time averages). The temperatures are then returned to their “true” values for a fixed number of steps, and the process is then repeated 2,000 times. We plot the average of the 2,000 samples as a function of the number of moves, and the performance of the algorithm is captured by the rate at which these averages approach the correct value.
FIGS. 3 and 4 present data for a Lennard-Jones cluster of 13 atoms, using the “smart Monte Carlo” scheme of [18] for the simulation of the dynamics, which produces a relatively large move in configuration space for each step. The “true” value is approximately −42.92. This is a relatively simple model and was studied using only four temperatures. The temperatures are dropped to the true values at step 50. Infinite swapping converges more rapidly than any of the parallel tempering schemes. We see in FIG. 3 that the most efficient of the parallel tempering schemes appears to use an attempted swap rate of around 64%. (The rates that would typically be used in such calculations are in the range of 5-10%.) FIG. 4 magnifies a portion of the graph, but it plots only the best parallel tempering result and adds a partial infinite swapping result based on blocks of the form 1,3 and 3,1, and with a handoff at each Metropolis step. Little difference is observed between the partial and full forms, though exclusive use of either of the partial forms by itself performs poorly.
The Lennard-Jones cluster of 13 atoms is not a particularly demanding problem, but it is presented so a comparison can be made between the full and partial infinite swapping forms. A much more complex example is the Lennard-Jones cluster of 38 atoms. Data for this example obtained using a 45-temperature ensemble is given in FIG. 5. Because full infinite swapping is impossible for this larger computational ensemble, we use the partial form. For comparison, results are also presented for parallel tempering.
The details concerning the computational methods underlying both the parallel tempering and infinite swapping results of FIG. 5 along with a discussion of the tem-perature ensemble involved for this example can be found in [14]. Briefly summarized, as with the previous 13-atom Lennard-Jones example, FIG. 5 denotes the results of a series of relaxation experiments. Here, however, 45 temperatures are used with the lowest 15 being involved in the heating/cooling process. The heating and cooling cycles consist of 1,200 smart Monte Carlo moves, each of one unit Lennard-Jones time duration. The cooling segment is taken as the portion of the cycle from moves 200 to 800 with the remainder being the heating portion. During the cooling portion of the cycle the 45 temperatures in the ensemble cover the range from (0.050-0.210) in temperature steps of 0.005, and from (0.210-0.330) in steps of 0.010, while during the heating portion of the cycle temperatures less than or equal to 0.150 are set equal to 0.150. The results shown in FIG. 5 are obtained using 600 thermal cycles.
The 38-atom Lennard-Jones cluster has an interesting landscape. In particular, while the global and lowest-lying local minima are similar in energy, the minimum energy pathway that separates them involves appreciably higher energies and contains 13 separate barriers [24, Chapter 8.3]. As discussed in [14], the partial infinite swap-ping approach is appreciably more effective than conventional tempering approaches in providing a proper sampling of this complex potential energy landscape.

### 8. Appendix

### 8.1. Proof of Theorem 4.1.

Throughout the proof, we let S=S₁×S₁, where S₁⊂ [symbol] ^{a} is convex and compact. Let [symbol] (S) denote the Polish space of all probability measures on S equipped with the topology of weak convergence. For any probability measure νε [symbol] (S), define its mirror image ν^{R}ε [symbol] (S) by requiring

ν^{R}(A×B)=ν(B×A)

for all Borel sets A, B⊂ [symbol] ^{d}. Furthermore, as in the rest of the paper, a bold symbol xεS means x=(x₁, x₂), where x₁, x₂ε [symbol] ^{d}, and x^{R}=(x₂, x₁). We also use the notation

α(x,dy) [symbol] α₁(x₁dy₁)α₂(x₂,dy₂),

which is a probability transition kernel defined on S given S.
To prove the uniform LDP, it suffices to prove the equivalent uniform Laplace principle [3, Chapter 1]. To simplify the proof we have assumed that S is compact. This would be the case if, e.g., V is defined with periodic boundary conditions. The general case can be handled under (2.1) by using V as a Lyapunov function [3, section 8.2]. It will be convenient to split this into upper and lower bounds. We also consider just the (more complicated) case where a_{T}→∞ but a_{T}<∞ for each T. Allowing α_{T}=∞ requires a different notation to handle this special case but does not change the structure of the proof otherwise.
We will show for any bounded continuous function F: [symbol] (S)→ [symbol] that

$${lim}_{T -> ∞} - \frac{1}{T} log E [ exp \{ - TF ( {η}_{T}^{{a}_{T}} ) \} ] = {inf}_{v ∈ 𝒫 ( S )} [ F ( v ) + {I}^{∞} ( v ) ] . \qquad ( 8.1 )$$

By adding a constant to both sides we can assume F≧0, and we do so for the rest of this section. The proof of the uniform LDP is based on the weak convergence approach. The proof is complicated by the multiscale aspect of the fast swapping process, as well as the fact that is a weighted empirical measure that involves this fast process.

### 8.2. Preliminary Results.

### 8.2.1. A Representation.

We first state a stochastic control representation for the left-hand side of (8.1). As with the derivation of the infinite swapping process via weak convergence, it will be necessary to work with the (distributionally equivalent) temperature swapped processes for tightness to hold. In the representation, all random variables used to construct η_{T}^{a}^{_{T}} are replaced by random variables whose distribution is selected, and both the distributions and the random variables will be distinguished from their uncontrolled, original counterparts by an overbar. For this reason, while the continuous time process is denoted by Y^{a}(t), we change notation and use U^{a}(j) rather than Y̅^{a}(j) to denote the discrete time process.
We first construct the temperature swapped process. Let α(x, dy[0)=α(x, dy) and α(x, dy|1)=α(x^{R}, dy^{R}), and let {Nⱼ^{a}, j=0, 1, . . . } be i.i.d. geometric random variables with parameter 1/(1+a), i.e., geometric random variables with mean a. Then the random variables {U^{a}(j), j=0, 1, . . . }, {Mₗ^{a}(j), j=0, 1, . . . , l=0, 1, . . . , N_{J}^{a}} are constructed recursively as follows. Given M₀^{a}(j)=z and U^{a}(j)=x, U^{a}(j+1) is distributed according to α(x, dy|z). The Mₗ^{a}(j), l=0, 1, . . . , Nⱼ^{a}, is a Markov chain with states {0,1} and transition probabilities

p(0,0|x)=g(x), p(0,1|x)=1−g(x),

p(1,0|x)=1−g(x^{R}), p(1,0|x)=g(x^{R}). (8.2)

The initial value for the subsequent interval is given by M₀^{a}(j+1)=M_{N}_{ⱼ}_{^{a}}^{a}(j). Letting {τ_{j,l}^{a}, i=0, 1, . . . , l=0, 1, . . . , Nⱼ^{a}−1} be i.i.d. exponential random variables with mean 1/a, the temperature swapped process in continuous time is then given by

$${Y}^{a} ( t ) = {U}^{a} ( j ) for {\sum }_{i = 0}^{j - 1} {\sum }_{𝓁 = 0}^{{N}_{j}^{a} - 1} {τ}_{i , 𝓁}^{a} \leq t < {\sum }_{i = 0}^{j} {\sum }_{𝓁 = 0}^{{N}_{j}^{a} - 1} {τ}_{i , 𝓁}^{a}$$

(with the convention that the sum from 0 to −1 is 0) and

$${Z}^{a} ( t ) = {M}_{𝓁}^{a} ( j ) for {\sum }_{i = 0}^{j - 1} {\sum }_{k = 0}^{𝓁 - 1} {τ}_{i , k}^{a} \leq t < {\sum }_{i = 0}^{j - 1} {\sum }_{k = 0}^{𝓁} {τ}_{i , k}^{a} ,$$

and, last, the ordinary and weighted empirical measures are given by

$${ψ}_{T}^{a} = \frac{1}{T} {\int }_{0}^{T} {δ}_{{Y}^{a} ( t )} d t and$$

$${η}_{T}^{a} = \frac{1}{T} {\int }_{0}^{T} [ {1}_{\{ {Z}^{a} ( t ) = 0 \}} {δ}_{{Y}^{a} ( t )} + {1}_{\{ {Z}^{a} ( t ) = 1 \}} {δ}_{{{Y}^{a} ( t )}^{K}} ] d t .$$

Let σ^{a} denote the exponential distribution with mean 1/a, and let β^{a} denote the geometric distribution with mean a. For the representation, all distributions (e.g., α(x, dy|z)) can be perturbed from their original form, but such a perturbation pays a relative entropy cost. We distinguish the new distributions and random variables by using an overbar. Given T Tε(0, ∞), let R^{a} and K^{a} be the discrete time indices when the continuous time parameter reaches T, i.e.,

$${\sum }_{i = 0}^{{R}^{a} - 2} {\sum }_{k = 0}^{{N}_{i}^{a} - 1} {τ}_{i , k}^{a} + {\sum }_{k = 0}^{{K}^{a} - 1} {τ}_{{R}^{a} - 1 , k}^{a} \leq T < {\sum }_{i = 0}^{{R}^{a} - 2} {\sum }_{k = 0}^{{N}_{i}^{a} - 1} {τ}_{i , k}^{a} + {\sum }_{k = 0}^{{K}^{a}} {τ}_{{R}^{a} - 1 , k}^{a} . \qquad ( 8.3 )$$

In this representation the barred quantities are constructed analogously to their unbarred counterparts. Thus, e.g., R̅^{a} and N̅ᵢ^{a} are defined by (8.3) but with τ_{i,k}^{a} replaced by τ̅_{i,k}^{a}. Random variables corresponding to any given value of j are constructed in the order Ū^{a}(j+1), N̅ⱼ^{a}, M̅ₗ^{a}(j), τ̅_{i,l}^{a}, l=0, 1, . . . , N̅ⱼ^{a}, and then j is updated to j+1. Barred measures, which are also allowed to depend on discrete time, are used to construct the corresponding barred random variables; e.g., Ū^{a}(j+1) is (conditionally) distributed according to α̅ⱼ(Ū^{a}(j),•|M̅₀^{a}(j)). The infimum is over all collections of measures {α̅ⱼ,β̅ⱼ^{a},p̅_{j,l},σ̅_{j,l}^{a}}, and, although this is not denoted explicitly, any particular measure can depend on all previously constructed random variables. To simplify notation we let N̅_{R}_{^{a}}^{a} denote K̅^{a}. We state the representation for {η_{T}^{a}} and note that an analogous representation holds for {ψ_{T}^{a}}.
LEMMA 8.1. Let G: [symbol] (S)× [symbol] → [symbol] be bounded from below and measurable. Then the representation

$$- \frac{1}{T} log E [ exp \{ - TG ( {η}_{T}^{a} , {R}^{a} ) \} ] = inf E [ G ( {\overline{η}}_{T}^{a} , {\overline{R}}^{a} ) + \frac{1}{T} {\sum }_{i = 0}^{{R}^{a} - 1} [ R ( {\overline{δ}}_{i} ( {\overline{U}}^{a} ( i ) , \cdot \vert {M}_{0}^{a} ( i ) ) \vert \vert α ( {\overline{U}}^{a} ( i ) , \cdot \vert {\overline{M}}_{0}^{a} ( i ) ) ) + R ( {\overline{β}}_{i}^{a} \vert \vert {β}^{a} ) ] + \frac{1}{T} {\sum }_{i = 0}^{{\overline{R}}^{a} - 1} {\sum }_{k = 0}^{{\overline{N}}_{i}^{a} - 1} [ R ( {\overline{p}}_{i , k} ( {\overline{M}}_{k}^{a} ( i ) , \cdot \vert {M}_{k}^{a} ( i ) , \cdot \vert {\overline{U}}^{a} ( i ) ) \vert \vert p ( {\overline{M}}_{k}^{a} ( i ) , \cdot \vert {\overline{U}}^{a} ( i ) ) ) + R ( {\overline{σ}}_{i , k}^{a} ‖ {σ}^{a} ) ] ]$$

is valid.
The proofs of such representations follow from the chain rule for relative entropy (see, e.g., [3, section B.2]). A novel feature of the representation here is that the total number of discrete time steps is random. However, this case can easily be reduced to the case with a fixed deterministic number of steps.

### 8.2.2. Rate for the Ordinary Empirical Measure.

We will frequently factor measures on product spaces in the proof. For a (deterministic) probability measure v on a product space such as S¹×S²×S³, with each Sⁱ a Polish space, we use notation such as ν_{1,2} to denote the marginal distribution on the first two components and notation such as ν_{1|3} to denote the conditional distribution on the first component given the third. When ν is a measurable random measure these can all be chosen so that they are also measurable.
We will make use of the rate function for the ordinary empirical measure. Let φ(x, dy)=α(x, dy|0)ρ₀(x)+α(x, dy|1)ρ₁(x) where ρ₀(x)=ρ(x) and ρ₁(x)=, ρ(x^{R}) and let μ̅(dx)=[π(x)+π(x^{R})]dx/2 be its unique invariant probability distribution. If γ is absolutely continuous with respect to μ̅ with k(x)=[dγ/dμ̅](x), then set

K(γ)=1−∫\sqrt{k(x)k(y)}μ̅(dx)φ(x,dy)

Note that K is convex. We then extend the definition to all of P(S) via lower semi-continuous regularization with respect to the weak topology. Thus if γi→γ in the weak topology and if each γi is absolutely continuous with respect to μ̅, then lim and infᵢK(γi)≧K(γ), we have equality for at least one such sequence. Note that since μ̅ is mutually absolutely continuous with respect to Lebesgue measure, this means that K(γ)≦1 for all γε [symbol] (S).
The following lemma will help relate weak limits of quantities in the representations to the rate function of the ordinary empirical measure.

$$\begin{matrix} LEMMA & \\ Let γ ∈ P ( S ) be absolutely continous with respect to \overline{μ} , \\ and let \\ κ = [ d γ / d \overline{μ ]} . \\ Assume A ∈ ( 0 , ∞ ) , \\ v ∈ ( S \times S ) is such that \\ v [ 1 ] = v [ 2 ] , \\ R ( v {\vert \vert [ v ]}_{1} ⊗ ϕ ) < ∞ , \\ r is such that \\ {r [ v ]}_{1} = κ \overline{μ} , \\ and \\ 0 \leq - \int log {r ( y ) [ v ]}_{1} ( d y ) < ∞ . \\ Then & ( 8.2 ) \\ K ( γ ) = 1 - \int \sqrt{κ ( x ) κ ( y )} \overline{μ} ( d x ) ϕ ( x , d y ) \leq AR ( v {\vert \vert [ v ]}_{1} ⊗ ϕ ) - A \int log {r ( y ) [ v ]}_{1} ( d y ) + A log A - A + 1. & ( 8.4 )\end{matrix}$$

Proof.

Let C be the set where k(x)=0. Then −∫ log r(y)[ν]₁(dy)<∞ implies r(y)>0 a.s. with respect to [ν]₁(dy), and we also have ∫r(y)[ν]₁(dy)=1, so that r(y)<∞ a.s. with respect to [ν]₁(dy). It follows that [ν]₁(C)=0. Now suppose that

∫\sqrt{k(x)k(y)}μ̅(dx)φ(x,dy)=0.

Then k(x)k(y)=0 a.s. with respect to Lebesgue measure, and so if k(x)≠0, then φ(x, {y: k(y)>0})=0, or φ(x, C)=1. Thus ν((S\C)×C)=0, while [ν]₁ [symbol] φ((S(O)×O)=1, which implies R(ν∥[ν]₁ [symbol] φ)=∞, which is a contradiction. We conclude that

∫\sqrt{k(x)k(y)}μ̅(dx)φ(x,dy)>0.

Since also

∫\sqrt{k(x)k(y)}μ̅(dx)φ(x,dy)≦1,

it follows that

−log ∫\sqrt{k(x)k(y)}μ̅(dx)φ(x,dy)ε[0,∞).

Since R(ν∥[ν]₁ [symbol] φ)<∞ and since μ̅ is the invariant distribution of φ, it follows that R([ν]₁∥μ̅)<∞ [3, Lemma 8.6.2]. This means that

$$\int log {\frac{κ ( x )}{r ( x )} [ v ]}_{1} ( d x ) < ∞ ,$$

and since −∫ log r(y)[ν]₁(dy)<∞, it follows that −∫ log k(x)[ν]₁(dx)>−∞. From [v]₁=[v]₂ we conclude that

−½∫[log k(x)+log k(y)]ν(dx,dy)>−∞. (8.5)

By relative entropy duality [3, Proposition 1.4.2]

$$- log \int \sqrt{κ ( x ) κ ( y )} \overline{μ} ( d x ) ϕ ( x , d y ) = - log \int {e}^{\frac{1}{3} [ lo g κ ( x ) + lo g κ ( y ) ]} \overline{μ} ( d x ) ϕ ( x , d y ) \leq R ( v \vert \vert \overline{μ} ⊗ ϕ ) - \frac{1}{2} \int [ log κ ( x ) + log κ ( y ) ] v ( d x , d y )$$

is valid as long as the right-hand side is not of the form ∞-∞, which is true by (8.5). The chain rule then gives

$$- log \int {e}^{\frac{1}{2} [ lo g κ ( x ) + lo g κ ( y ) ]} \overline{μ} ( d x ) ϕ ( x , d y ) \leq R ( v \vert \vert \overline{μ} ⊗ ϕ ) - \int log {κ ( x ) [ v ]}_{1} ( d x ) = R ( v \vert \vert {[ v ]}_{1} ⊗ ϕ ) + R ( {[ v ]}_{1} \vert \vert \overline{μ} ) - \int log {κ ( x ) [ v ]}_{1} ( d x ) = R ( v \vert \vert {[ v ]}_{1} ⊗ ϕ ) - \int log {r ( x ) [ v ]}_{1} ( d x ) ,$$

and thus

−∫\sqrt{k(x)k(y)}μ̅(dx)φ(x,dy)≦−e^{-R(ν∥[ν]}^{₁} [symbol] ^{φ)+∫ log r(x)[ν]}^{₁}^{(dx)}.

Then (8.4) follows from the fact that if aε [symbol] and bε(0, ∞), then −e^{-a}≦ab+b log b−b by taking a=R(ν∥[ν]₁ [symbol] φ)−∫ log r(x)[ν]₁(dx) and b=A. □

### 8.2.3. Decomposition of the Exponential Distribution.

In the construction of η_{T}^{a} we used independent exponential random variables τ_{i,k}^{a} and geometric random variables Nᵢ^{a} and the fact that for each i

$${\sum }_{𝓁 = 0}^{{N}_{i}^{a} - 1} {τ}_{i , 𝓁}^{a}$$

is exponential with mean one. This decomposition corresponds to a relationship in relative entropies, which we now state.
LEMMA 8.3. For aε(0, ∞), let N̅^{a} be distributed according to a random probability measure β̅^{a} on {0, 1, . . . }. Given N̅^{a}=l, for kε{0, 1, . . . l} let τ̅ₖ^{a}(l) be distributed according to a random probability measure σ̅ₖ^{a}(l) on [0, ∞). Let σ̅ be the distribution of the random variable

$$\overline{τ} = {\sum }_{k = 0}^{{\overline{N}}^{a} - 1} {\overline{τ}}_{k}^{a} ( {\overline{N}}^{a} ) . \\ Then$$

$$E [ R ( {\overline{β}}^{a} \vert \vert {β}^{a} ) + {\sum }_{k = 0}^{{\overline{N}}^{a} - 1} R ( {\overline{σ}}_{k}^{a} ( {N}^{a} ) \vert \vert {σ}^{a} ) ] \geq E [ R ( \overline{σ} \vert \vert {σ}^{1} ) ] .$$

Proof.

Define a measure μ on the space [symbol] ₊×Πᵢ₌₀^{∞}[0, ∞) as follows. For any lε [symbol] ₊ and any sequence A₀, A₁, . . . of Borel measurable subsets of [0, ∞),

$$μ ( \{ l \} \times {A}_{0} \times {A}_{1} \times … ) = {β}^{a} ( l ) {\prod }_{k = 0}^{∞} {σ}^{a} ( {A}_{k} ) ,$$

and similarly define the measure μ̅ by

$$\overline{μ} ( \{ l \} \times {A}_{0} \times {A}_{1} \times … ) = {\overline{β}}^{a} ( l ) ( {\sum }_{k = 0}^{𝓁 - 1} {\overline{σ}}_{k}^{a} ( 𝓁 ) ( {A}_{k} ) ) ( {\prod }_{k = 𝓁}^{∞} {σ}^{a} ( {A}_{k} ) ) .$$

Then by the chain rule of relative entropy

$$E [ R ( \overline{μ} \vert \vert μ ) ] = E [ R ( {\overline{β}}^{a} \vert \vert {β}^{a} ) + {\sum }_{𝓁 = 0}^{∞} {\sum }_{k = 0}^{𝓁 - 1} R ( {\overline{σ}}_{k}^{a} ( 𝓁 ) \vert \vert {σ}^{a} ) {\overline{β}}^{a} ( 𝓁 ) ] . \\ Since$$

$$\begin{matrix}E [ {\sum }_{k = 0}^{{\overline{N}}^{a} - 1} R ( {\overline{σ}}_{k}^{a} ( {\overline{N}}^{a} ) \vert \vert {σ}^{a} ) ] = E [ E [ {\sum }_{k = 0}^{{\overline{N}}^{a} - 1} R ( {\overline{σ}}_{k}^{a} ( {\overline{N}}^{a} ) \vert \vert {σ}^{a} ) \vert {\overline{N}}^{a} ] ] \\ = E [ {\sum }_{𝓁 = 0}^{∞} {\sum }_{k = 0}^{𝓁 - 1} R ( {\overline{σ}}_{k}^{a} ( 𝓁 ) \vert \vert {σ}^{a} ) {\overline{β}}^{a} ( 𝓁 ) ] ,\end{matrix}$$

it follows that

$$E [ R ( \overline{μ} \vert \vert μ ) ] = E [ R ( {\overline{β}}^{a} \vert \vert {β}^{a} ) + {\sum }_{k = 0}^{{\overline{N}}^{a} - 1} R ( {\overline{σ}}_{k}^{a} ( {\overline{N}}^{a} ) \vert \vert {σ}^{a} ) ] .$$

Observe that τ̅ can be written as a measurable mapping on [symbol] ₊×Πᵢ₌₀^{∞}[0, ∞) and that σ̅ and σ¹ are the distributions induced on [0, ∞) under that map by μ̅ and μ, respectively. Since relative entropy can only decrease under such a mapping, it follows that

ER(μ̅∥μ)≧ER(σ̅∥σ¹). □

### 8.3. Lower Bound.

The proof of the lower bound will be partitioned into three cases according to a parameter Cε(1, ∞). After the three cases have been argued, the proof of the lower bound will be completed. The first two cases are very simple, and they give estimates when R^{a}/T is small (i.e., unusually few exponential clocks with mean 1 are needed before time T is reached) or when R^{a}/T is large (i.e., an unusually large number of such clocks are needed to reach time T). The processes {U^{a}(j)} and {Mₗ^{a}(j)} play no role in these estimates, and the required estimates follow from Chebyshev's inequality as it is used in the proof of Cramer's theorem. We will need the function h(b)=−log b+b−1, bε[0, ∞), which satisfies inf
{R(γ∥σ¹): ∫uγ(du)=b}=h(b).

### 8.3.1. The Case R^{a}/T≦1/C.

Let F: [symbol] (S)→ [symbol] be nonnegative and continuous. Then

$$- \frac{1}{T} log E [ exp \{ - TF ( {η}_{T}^{a} ) - {∞1}_{\{ [ 0 , 1 / C ] \}} ⋆ ( {R}^{a} / T ) \} ] = - \frac{1}{T} log E [ exp \{ - TF ( {η}_{T}^{a} ) \} {1}_{\{ [ 0 , 1 / C ] \}} ( {R}^{a} / T ) ] \geq - \frac{1}{T} log P \{ {\sum }_{i = 0}^{⌊ T / C ⌋ + 1} {τ}_{i}^{1} \geq T \} .$$

By Chebyshev's inequality, for αε(0, 1),

$$P \{ {\sum }_{i = 0}^{⌊ T / C ⌋ + 1} {τ}_{i}^{1} \geq T \} = P \{ {e}^{a {\sum }_{i = 0}^{⌊ T / C ⌋ + 1}} {τ}_{i}^{1} \geq {e}^{α T} \} \leq exp \{ ( ⌊ T / C ⌋ + 2 ) ( log \frac{1}{1 - α} - α C ) \} .$$

Optimizing this inequality over αε(0, 1) gives

$${lim inf}_{T \to ∞} - \frac{1}{T} log E [ exp \{ - TF ( {η}_{T}^{a} ) - {∞1}_{\{ [ 0 , 1 / C ] \}} \text{?} ( {R}^{a} / T ) \} ] \geq {lim inf}_{T -> ∞} \frac{1}{T} ( ⌊ T / C ⌋ + 2 ) h ( C ) = \frac{h ( C )}{C} . \\ \text{?} \text{indicates text missing or illegible when filed}$$

Note that h(C)/C→las C→∞.

### 8.3.2. The Case R^{a}/T≧C.

With F as in the last section, an analogous argument gives

$${lim inf}_{T \to ∞} - \frac{1}{T} log E [ exp \{ - TF ( {η}_{T}^{a} ) - {∞1}_{\{ [ C , ∞ ) \}} \text{?} ( {R}^{a} / T ) \} ] \geq {lim inf}_{T -> ∞} \frac{1}{T} ( ⌊ T ( C - 1 ) ⌋ + 2 ) h ( \frac{1}{C - 1} ) = ( C - 1 ) h ( \frac{1}{C - 1} ) . \\ \text{?} \text{indicates text missing or illegible when filed}$$

Note that (C−1)h(1/C−1))→∞ as C→∞.

### 8.3.3. The Case 1/C≦R^{a}/T≦C.

To analyze this case it will be sufficient to consider any deterministic sequence {r^{a}} such that 1/C≦r^{a}/T≦C, and such that r^{a}/T→A as T→∞, and obtain lower bounds on

$${lim inf}_{T \to ∞} - \frac{1}{T} log E [ exp \{ - TF ( {η}_{T}^{a} ) - {∞1}_{\{ {r}^{a} / T \}} \text{?} ( {R}^{a} / T ) \} ] . \\ \text{?} \text{indicates text missing or illegible when filed}$$

Since I^{∞} is convex, to prove the lower bound for (8.1) we can assume F is convex and lower semicontinuous [3, Theorem 1.2.1]. The representation from Lemma 8.1 will be applied. We first note that the representation will include a term of the form ∞I_{{r}_{^{a}}_{/T}}_{^{c}}(R̅^{a}/T) on the right-hand side. We can remove this term if we restrict the infimum to controls for which R̅^{a}=r^{a} w.p.1, and we do so for notational convenience. The representation thus becomes

$$- \frac{1}{T} log E [ exp \{ - TF ( {η}_{T}^{a} ) - {∞1}_{\{ {r}^{a} \}} \text{?} ( {R}^{a} ) \} ] = infE [ F ( {\overline{η}}_{T}^{a} ) + \frac{1}{T} {\sum }_{i = 0}^{{r}^{a} - 1} [ R ( {\overline{α}}_{i} ( {\overline{U}}^{a} ( i ) , \cdot \vert {\overline{M}}_{0}^{a} ( i ) ) \vert \vert α ( {\overline{U}}^{a} ( i ) , \cdot \vert {\overline{M}}_{0}^{a} ( i ) ) ) + R ( {\overline{β}}_{i}^{a} \vert \vert {β}^{a} ) ] + \frac{1}{T} {\sum }_{i = 0}^{{r}^{a} - 1} {\sum }_{k = 0}^{{\overline{N}}_{i}^{a} - 1} [ R ( {\overline{p}}_{i , k} ( {\overline{M}}_{k}^{a} ( i ) , \cdot \vert {\overline{U}}^{a} ( i ) ) \vert \vert p ( {\overline{M}}_{k}^{a} ( i ) , \cdot \vert {\overline{U}}^{a} ( i ) ) ) + R ( {\overline{σ}}_{i , k}^{a} \vert \vert {σ}^{a} ) ] . \\ \text{?} \text{indicates text missing or illegible when filed} \qquad ( 8.6 )$$

There are four relative entropy sums in (8.6). Since F is bounded from below, the lower bound holds vacuously unless each such term is uniformly bounded.
We first show that the empirical distribution on N̅ᵢ^{a} converges to δ_{∞} by using a martingale argument. For C₁, C₂⊂[0, ∞), let

$${ξ}^{T} ( {C}_{1} \times {C}_{2} ) ≐ \frac{1}{{r}^{a}} {\sum }_{i = 0}^{{r}^{a} - 1} {δ}_{{\overline{N}}_{i}^{a}} ( {C}_{1} ) {\overline{β}}_{i}^{a} ( {C}_{2} ) .$$

Consider the one-point compactification of [0, ∞), which we identify with [0, ∞], and left ƒ: [0, ∞]→ [symbol] be bounded and continuous. Then for any ε>0,

$$P \{ \vert \int [ f ( {z}_{1} ) - f ( {z}_{2} ) ] {ξ}^{T} ( d {z}_{1} \times d {z}_{2} ) \vert \geq ɛ \} = P \{ \vert \frac{1}{{r}^{a}} {\sum }_{i = 0}^{{r}^{a} - 1} ( f ( {\overline{N}}_{i}^{a} ) - \int f ( n ) {\overline{β}}_{i}^{a} ( d n ) ) \vert \geq ɛ \} \leq \frac{1}{{ɛ}^{2}} E [ {\vert \frac{1}{{r}^{a}} {\sum }_{i = 0}^{{r}^{a} - 1} ( f ( {\overline{N}}_{i}^{a} ) - \int f ( n ) {\overline{β}}_{i}^{a} ( d n ) ) \vert}^{2} ] \leq \frac{{‖ f ‖}_{∞}^{2}}{{ɛ}^{2} {r}^{a}} -> 0 , \qquad ( 8.7 )$$

and thus any weak limit of ξ^{T} has identical marginals. Next note that by Jensen's inequality and since r^{a}/T→Aε(0, ∞), the uniform bound on the second relative entropy sum implies that ER([ξ^{T}]₂∥β^{a}) is uniformly bounded. Using that inf

$$\{ R ( γ \vert \vert {β}_{a} ) \text{:} \int u γ ( d u ) = b \} = b log \frac{b}{a} + ( 1 + b ) log \frac{1 + a}{1 + b} ,$$

it follows that the weak limit of [ξ^{T}]₂=δ_{∞} w.p.1.
Next we consider the asymptotic properties of the collection {M̅ₗ^{a}(i)} under boundedness of the third relative entropy sum. We use that the empirical measure of the {N̅ᵢ^{a}} tends to δ_{∞}. Since p(•,•|Ū^{a}(i)) is the transition function of a finite state Markov chain, this means that asymptotically the M̅ₖ^{a}(i), k=0, . . . , N̅ᵢ^{a}, are samples from the transition probability (8.2) with x=Ū^{a}(i), and in particular that M̅₀^{a}(i+1) is asymptotically conditionally independent with distribution (ρ(x), 1−ρ(x)). Indeed, a martingale argument similar to (8.7) shows that if

$${μ}^{T} ( {C}_{1} \times {C}_{2} ) ≐ \frac{1}{{r}^{a}} {\sum }_{i = 0}^{{r}^{a} - 1} {δ}_{{\overline{U}}^{a} ( i )} ( {C}_{1} ) {δ}_{{\overline{M}}_{0}^{a} ( i )} ( {C}_{2} )$$

and if μ^{∞} is the weak limit of any convergent subsequence (which must exist by compactness), then

([μ^{∞}]_{2|1}({0}|y),[μ^{∞}]_{2|1}({1}|y))=(ρ(y),1−ρ(y))[μ^{∞}]₁-a.s., (8.8)

and the same is true for the empirical measure of {M̅ₖ^{a}(i), k=0, . . . , N̅ᵢ^{a}}.
We next remove the third relative entropy sum from the representation (8.6) and obtain a lower bound for the right-hand side using Lemma 8.3. Let \hat{σ}ᵢ^{a} denote the distribution of the random variable

$${\hat{τ}}_{i}^{a} = {\sum }_{𝓁 = 0}^{{\overline{N}}_{i}^{a} - 1} {\overline{τ}}_{i , 𝓁}^{a} .$$

Then we have the lower bound

$$- \frac{1}{T} log E [ exp \{ - TF ( {η}_{T}^{a} ) - {∞1}_{\{ {r}^{a} \}} \text{?} ( {R}^{a} ) \} ] \geq inf [ F ( E {\overline{η}}_{T}^{a} ) + \frac{1}{T} E {\sum }_{i = 0}^{{r}^{a} - 1} [ R ( {\overline{α}}_{i} ( {\overline{U}}^{a} ( i ) , \cdot \vert {\overline{M}}_{0}^{a} ( i ) ) \vert \vert α ( {\overline{U}}^{a} ( i ) , \cdot \vert {\overline{M}}_{0}^{a} ( i ) ) ) + R ( {\hat{σ}}_{i}^{a} \vert \vert {σ}^{1} ) ] ] . \\ \text{?} \text{indicates text missing or illegible when filed} \qquad ( 8.9 )$$

To study the lower bound of (8.9) we introduce the measures

$${κ}^{T} ( {C}_{1} \times {C}_{2} \times {C}_{3} ) ≐ \frac{1}{{r}^{a}} {\sum }_{i = 0}^{{r}^{a} - 1} {δ}_{{\overline{U}}^{a} ( i )} ( {C}_{1} ) {\overline{α}}_{i} ( {\overline{U}}^{a} ( i ) , {C}_{2} \vert {\overline{M}}_{0}^{a} ( i ) ) {δ}_{{\overline{M}}_{0}^{a} ( i )} ( {C}_{3} ) , \\ {ξ}^{T} ( {C}_{1} \times {C}_{2} ) ≐ \frac{1}{T} {\sum }_{i = 0}^{{r}^{a} - 1} {δ}_{{\overline{U}}^{a} ( i )} ( {C}_{1} ) {δ}_{{( {\overline{m}}_{i}^{a} )}^{- 1}} ( {C}_{2} ) {\hat{m}}_{i}^{a} ,$$

where \hat{m}ᵢ^{a} is the conditional mean of \hat{τ}ᵢ^{a}. The restriction on the control measures implies

$${\sum }_{i = 0}^{{r}^{a} - 2} {\hat{τ}}_{i}^{a} \leq T < {\sum }_{i = 0}^{{r}^{a} - 1} {\hat{τ}}_{i}^{a} ,$$

and since function h is increasing on (1, ∞), we can assume without loss of generality that \hat{m}ᵣ_{^{a}}₋₁^{a}≦1.
We introduce the function l: [symbol] ₊→ [symbol] ₊ given by l(b)=b log b−b+1. Note that h(b)=bl(1/b). The sequence {k^{T}} is tight because S and {0, 1} are compact. Using the fact that \hat{σ}ᵢ^{a} selects the conditional distribution of \hat{τ}ᵢ^{a} and inf{R(γ∥σ¹): ∫uγ(du)=b}=h(b), we have

$$\begin{matrix}E [ \frac{1}{T} {\sum }_{i = 0}^{{r}^{a} - 1} R ( {\hat{σ}}_{i}^{a} \vert \vert {σ}^{1} ) ] \geq E [ \frac{1}{T} {\sum }_{i = 0}^{{r}^{a} - 1} h ( {\hat{m}}_{i}^{a} ) ] \\ = E [ \frac{1}{T} {\sum }_{i = 0}^{{r}^{a} - 1} {\hat{m}}_{i}^{a} l ( {[ {\hat{m}}_{i}^{a} ]}^{- 1} ) ] \\ = E [ \int l ( z ) {ξ}^{T} ( d u \times d z ) ] .\end{matrix}$$

Hence the uniform bound on the relative entropy sum gives that {ξ^{T}} is tight. Let ƒ: S→R be bounded and continuous. Since α̅ᵢ(Ū^{a}(i),•M̅₀^{a}(i)) selects the conditional distribution of Ū^{a}(i+1), for ε>0,

$$P \{ \vert {\sum }_{x = 1}^{2} \int [ f ( {y}_{1} ) - f ( {y}_{2} ) ] {κ}^{T} ( d {y}_{1} \times d {y}_{2} \times d z ) \vert \geq ɛ \} = P \{ \vert \frac{1}{{r}^{a}} {\sum }_{i = 0}^{{r}^{a} - 1} ( f ( {\overline{U}}^{a} ( i + 1 ) ) - \int f ( y ) {\overline{α}}_{i} ( {\overline{U}}^{a} ( i ) , d y \vert {\overline{M}}_{0}^{a} ( i ) ) ) \vert \geq ɛ \} \leq \frac{1}{{ε}^{2}} E [ {\vert \frac{1}{{r}^{a}} {\sum }_{i = 0}^{{r}^{a} - 1} ( f ( {\overline{U}}^{a} ( i + 1 ) ) - \int f ( y ) {\overline{α}}_{i} ( {\overline{U}}^{a} ( i ) , d y \vert {\overline{M}}_{0}^{a} ( i ) ) ) \vert}^{2} ] \leq \frac{{‖ f ‖}_{∞}^{2}}{{ɛ}^{2} {r}^{a}} \to 0.$$

We find that

[k^{∞}]₁=[k^{∞}]₂w.p.1. (8.10)

Using Fatou's lemma and the definition of φ, we get the lower bound AR([k^{∞}]_{1,2}∥[k^{∞}]₁\textcircled{x}φ) on the weak limit of the corresponding relative entropies (the second sum in (8.9)).
With regard to ξ^{∞} comparing the form of [ξ^{T]}₁ and ψ̅_{T}^{a} gives

E[ξ^{∞}]₁=Eψ̅_{∞}.

Observe that

$$\int z {\dot{ξ}}^{T} ( d x \times d x ) = {\frac{{r}^{α}}{T} [ {κ}^{T} ]}_{1} d x .$$

Because of the superlinearity of l, we have uniform integrability, and thus passing to the limit gives

∫z[ξ^{∞}]₁(dx)[ξ^{∞}]_{2|1}(dz|x)=A[k^{∞}]₁(dx).

Hence with the definition b(x)=∫z[ξ^{∞}]_{2|1}(dz|x), [d[k^{∞}]₁/d[ξ^{∞}]₁](x)=b(x)/A. Using Fatou's lemma, Jensen's inequality, and the weak convergence, we get the following lower bound on the corresponding relative entropies (the first sum in (8.9)):

$${lim inf}_{T \to ∞} \int l ( z ) {ξ}^{T} ( d u \times d z ) \geq \int l ( z ) {ξ}^{∞} ( d u \times d z ) \geq \int {l ( \int {z [ {ξ}^{∞} ]}_{2 \vert 1} ( d z \vert x ) ) [ {ξ}^{∞} ]}_{1} ( d x ) = \int {l ( b ( x ) ) [ {ξ}^{∞} ]}_{1} ( d x ) = A \int {h ( 1 / b ( x ) ) [ {κ}^{∞} ]}_{1} ( d x ) .$$

Let r(y)=A/b (y). Then we can write the combined lower bound on the relative entropies as

$$AER ( {[ {κ}^{∞} ]}_{1 , 2} {\vert \vert [ {κ}^{∞} ]}_{1} ⊗ ϕ ) + AE \int {h ( 1 / b ( x ) ) [ {κ}^{∞} ]}_{1} ( d x ) = AER ( {[ {κ}^{∞} ]}_{1 , 2} {\vert \vert [ {κ}^{∞} ]}_{1} ⊗ ϕ ) - AE \int log {r ( y ) [ {κ}^{∞} ]}_{1} ( d y ) + A log A - A + 1. \qquad ( 8.11 )$$

We next consider φ̅_{T}^{a} and η̅_{T}^{a}. Using the limiting properties of the M̅ₖ^{a}(i), we have

$${\overline{η}}_{T}^{a} ( C ) = \frac{1}{T} {\int }_{0}^{T} [ {1}_{\{ {\overline{Z}}^{a} ( t ) = 0 \}} {δ}_{{\overline{Y}}^{a} ( t )} ( C ) + {1}_{\{ {\overline{Z}}^{a} ( t ) = 1 \}} {δ}_{{{\overline{Y}}^{a} ( t )}^{R}} ( C ) ] d t \to \int {[ ρ ( y ) {δ}_{y} ( C ) + ( 1 - ρ ( y ) ) {δ}_{{y}^{R}} ( C ) ] [ {ξ}^{∞} ]}_{1} = {\overline{η}}_{∞} ( C )$$

$$and$$

$${\overline{ψ}}_{T}^{a} ( C ) = \frac{1}{T} {\int }_{0}^{T} {δ}_{{\overline{Y}}^{a} ( t )} ( C ) d t \to {\int }_{C} {[ {ξ}^{∞} ]}_{1} = {\overline{ψ}}_{∞} ( C ) .$$

Note that this implies the relation

η̅_{∞}(C)=∫_{C}[ρ(y)ψ̅_{∞}(dy)+ρ(y^{R})ψ̅_{∞}(dy^{R})]. (8.12)

Finally we consider the weighted empirical measure. By (8.11), Lemma 8.2, and Jensen's inequality we have the lower bound ┌F(Eη̅_{∞})+K(Eψ̅_{∞})┐ for the limit inferior of the right-hand side of (8.6), where η̅_{∞} and φ̅_{∞} are related by (8.12). Thus we need only show that

K(Eψ̅_{∞})≧I⁰(Eη̅_{∞})=I^{∞}(Eη̅_{∞}).

The equality follows from the definition of I^{∞} and (8.12). Let a(y)=[dEψ̅_{∞}/dμ̅](y). Then

K(Eψ̅_{∞})=1−∫\sqrt{a(x)a(y)}μ̅(dx)φ(x,dy)

and

I⁰(Eη̅_{∞})=1−∫½{square root over ((a(x)+a(x^{R}))(a(y)+a(y^{R})))}μ(dx)α(x,dy).

Using that p(x)=1−p(x^{R}) and symmetry,

$$\int \sqrt{a ( x ) a ( y )} \frac{1}{2} [ μ ( d x ) + μ ( d {x}^{R} ) ] ( ρ ( x ) α ( x , d y ) + ρ ( {x}^{R} ) α ( {x}^{R} , d {y}^{R} ) ) = \frac{1}{2} \int ( \sqrt{a ( x ) a ( y )} + \sqrt{a ( {x}^{R} ) a ( {y}^{R} )} ) μ ( d x ) ( ρ ( x ) α ( x , d y ) + ρ ( {x}^{R} ) α ( {x}^{R} , d {y}^{R} ) ) = \frac{1}{2} \int ( \sqrt{a ( x ) a ( y )} + \sqrt{a ( {x}^{R} ) a ( {y}^{R} )} ) μ ( d x ) α ( x , d y ) .$$

### We now use

$$\sqrt{a ( x ) a ( y )} + \sqrt{a ( {x}^{R} ) a ( {y}^{R} )} \leq \sqrt{( a ( x ) + a ( {x}^{R} ) ) ( a ( y ) + a ( {y}^{R} ) )}$$

to obtain K(Eφ̅_{∞})≧I⁰(Eη̅_{∞}). (We note for later use that given η̅ that is absolutely continuous with respect to Lebesgue measure and such that I^{∞}(η̅)<∞, K(ψ̅)=I⁰(η̅) can be shown for a ψ̅ that maps to η̅ by taking ψ̅=[η̅+η̅^{R}]/2.)

### 8.3.4. Combining the Cases.

In the last subsection we showed that for any sequence r^{a} such that r^{a}/T→Aε[1/C, C],

$${lim inf}_{T \to ∞} - \frac{1}{T} log E [ exp ( - TF ( {η}_{T}^{a} ) - ∞1 \text{?} ( {R}^{a} / T ) \} ] \geq [ F ( E {\overline{η}}_{∞} ) + {I}^{∞} ( E {\overline{η}}_{∞} ) ] [ F ( v ) + {I}^{∞} ( v ) ] , \\ \text{?} \text{indicates text missing or illegible when filed}$$

and an argument by contradiction shows that the bound is uniform in A. Thus

$${lim inf}_{T \to ∞} - \frac{1}{T} log \{ {\sum }_{\text{?}}^{[ TC ]} E [ exp \{ - TF ( {η}_{T}^{a} ) - {∞1}_{{\{ {r}^{a} / T \}}^{c}} ( {R}^{a} / T ) \} ] \} \geq {lim inf}_{T \to ∞} - \frac{1}{T} log \{ Tc \cdot {}_{\text{?}}^{[ TC ]} E [ exp \{ - TF ( {η}_{T}^{a} ) - {∞1}_{{\{ {r}^{a} / T \}}^{c}} ( {R}^{a} / T ) \} ] \} \geq [ F ( v ) + {I}^{∞} ( v ) ] . \text{?}$$

$$\text{?} \text{indicates text missing or illegible when filed}$$

We now partition E[exp{−TF(η_{T}^{a})] according to the various cases to obtain the overall lower bound

$${lim inf}_{T \to ∞} - \frac{1}{T} log E [ exp ( - TF ( \text{?} ) \} ] \geq min [ F ( v ) + {I}^{∞} ( v ) ] , \\ \frac{h ( C )}{C} , ( C - 1 ) h ( \frac{1}{C - 1} ) \} . \\ \text{?} \text{indicates text missing or illegible when filed}$$

Letting C→∞ and using the fact that I^{∞}≦1, we have the desired lower bound

$${lim inf}_{T \to ∞} - \frac{1}{T} log E [ exp \{ - TF ( {η}_{T}^{{a}_{r}} ) \} ] \geq [ F ( v ) + {I}^{∞} ( v ) ] .$$

### 8.4. Upper Bound.

The proof of the reverse inequality

$${lim sup}_{T \to ∞} - \frac{1}{T} log E [ exp \{ - TF ( {η}_{T}^{{a}_{r}} ) \} ] \leq [ F ( v ) + {I}^{∞} ( v ) ]$$

is simpler. Let bounded and continuous F be given. Given ε>0, we can find ν that is absolutely continuous with respect to Lebesgue measure and for which

$$[ F ( v ) + {I}^{∞} ( v ) ] \leq [ F ( v ) + {I}^{∞} ( v ) ] + ɛ .$$

Next we use that I^{∞} is convex and I^{∞}(μ)=0 to find τ>0 such that

[F(ν^{τ})+I^{∞}(ν^{τ})]≦[F(ν)+I^{∞}(ν)]+ε

when ν^{τ}=τμ+(1−τ)ν. Note that if θ(x)=[dν/dμ](x) and θ^{τ}(x)=[dν^{τ}/dμ](x), then θ^{τ}(x)≧τ>0 and so I^{∞}(ν^{τ})<1.
We will construct a control to use in the representation such that η̅_{T}^{a}^{_{T}} will converge w.p.1 to ν^{τ} and RE^{T} will converge w.p.1 to I^{∞}(ν^{τ}). These convergences will follow from the ergodic theorem, and the bound θ^{τ}(x)≧τ will be used to argue that the ergodicity of the original process is inherited by the controlled process.
We now proceed to the construction. Let c(dx)=[ν^{τ}(dx)+ν^{τ}(dx^{R})]/2 so that I^{∞}(ν^{τ})=K(c). Let k(x)=[dc/dμ̅](x)≧τ/2. Then

K(c)=1−∫\sqrt{k(x)k(y)}μ̅(dx)φ(x,dy).

Since k is uniformly bounded from below, we have the dual relationship

$$- log \int \sqrt{κ ( x ) κ ( y )} \overline{u} ( d x ) ϕ ( x , d y ) = - log \int {e}^{\frac{1}{2} ( logn ( x ) + logn ( y ) )} \overline{u} ( d x ) ϕ ( x , d y ) = R ( η \vert \vert \overline{u} ⊗ ϕ ) - \frac{1}{2} \int [ log κ ( x ) + log κ ( y ) ] v ( d x , d y ) , \\ where$$

$$η ( C ) = \frac{{\int }_{C} {e}^{\frac{1}{2} [ logκ ( x ) + logκ ( y ) ]} \overline{u} ( d x ) ϕ ( x , d y )}{{\int }_{{S}^{2}} {e}^{\frac{1}{2} [ logκ ( x ) + logκ ( y ) ]} \overline{u} ( d x ) ϕ ( x , d y )} .$$

Since \sqrt{k(x)k(y)} is symmetric in x and y, automatically [η]₁=[η]₂, and using the bound k(x)≧τ/2 we can factor η(dx×dy)=[η]₁(dx)φ̅(x, dy), where φ̅ is the transition kernel of a uniformly ergodic Markov chain. Let

α̅(x,dy|0)=α̅(x,dy|1)=φ̅(x,dy).

Notice that from the definition of φ̅, φ̅(x, dy)=φ̅(x^{R}, dy^{R}), and hence α̅ has the property that

α̅(x^{R},dy^{R}|0)=α̅(x,dy|1).

These will be the transition kernels used to construct the Ū^{a}(i).
Now of course the invariant distribution of φ̅ is [η]₁ and not the desired distribution c. Let τ(x)=[dc/d[η]₁](x). Then r(x) identifies the way in which the distribution of the random variables N̅ⱼ^{a} should be modified so that in the continuous time the empirical measure [η]₁ is reshaped into c. Choose A so that equality holds in (8.4), and set b(x)=Ar(x). Then β̅ᵢ^{a} is chosen to be β^{ab(x)}. Consistent with the analysis of the upper bound, we do not perturb the distribution of the other variables so that p̅_{i,k}(•, •|•)=p(•, •|•̅) and σ̅_{j,l}^{a}=σ^{a}. We then construct the controlled processes using these measures in exact analogy with the construction of the original process. With this choice and Lemma 8.1 we obtain the bound

$$- \frac{1}{T} log E [ exp \{ - TF ( {η}_{T}^{{a}_{r}} ) \} ] \leq E [ F ( {\overline{η}}_{T}^{a} ) + \frac{1}{T} {\sum }_{i = 0}^{\text{?}} [ R ( \overline{α} ( {\overline{U}}^{a} ( i ) , \cdot \vert {\overline{M}}_{0}^{a} ( i ) \vert \vert α ( {\overline{U}}^{a} ( i ) , \cdot \vert {\overline{M}}_{0}^{a} ( i ) ) ) + R ( {β}^{ab ( {\overline{U}}^{a} ( i ) )} \vert \vert {β}^{a} ) ] ] . \\ \text{?} \text{indicates text missing or illegible when filed}$$

Now apply the ergodic theorem, and use that w.p.1 A^{τ}=R̅^{a}/T→1/∫b(x)[η]₁(dx)=A and also that asymptotically the conditional distribution M̅₀^{a}(i) is given by (ρ₀(Ū^{a}(i)), ρ₁(Ū^{a}(i))). Then the right-hand side of the last display converges until we have the limit

$$F ( {v}^{τ} ) + \frac{1}{\int {b ( x ) [ η ]}_{1} ( d x )} \int [ {\sum }_{x = 1}^{2} R ( \overline{α} ( x , d y \vert z ) \vert \vert α ( x , d y \vert z ) ) {ρ}_{x} ( x ) ] {r ( x ) [ η ]}_{1} ( d x ) + \frac{1}{\int {b ( x ) [ η ]}_{1} ( d x )} \int ( - log b ( x ) + b ( x ) - 1 ) {b ( x ) [ η ]}_{1} ( d x ) = F ( {v}^{τ} ) + A \int R ( ϕ ( x , d y ) \vert \vert ϕ ( x , d y ) ) \text{?} ( d x ) - A \int log r ( x ) \text{?} ( d x ) + A log A - A + 1 = F ( {v}^{τ} ) + K ( \text{?} ) = F ( {v}^{τ} ) + {I}^{∞} ( {v}^{τ} )$$

$$\text{?} \text{indicates text missing or illegible when filed}$$

This completes the proof of (8.13) and also the proof of Theorem 4.1.

The foregoing has outlined some of the more pertinent features of the subject matter. These features should be construed to be merely illustrative. Many other beneficial results can be attained by applying the disclosed subject matter in a different manner or by modifying the subject matter as will be described. For example, density or pressure may be used as a control variable in the place of temperature.

1. A computer system for simulating a physical system using a control variable, comprising:
a grouping module for dividing a control variable range into a first set of groups and a second set of groups, the control variable range extending from a lowest value, V_{lowest}, to a highest value, V_{highest}, each group in the first set including a discrete set of control values that extend over only a portion of the range from V_{lowest} to V_{highest}, each group in the second set including a discrete set of control values that extend over only a portion of the range from V_{lowest} to V_{highest}, each group in the first set being distinct from each group in the second set, the control values in the first set extending from V_{lowest} to V_{highest}, the control values in the second set extending from V_{lowest} to V_{highest};
an analysis module for computing data representative of the physical system over the set of control values in each group in the first and second set of groups, the analysis module providing simultaneous exchange of information between all of the control values within a group; and
a swapping module for communicating data such that:
the analysis module can use data computed using a group in the first set for computing data representative of the physical system for a group of control values in the second set and,
the analysis module can use data computed using a group in the second set for computing data representative of the physical system for a group of control values in the first set.

2. The computer system of claim 1, wherein the control values comprise one of density, pressure, volume and temperature.

3. The computer system of claim 1, wherein the physical system is a nanoscale structure.

4. A computer system for simulating a physical system using a control variable, comprising:
a first analysis module for computing data representative of the physical system over a range of a control variable, the range extending from a lowest value V_{lowest}, to a highest value, V_{highest}, the first analysis module individually computing data representative of the physical system within each of a first set of groups, each group in the first set including a discrete set of values of the control variable, the discrete set in each group of the first set of groups extending over only a portion of the range from V_{lowest} to V_{highest}, the first analysis module providing simultaneous exchange of information between all values of the control variable within a group of the first set of groups;
a second analysis module for computing data representative of the physical system over the range of the control variable extending from V_{lowest} to V_{highest}, the second analysis module individually computing data representative of the physical system within each of a second set of groups, each group in the second set including a discrete set of values of the control variable, the discrete set in each group of the second set of groups extending over only a portion of the range from V_{lowest} to V_{highest}, the second analysis module providing simultaneous exchange of information between all values of the control variable within a group of the second set of groups, each group in the second set of groups being distinct from each group in the first set of groups; and
a swapping module for communicating data such that:
the second analysis module can receive data computed by the first analysis module for a group in the first set of groups, the second analysis module using that data received from the first analysis module for computing data representative of the physical system for a group in the second set of groups.

5. A computer system according to claim 4, the first analysis module and the second analysis module being formed from a common module of computer software.

6. A computer system according to claim 4, the swapping module also communicating data such that the first analysis module can receive data computed by the second analysis module for a group in the second set of groups, the first analysis module using that data received from the second analysis module for computing data representative of the physical system for a group in the first set of groups.

7. A computer system according to claim 4, further comprising a third analysis module for computing data representative of the physical system over the range of the control variable extending from V_{lowest} to V_{highest}, the third analysis module individually computing data representative of the physical system within each of a third set of groups, each group in the third set including a discrete set of values of the control variable, the discrete set in each group of the third set of groups extending over only a portion of the range from V_{lowest} to V_{highest}, the third analysis module providing simultaneous exchange of information between all values of the control variable within a group of the third set of groups, each group in the third set of groups being distinct from each group in the first and second sets of groups.

8. A computer system according to claim 7, wherein the first, second and third analysis modules are formed from a common module of computer software.

9. A computer system according to claim 4, wherein the control variable comprises one of temperature, density, volume and pressure.

10. A computer system according to claim 4, wherein the physical system is a nanoscale structure.

11. A computer system for simulating a physical system using a control variable, comprising:
a first analysis module for computing data representative of the physical system over a range of temperatures, the range extending from a lowest value T_{lowest}, to a highest value, T_{highest}, the first analysis module individually computing data representative of the physical system within each of a first set of groups, each group in the first set including a discrete set of temperature values, the discrete set in each group of the first set of groups extending over only a portion of the range from T_{lowest} to T_{highest}, the first analysis module providing simultaneous exchange of information between all temperature values within a group of the first set of groups;
a second analysis module for computing data representative of the physical system over the temperature range extending from T_{lowest} to T_{highest}, the second analysis module individually computing data representative of the physical system within each of a second set of groups, each group in the second set including a discrete set of temperature values, the discrete set in each group of the second set of groups extending over only a portion of the range from T_{lowest} to T_{highest}, the second analysis module providing simultaneous exchange of information between all temperature values within a group of the second set of groups, each group in the second set of groups being distinct from each group in the first set of groups; and
a swapping module for communicating data such that the second analysis module can receive data computed by the first analysis module for a group in the first set of groups, the second analysis module using that data received from the first analysis module for computing data representative of the physical system for a group in the second set of groups.

12. A computer system according to claim 11, wherein the physical system is a nanoscale structure.
